(19) United States
(12) Patent Application Publication
(10) Pub. No.: US 2021/0410084 A1
(43) Pub. Date: Dec. 30, 2021

(54) SIDELINK TRANSMIT POWER CONTROL FOR NEW RADIO V2X

(71) Applicant: CONVIDA WIRELESS, LLC, Wilmington, DE (US)

(72) Inventors: Qing LI, Princeton Junction, NJ (US); Patrick SVEDMAN, Chevy Chase, MD (US); Guodong ZHANG, Woodbury, NY (US); Pascal M. ADJAKPLE, Great Neck, NY (US); Joseph M. MURRAY, Schwenksville, PA (US); Mohamed AWADIN, Plymouth Meeting, PA (US)

(21) Appl. No.: 17/291,644

(22) PCT Filed: Sep. 11, 2019
(86) PCT No.: PCT/US2019/050596

§ 371 Date: May 6, 2021

Related U.S. Application Data
(60) Provisional application No. 62/757,431, filed on Nov. 8, 2018.

(51) Int. Cl. H04W 52/38; H04W 52/24; H04W 52/26

(52) U.S. Cl. CPC H04W 52/383; H04W 52/265; H04W 52/243; H04W 52/242

(57) ABSTRACT

Methods and systems for Sidelink Transmit Power Control may include but are not limited to path loss estimation for sidelink including Reference Signals (RS) for path loss measurement and path loss estimation for proximity based transmit power control, open-loop transmit power control on sidelink including synchronization, discovery, and broadcast, as well as closed-loop transmit power control on sidelink including two-way transmit power control on sidelink for unicast and two-way transmit power control on sidelink for groupcast or multicast. Methods and systems for transmit power sharing may include but are not limited to transmit power sharing between uplink and sidelink and transmit power sharing between sidelinks.

### CROSS-REFERENCE TO RELATED APPLICATIONS

This application claims the benefit of priority to U.S. Application No. 62/757,431, filed on 8 Nov. 2018, the entirety of which is incorporated by reference herein.

### BACKGROUND

As Vehicle-to-everything (V2X) applications make significant progress, transmission of short messages about vehicles' own status data for basic safety may need to be extended with transmission of larger messages containing raw sensor data, vehicles' intention data, coordination and confirmation of future maneuver, etc. For these advanced applications, the expected requirements to meet the needed data rate, latency, reliability, communication range and speed are made more stringent.

For enhanced V2X (eV2X) services, 3GPP has identified 25 use cases and the related requirements in TR 22.886 (see 3GPP TR 22.886 Study on enhancement of 3GPP Support for 5G V2X Services, Release 16, V16.0.0). The normative requirements are specified in TS 22.186 with the use cases categorized into four use case groups: vehicles platooning, advanced driving, extended sensors and remote driving (see 3GPP TS 22.186 Enhancement of 3GPP support for V2X scenarios (Stage 1), Release 16, V16.0.0). The detailed description of performance requirements for each use case group are specified in TS 22.186, which guides the New Radio (NR) V2X specification.

### SUMMARY

Methods and systems for Sidelink Transmit Power Control are disclosed. Example methods and systems may include but are not limited to path loss estimation for sidelink including Reference Signals (RS) for path loss measurement and path loss estimation for proximity based transmit power control, open-loop transmit power control on sidelink including synchronization, discovery, and broadcast, as well as closed-loop transmit power control on sidelink including two-way transmit power control on sidelink for unicast and two-way transmit power control on sidelink for groupcast or multicast. Methods and systems for transmit power sharing are disclosed. Example methods and systems may include but are not limited to transmit power sharing between uplink and sidelink and transmit power sharing between sidelinks.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1A illustrates one embodiment of an example communications system in which the methods and apparatuses described and claimed herein may be embodied;

FIG. 1B is a block diagram of an example apparatus or device configured for wireless communications in accordance with the embodiments illustrated herein;

FIG. 1C is a system diagram of an example radio access network (RAN) and core network in accordance with an embodiment;

FIG. 1D is another system diagram of a RAN and core network according to another embodiment;

FIG. 1E is another system diagram of a RAN and core network according to another embodiment;

FIG. 1F is a block diagram of an exemplary computing system 90 in which one or more apparatuses of the communications networks illustrated in FIGS. 1A, 1C, 1D and 1E may be embodied;

FIG. 1G is a block diagram of an example V2X communication system;

FIG. 2 shows a block diagram of example advanced V2X services;

FIG. 3 shows an example method for path loss measurements with network coverage;

FIG. 4 shows an example method for path loss measurements without network coverage;

FIG. 5A and FIG. 5B show a flowchart for an example method for sidelink open-loop transmit power control;

FIG. 6A and FIG. 6B show a flowchart for an example method for adjustable transmit power control for discovery;

FIG. 7A and FIG. 7B show a flowchart for an example method for sidelink closed-loop initial power setting;

FIG. 8 shows a flowchart for an example method for sidelink closed-loop transmit power adjustment;

FIG. 9A and FIG. 9B show a flowchart for an example method for closed-loop power control for unicast under network coverage;

FIGS. 10A and 10B show a flowchart for an example method for closed-loop power control for unicast without network coverage;

FIG. 11A and FIG. 11B show a flowchart for an example method for closed-loop power control for groupcast under Network Coverage;

FIG. 12A and FIG. 12B show a flowchart for an example method for closed-loop power control for groupcast without network coverage;

FIG. 13 shows a block diagram of example transmit power sharing;

FIG. 14 shows a flowchart for an example method for transmit power sharing between uplink and sidelink; and

FIG. 15 shows a flowchart for an example method for transmit power sharing between sidelinks.

### DETAILED DESCRIPTION OF ILLUSTRATIVE EMBODIMENTS

### Example Communication System and Networks

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

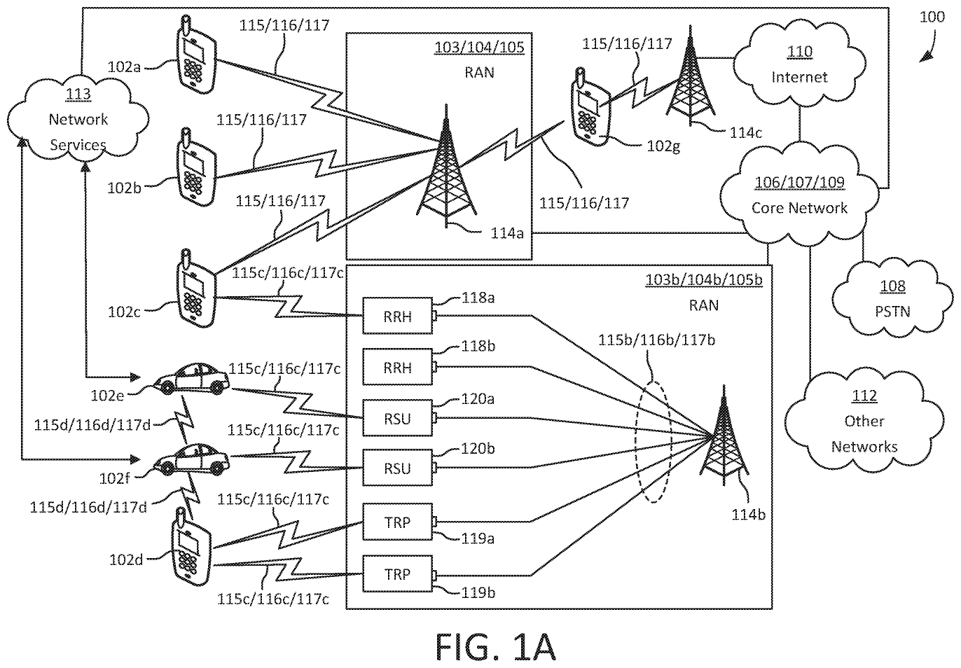

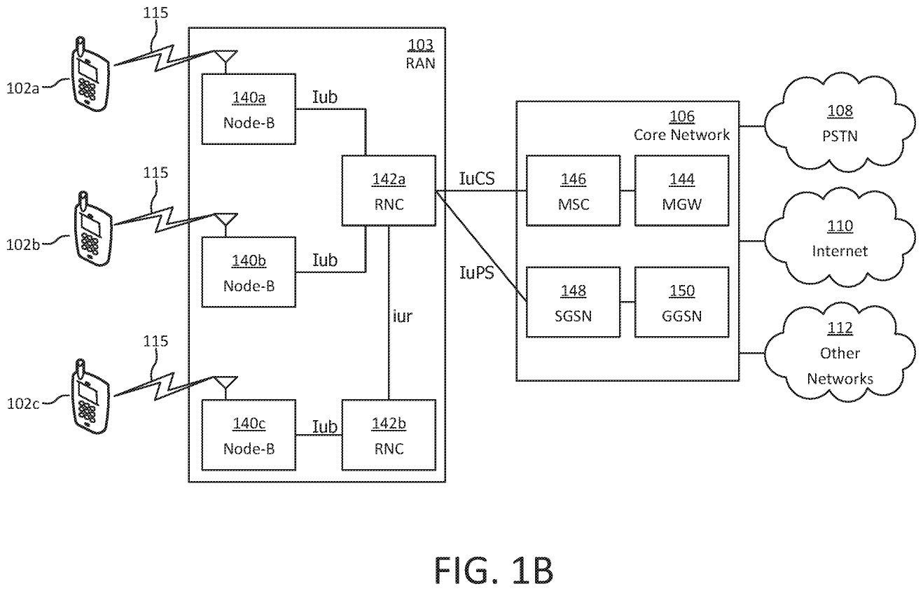

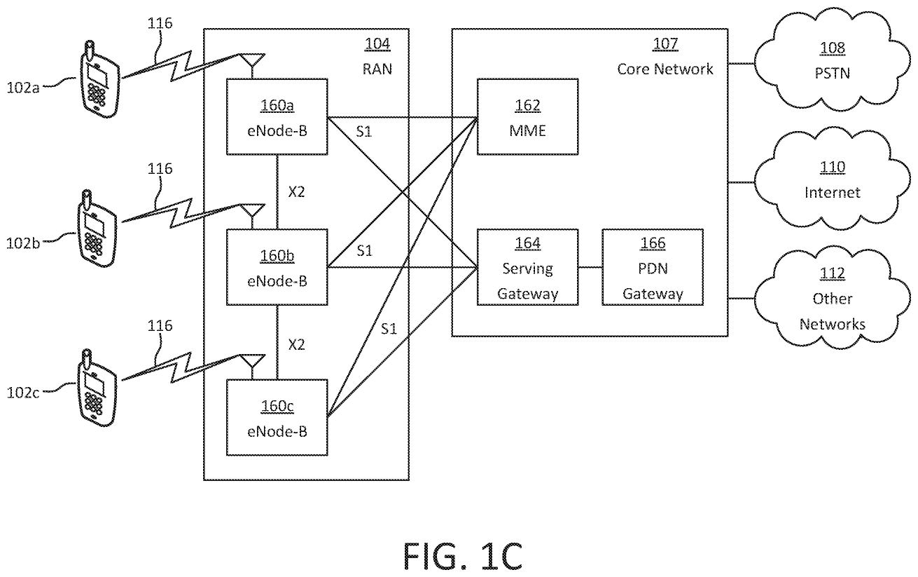

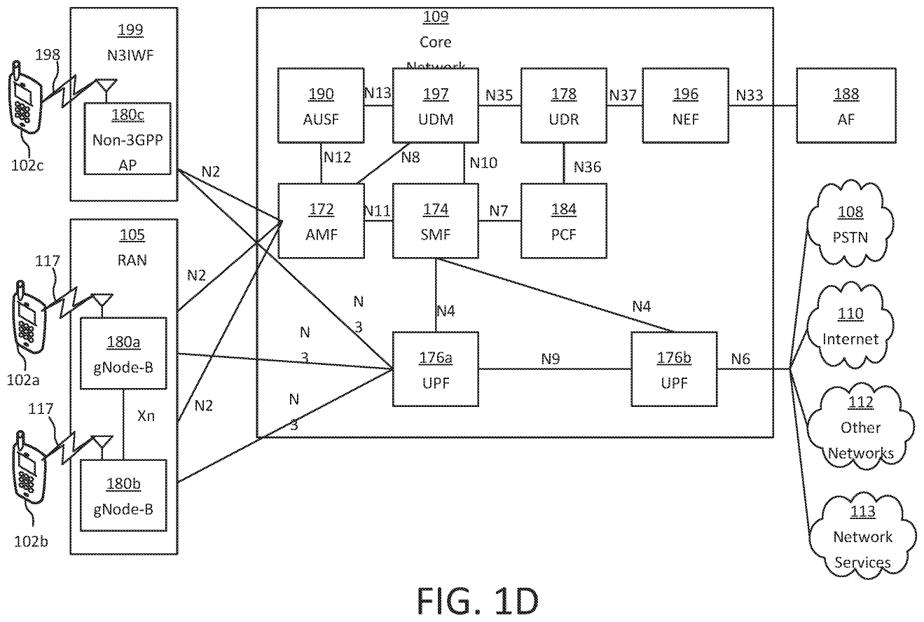

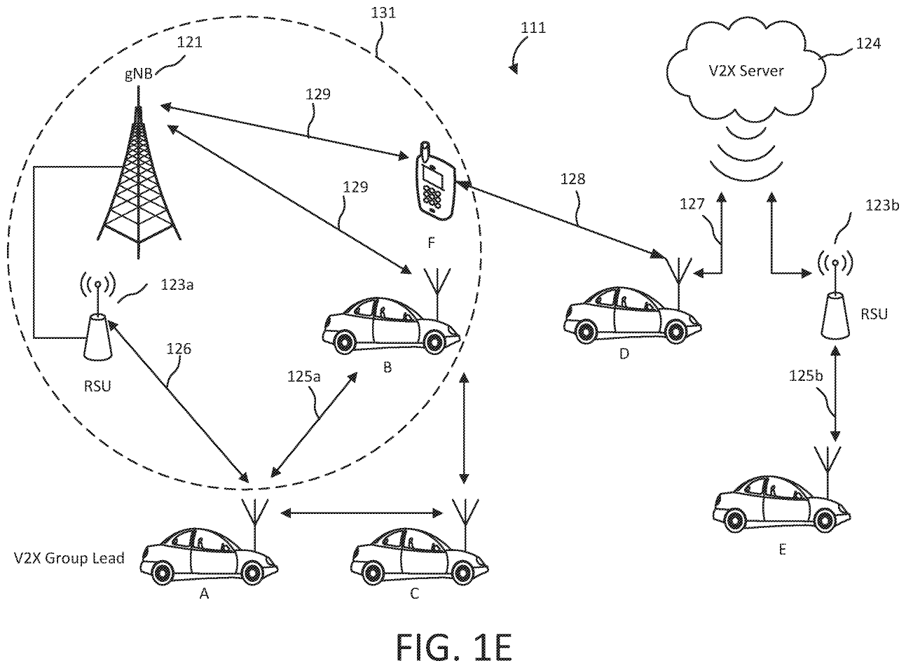

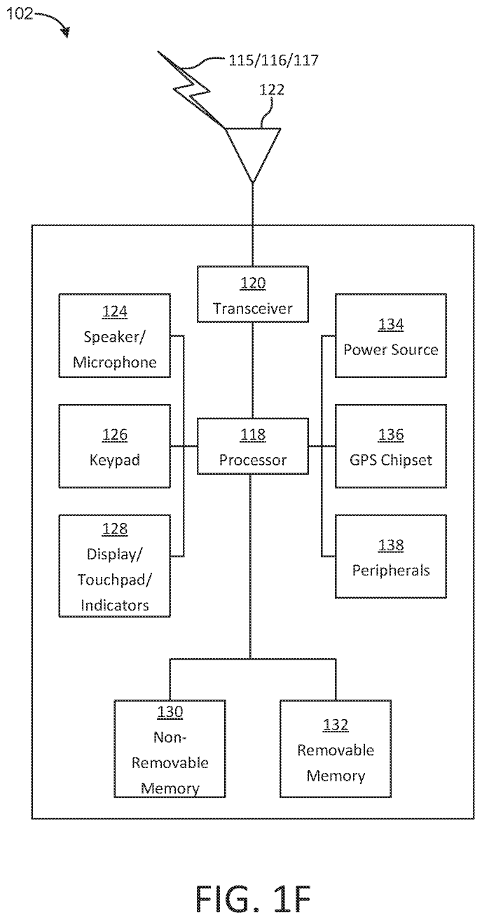

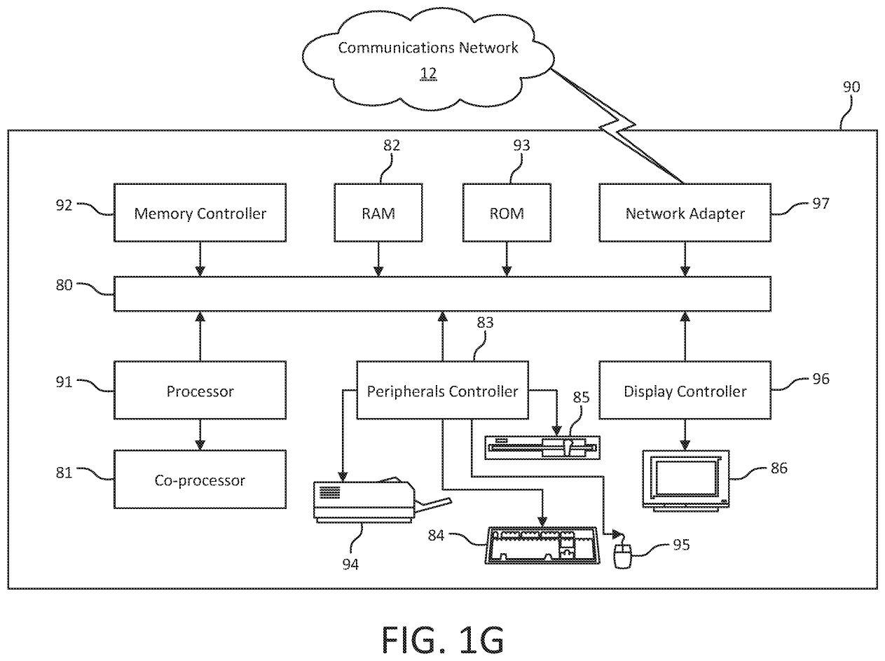

FIG. 1A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 1A, each of the WTRUs 102 is depicted in FIGS. 1A-1E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 1A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 1A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 1A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 1A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 1A may be configured to communicate with the base station 114a, which may employ a cellular-based radio technology, and with the base station 114c, which may employ an IEEE 802 radio technology.

Although not shown in FIG. 1A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 1B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 1B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 1B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 1B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 1C is a system diagram of an example RAN 104 and core network 107.

As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 1C, the eNode-Bs 160a, 160b, and 160c may communicate with one another over an X2 interface.

The core network 107 shown in FIG. 1C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 1D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-B s. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 1D, the gNode-Bs 180a and 180b may communicate with one another over an Xn interface, for example.

The core network 109 shown in FIG. 1D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in Figure x1G.

In the example of FIG. 1D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 1D shows that network functions directly connect to one another, however, it should be appreciated that they may communicate via routing agents such as a diameter routing agent or message buses.

In the example of FIG. 1D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 1D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 1D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g. in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 1D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 1A, 1C, 1D, and 1E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 1A, 1B, 1C, 1D, and 1E are provided by way of example only, and it is understood that the subject matter disclosed and claimed herein may be embodied or implemented in any similar communication system, whether presently defined or defined in the future.

FIG. 1E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 1E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 1E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 1F is a block diagram of an example apparatus or device WTRU 102 that may be configured for wireless communications and operations in accordance with the systems, methods, and apparatuses described herein, such as a WTRU 102 of FIG. 1A, 1B, 1C, 1D, or 1E. As shown in FIG. 1F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 1F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 1A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 1F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 1G is a block diagram of an exemplary computing system 90 in which one or more apparatuses of the communications networks illustrated in FIGS. 1A, 1C, 1D and 1E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 1A, 1B, 1C, 1D, and 1E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

The following is a list of acronyms relating to service layer technologies that may appear in the description below. Unless otherwise specified, the acronyms used herein refer to the corresponding term listed below:
ACK ACKnowledgement
CE Control Element
DCI Downlink Control Information
DL Downlink
HARQ Hybrid Automatic Repeat Request
LTE Long Term Evolution
MAC Medium Access Control
NACK Negative ACKnowledgement
NAS Non-Access Stratum
NR New Radio
PBCH Physical Broadcast Channel
PDCCH Physical Downlink Control Channel
PDSCH Physical Downlink Shared Data Channel
PSBCH Physical Sidelink Broadcast Channel
PSDCH Physical Sidelink Discovery Channel
PSCCH Physical Sidelink Control Channel
PSSCH Physical Sidelink Shared Data Channel
PSS Primary Synchronization Signal
RB Resource Block
RRC Radio Resource Control
SCI Sidelink Control Information
S-CSI-RS Sidelink Channel State Information Reference Signal
S-DMRS Sidelink Demodulation Reference Signal
S-PSS Sidelink Primary Synchronization Signal
SS Synchronization Signal
SSB Synchronization Signal Block
SSS Secondary Synchronization Signal
S-SS Sidelink Synchronization Signal
S-SSB Sidelink Synchronization Signal Block
S-SSS Sidelink Secondary Synchronization Signal
TPC Transmit Power Control
TDD Time Division Duplex
UE User Equipment
UL Uplink

### Up Link Power Control in NR Release 15

Up Link (UL) power control in a NR system is used mainly for limiting intracell and intercell interference, reducing UE power consumption with received power for proper decoding, and ensuring the overall system UL throughput performance.

Beam-based UL Transmit Power Control (TPC) in open-loop and closed-loop are specified in TS 38.213 for different UL channels as well as UL signals (see 3GPP TS 38.213 Physical layer procedures for control, Release 15, V15.3.0), which may be generalized with the following equation for the UL transmit power (in dBm) at transmission occasion i:

P(i,j,q,l)=min{Pc max(i),P₀(j)+10×log₁₀(2^{μ}×M_{RB}(i))+α(j)×PL(q)+Δ_{TF}(i)+ƒ(i,l)}

For open-loop TPC, the beam-based transmit power may be set based on the maximum allowable transmission power (e.g., Pcmax(i)), normalized target power level at a gNB's receiver (e.g., P₀(j) for a configuration with j<2 or beam pair association with j≥2), transmitted Resource Blocks (RBs), e.g., M_{RB}(i)) scaled with the associated numerology (e.g., subcarrier spacing 2^{μ}), UL Path Loss (PL) estimated with the scaled (e.g., α(j) for fractional scaled) Downlink (DL) path loss measurement (e.g., PL(q)) with a DL Reference Signal (RS) (e.g., reference signal resource index q) associated to the beam pair link, and the adjustment with the associated Modulation Coding Scheme (MCS) (e.g., Δ_{TF}(i)).

For closed-loop TPC, the beam-based transmit power may be adjusted based on Transmit Power Control command from the gNB, for example ƒ(i,l) as power control adjustment state of loop l for increasing or decreasing the power at transmission occasion i.

### Sidelink Power Control in LTE

Sidelink transmit power control is specified in LTE, where only open-loop power control is conducted for sidelink V2X communications (see 3GPP TS 36.213 Physical layer procedures, Release 15, V15.3.0). The open-loop power control is based on either path loss estimated on downlink from an eNB or based on the maximum allowable transmit power for emergency service when under the eNB coverage; or is based on a fixed preconfigured transmit power level when out of an eNB's coverage.

### Example Problem Statement and Summary

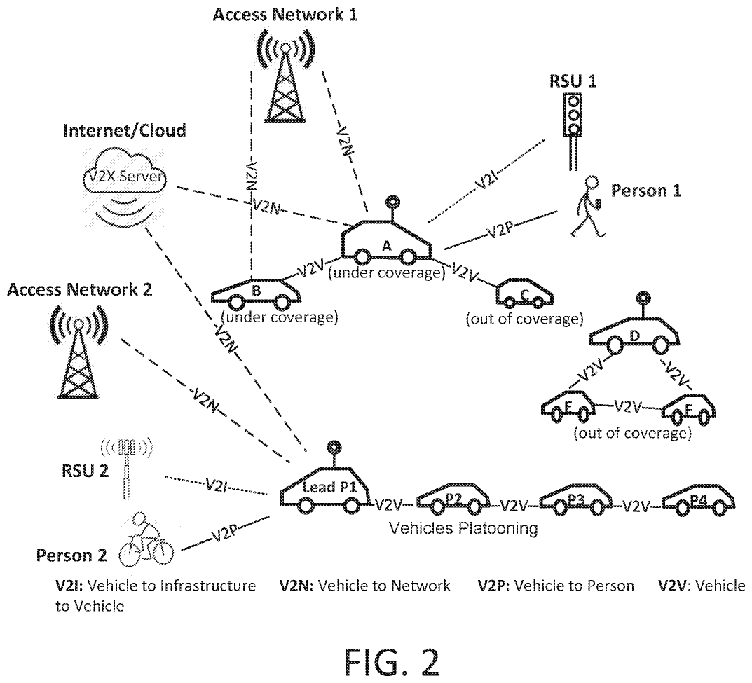

As illustrated in FIG. 2, the advanced V2X applications have created a shift towards more proactive and intelligent transport infrastructure, which requires more dynamically mixed communications, such as broadcast, multicast and unicast in proximity, within and among distributed V2X networks. As more stringent latency and reliability are required, optimization on transmit power control over sidelink has become essential for a New Radio (NR) V2X system to support advanced V2X services.

As depicted in FIG. 2, vehicle UE A and B under network coverage (e.g., gNB's coverage) may operate at NR sidelink mode 1, where the cellular network selects and manages the radio resources used by vehicle UE A and B for their direct V2V communications on sidelink (e.g., V2V interface between A and B), and may also operate at NR sidelink mode 2, where vehicle UE A and B autonomously select the radio resources for their direct V2V communications on sidelink. Vehicle UE C is out of network coverage, and vehicle UE C and A may operate under partial network coverage with vehicle UE A as the synchronization source UE.

Also, as illustrated in FIG. 2, vehicle UE D, E and F are out of network coverage and may operate at NR sidelink mode 2, where vehicle UE D, E and F autonomously select the radio resources for their direct V2V communications (e.g., V2V interfaces among D, E and F). In this scenario, vehicle UE D may be the synchronization source UE.

Also shown in FIG. 2, a vehicle platoon with vehicle UE P1 as the platoon lead and vehicle UE P2, P3 and P4 as the platoon members, where the platoon lead may be the synchronization source UE.

In LTE V2X, the transmit power control (TPC) is conducted as open-loop power control with the path loss estimated from the DownLink (DL) measurements which is mainly for inband interference management, e.g., the closer a vehicle UE gets to eNB, the lower the transmit power level on its sidelink. For emergency scenario, the network switches a vehicle UE to operate at a maximum power level. For out of network coverage, a vehicle UE's maximum transmit power may be set at three different levels for discovery by the higher layer. Overall, the sidelink transmit power is not optimized for sidelink radio link quality, or in another words, not optimized in proximity for sidelink communications.

To support the advanced V2X use cases, proximity based sidelink optimization is becoming important to ensure the radio link quality and therefore to meet much more stringent latency and reliability requirement. Specifically, the following problems for transmit power control may need to be addressed:

When a vehicle UE is operating in NR Mode 1 or Mode 2 under the network coverage, how does the UE balance the proximity based sidelink transmit power control with the cell based inband interference control?

When a vehicle UE is operating in NR Mode 2 out of the network coverage, how does the UE optimize the proximity based sidelink transmit power control, as well as managing the interference in the proximity?

Different sidelink Transmit Power Control (TPC) schemes are disclosed herein. Note that the terms UE and vehicle UE are used interchangeably, terms groupcast and multicast are used interchangeably, and terms beam and panel are used interchangeably herein.

Methods and systems for Sidelink Transmit Power Control are disclosed. Example methods and systems may include but are not limited to path loss estimation for sidelink including Reference Signals (RS) for path loss measurement and path loss estimation for proximity based transmit power control, open-loop transmit power control on sidelink including synchronization, discovery, broadcast, groupcast or multicast, and unicast, as well as closed-loop transmit power control on sidelink including two-way transmit power control on sidelink for unicast and two-way transmit power control on sidelink for groupcast or multicast.

Methods and systems for transmit power sharing are disclosed. Example methods and systems may include but are not limited to transmit power sharing between uplink and sidelink and transmit power sharing between sidelinks.

An example method may comprise receiving one or more of a sidelink quality of service configuration, a sidelink transmit power control configuration, or an interference control configuration; determining one or more of a first path loss measurement from a first device or a second path loss measurement from a second device on sidelink; estimating a sidelink transmit power based on one or more of the sidelink quality of service configuration, the sidelink transmit power control configuration, the interference control configuration, the first path loss measurement from the first device, or the second path loss measurement from the second device on sidelink; and sending a transmission to the second device on sidelink based on the estimated sidelink transmit power.

The sidelink quality of service configuration may comprise one or more of a minimum sidelink communication range, a priority, or a latency. The sidelink transmit power control configuration per sidelink bandwidth part and/or per sidelink beam or antenna may comprise one or more of: a sidelink target power, a sidelink path loss scaling factor, a sidelink maximum transmit power, an initial sidelink transmit power, a sidelink transmit power adjustment, or a sidelink reference signal configuration for path loss measurement. The interference control configuration per sidelink bandwidth part and/or per sidelink beam or antenna may comprise one or more of a path loss scaling factor, a reference signal configuration for path loss measurement, or a transmit power of a reference signal for the path loss measurement.

Determining the first path loss measurement from the first device may comprises one or more of: measuring a path loss on downlink from a gNB using a synchronization signal block (SSB) or a channel state information reference signal (CSI-RS); or measuring a path loss on sidelink from the first device using a sidelink synchronization signal block (S-SSB), a sidelink channel state information reference signal (S-CSI-RS), or a sidelink demodulation reference signal (S-DMRS). Determining the second path loss measurement from the second device on sidelink may comprise one or more of: measuring a path loss on sidelink using a sidelink synchronization signal block (S-SSB), a sidelink channel state information reference signal (S-CSI-RS), or a sidelink demodulation reference signal (S-DMRS) from the second device; or receiving a measurement of sidelink reference signal received power (S-RSRP) from the second device for a second path loss or receiving a measured second path loss from the second device, wherein the measurement comprises one or more of a sidelink synchronization signal block (S-SSB), a sidelink channel state information reference signal (S-CSI-RS), or a sidelink demodulation reference signal (S-DMRS).

Estimating the sidelink transmit power may comprise one or more of: determining a sidelink transmit power based on a configured sidelink transmit power associated with a quality of service; and determining a sidelink transmit power using interference control based on one or more of the first path loss with the first device and/or using the sidelink path loss compensation based on the second path loss with the second device on sidelink. Sending a transmission may comprise one or more of broadcasting a sidelink synchronization signal block, broadcasting a sidelink discovery message, sending a data packet and/or sidelink channel state information reference signal via a sidelink unicast, a sidelink groupcast or multicast, or a sidelink broadcast, and sending a feedback for a sidelink unicast or a sidelink groupcast or multicast.

### Path Loss Estimation

Sidelink path loss estimation is based on a radio link path loss measurement, which may be measured within the network coverage or without the network coverage.

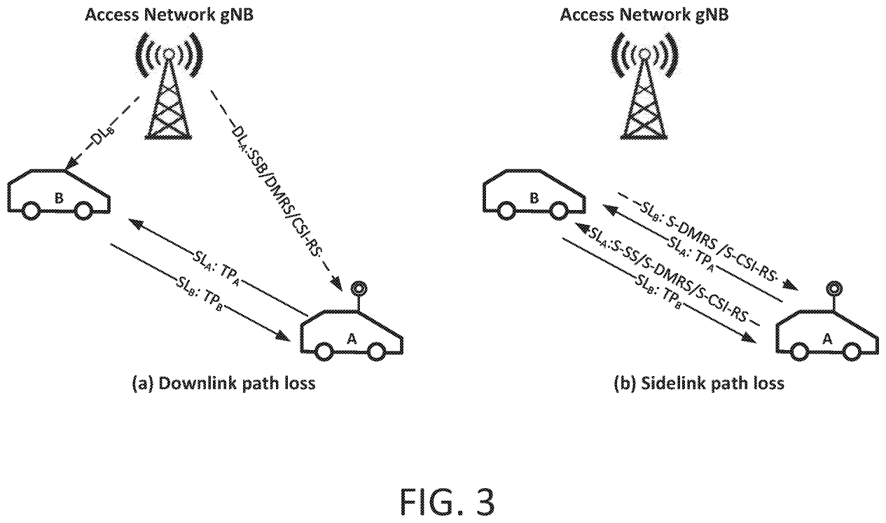

If a UE is under a network coverage, e.g., under a gNB as shown in FIG. 3(a), the downlink path loss may be measured on DownLink (DL) signals such as the Primary Synchronization Signal (PSS) and Secondary Synchronization Signal (SSS) of a Synchronization Signal Block (SSB) in NR, or may be measured on DL Demodulation Reference Signals (DMRSs) such as the DMRS of a Physical Broadcast Channel (PBCH) within an SSB in NR, DMRS of a Physical Downlink Control Channel (PDCCH) or DMRS of a Physical Downlink Shared Channel (PDSCH), or may be measured on DL Channel Status Information-Reference Signal (CSI-RS).

If the measured DL path loss is used for Sidelink (SL) power control, it is mainly for the cell based inband interference management and not for the sidelink radio link quality. As shown in FIG. 3 (a), UE A is farther away from the gNB comparing with UE B, and the downlink path loss measured on downlink DL_{A} is higher than the downlink path loss on downlink DL_{B}, therefore the open-loop Transmit Power (TP) TP_{A} from UE A to UE B on sidelink SL_{A} may be set higher based on the path loss measured on DL DL_{A} than the open-loop TP TP_{B} from UE B to UE A on sidelink SL_{B} based on the path loss measured on DL DL_{B}. In this scenario, power of TP_{A} from UE A to UE B may be higher than the performance requirement on sidelink SL_{A}, and power of TP_{B} from UE B to UE A may be lower than the performance requirement on sidelink SL_{B}, thus neither is optimized for the sidelink transmission performance on sidelink SL_{A} or SL_{B} in proximity.

For proper transmit power setting to ensure certain performance requirement on a sidelink in proximity, sidelink path loss measurement is proposed for sidelink open-loop transmit power control to compensate for the radio channel attenuation or fading to a signal on a sidelink. As illustrated in FIG. 3 (b) where UE A is a synchronization source UE, e.g., sending Sidelink-Synchronization Signal Block (S-SSB). The path loss of sidelink SL_{B} may be measured from the sidelink-DMRS(S-DMRS) or Sidelink-CSI-RS (S-CSI-RS) sent from UE B to UE A on sidelink SL_{B}, as shown in dashed line in FIG. 3 (b). The S-DMRS may be the DMRS of Physical Sidelink Discovery Channel (PSDCH), Physical Sidelink Control Channel (PSCCH), Physical Sidelink Shared Channel (PSSCH), or combination of any of them, sent from UE B. Similarly, the path loss of sidelink SL_{A} may be measured from the Sidelink-Synchronization Signal (S-SS), e.g., Sidelink-Primary Synchronization Signal (S-PSS) and Sidelink-Secondary Synchronization Signal (S-SSS), and/or S-DMRS of Physical Sidelink Broadcast Channel (PSBCH) of an S-SSB, the S-DMRS of PSDCH, PSCCH, PSSCH, or combination of any of them, or the S-CSI-RS, etc., sent from UE A to UE B on sidelink SL_{A}, as shown in dashed line in FIG. 3 (b).

Due to radio channel's reciprocal property of a Time Division Duplex (TDD) system on a sidelink, the path loss based on the measuring signal on sidelink may be applied to either direction of a paired sidelinks, therefore only one UE of a paired sidelinks needs to send a reference signal or to measure the path loss from a reference signal. For example, if UE A on sidelink pair SL_{A} and SL_{B}, as shown in FIG. 3(b), sends a reference signal, e.g., S-SS of a S-SSB, S-DMRS of PSBCH, PSDCH, PSCCH or PSSCH, or S-CSI-RS, at a time for sidelink radio link measurements on the paired sidelinks between the pair of UEs, UE B may measure the path loss from the reference signal sent from UE A as the path loss of UE A's sidelink SL_{A}, and UE B may also use this measured path loss as the estimated path loss of its sidelink SL_{B} based on the reciprocal property of a paired sidelinks. Similarly, UE A may measure the path loss from the reference signal sent from UE B such as S-DMRS of PSDCH, PSCCH or PSSCH, or S-CSI-RS as the path loss on sidelink SL_{A} for UE A as well as the path loss on sidelink SL_{B} for UE B.

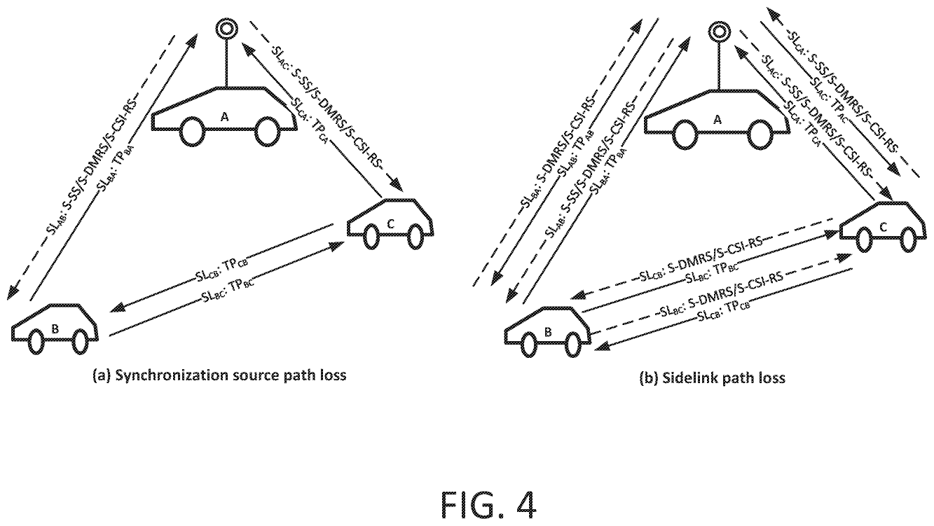

When a UE is out of the network coverage, the sidelink path loss measurement may be conducted in the examples depicted in FIG. 4, where UE A is a synchronization source which may be an RSU, a proximity lead, a group lead or a synchronization source UE.

As shown in FIG. 4(a), the transmit power on sidelink SL_{BA} and SL_{CA}, e.g., TP_{BA} and TP_{CA} as shown in solid lines, may be estimated from the S-SS and/or S-DMRS of PSBCH of a S-SSB, S-DMRS of PSDCH, PSCCH or PSSCH, or S-CSI-RS sent from UE A to UE B on SL_{AB} and UE C on SL_{AC} as shown in dashed lines in FIG. 4(a). If the transmit power TP_{BA} from UE B to UE A and TP_{CA} from UE C to UE A are set based on the measurement on sidelink SL_{AB} and SL_{AC} respectively, they are for optimizing the sidelink performance on SL_{BA} and SL_{CA} respectively. However, if the transmit power TP_{BC} from UE B to UE C and TP_{CB} from UE C to UE B are set based on the measurement on sidelink SL_{AB} and SL_{AC} respectively, they are for minimizing the inband interference to UE A and not for optimizing the sidelink performance on SL_{BC} and SL_{CB} respectively. For example, UE C is closer to UE A comparing with UE B, then the transmit power TP_{CB} on sidelink SL_{CB} based on the path loss measured on sidelink SL_{AC} may be lower than the transmit power TP_{BC} on sidelink SL_{BC} based on the path loss measured on sidelink SL_{AB}, therefore UE C introduces less interference to UE A with lower transmit power.

A full sidelink path loss measurement for each sidelink radio quality is exemplified in FIG. 4(b), where each sidelink transmit power, shown with the solid lines, is estimated based on the corresponding sidelink path loss measurement, shown with the dashed lines. Therefore, the transmit power is optimized for each sidelink performance without any interference management in the proximity.

The path loss measurement on the downlink or sidelink may be for example Reference Signal Received Power (RSRP), which may be based on periodic measuring signals (e.g., DL SS and/or DMRS of SSB or periodic CSI-RS; sidelink S-SS and/or S-DMRS of S-SSB, or periodic S-CSI-RS) and/or aperiodic measuring signals (e.g., DL DMRS of PDCCH or PDSCH, or aperiodic CSI-RS; sidelink S-DMRS of PSDCH, PSCCH or PSSCH, or aperiodic S-CSI-RS) sent on a downlink or sidelink respectively.

The downlink path loss may be estimated with the following equation as an example,

DL Path Loss=transmit power of SS/DMRS/CSI-RS−RSRP of SS/DMRS/CSI-RS, where RSRP may be measured at the physical layer, e.g. L1 measurement at each transmission or monitoring occasion or measuring window, and/or filtered by the higher layer for large scale channel fading, e.g., L2 or L3 filtering with a L2 or L3 filtering window or time interval.

The sidelink path loss may be estimated with the following equation as an example,

SL Path Loss=transmit power of S-SS/S-DMRS/S-CSI-RS−RSRP of S-SS/S-DMRS/S-CSI-RS, where RSRP may be measured at the physical layer, e.g. L1 measurement at each transmission or monitoring occasion or measuring window, and/or filtered by the higher layer for large scale channel fading, e.g., L2 or L3 filtering with a L2 or L3 filtering window or time interval.

A V2X communication topology structure may be very dynamic due to different speeds and moving directions among UEs in a proximity, e.g., at the intersection of an urban area. A V2X communication topology structure may be very static due to the same speeds and moving directions among UEs in a proximity, e.g., a car platoon. Therefore, a reference signal for path loss measurement, e.g., S-SSB, S-CSI-RS or S-DMRS, may be dynamic (e.g., aperiodic) or static (e.g., periodic or semi-persistent) for a V2X service in a proximity.

Periodic transmission occasions of a sidelink measuring signal and the related transmit power should be known to UEs in a proximity for sidelink path loss measurements. A periodic sidelink measuring signal may be S-SS and/or S-DMRS of PSBCH of an S-SSB, periodic S-CSI-RS, S-DMRS of PSCCH or PSSCH for periodic message.

The transmission occasions of a periodic sidelink measuring signal may include, for example, an allocation in time within a slot or subframe or a frame, e.g., Time_{symbol}, and period, e.g., Time_{period} in symbols, slots, subframes or frames; an allocation in frequency, e.g., Frequency_{PRB_num} as Physical Resource Block (PRB) number or index, or Frequency_{subch_num} as subchannel number or index, or Frequency_{RE_num} as Resource Element (RE) number or index, or Frequencyₚₐₜₜₑᵣₙ as frequency pattern within a sidelink bandwidth part (SL-BWP); and an allocation in space, SSB_{index} for S-SSB or SCSIRS_{ID} or SCSIRSRS_{index} for S-CSI-RS, or Quasi-co-location (QCL) relationship with S-SSB or S-CSI-RS or Transmission Configuration Indicator (TCI) state associated with the S-SSB or S-CSI-RS for S-DMRS port of PSSCH.

The transmission occasion may also be indicated by the configuration ID or index, e.g., S-SSB_Conf_{ID} or S-SSB_Config_{index} for S-SSB, S-CSIRS_Config_{ID} or S-CSIRS_Config_{index} for S-CSI-RS, S-DMRS_PSSCH_Config_{ID} or S-DMRS_PSSCH_Config_{index} for S-DMRS of a PSSCH, wherein the configuration may include the allocation in time, frequency, and space respectively.

The transmit power may be, for example, S-SSB_{power} as the transmit power level and/or SDMRS_SSSB_{poweroffset} as the power offset from the S-SS for S-DMRS of an S-SSB; S-CSIRS_{power} for transmit power level and/or S-CSIRS_{poweroffset} for transmit power level offset from S-SSB of a periodic CSI-RS; PSSCH_{power} as the transmit power level for S-DMRS of PSSCH if same power level as the associated PSSCH and/or SDMRSPSSCH_{poweroffset} as the power offset for S-DMRS of PSSCH from the associated PSSCH power level.

For example, the periodic transmission occasions and related transmit power of a sidelink measuring signal, e.g., S-SS and/or S-DMRS of PSBCH, periodic S-CSI-RS, S-DMRS of PSSCH carrying periodic message with fixed transmit power level (e.g., maximum transmit power for broadcast), etc., may be pre-configured by the access network or V2X server or by the service provider or device manufacture, or statically configured via Radio Resource Control (RRC) or V2X Non-Access Stratum (NAS) from the access network or V2X server if within the network coverage; or by a Road Side Unit (RSU), a proximity lead, a scheduling UE, or a group lead while joining a group or by a peer UE while pairing with the UE via Sidelink Radio Resource Control (SL-RRC) at PC5 interface, e.g. PC5-RRC, or the broadcasting message carried on PSBCH of a selected S-SSB on sidelink as sidelink system information. For another example, the periodic transmission occasions and related transmit power of a sidelink measuring signal, e.g., periodic S-CSI-RS, S-DMRS of PSSCH carrying periodic message with semi-static transmit power level, etc., may also be semi-statically indicated by MAC CE from the access network if within the network coverage, or a Road Side Unit (RSU), a proximity lead, a scheduling UE, a group lead or a paired UE via sidelink MAC (SL-MAC) CE via SL-RRC or the broadcasting message carried on PSSCH on sidelink. If power control is applied to the periodic sidelink measuring signal, the corresponding transmit power, S_CSIRS_TxPower for periodic S-CSI-RS, or SL_PSSCH_TxPower for S-DMRS of PSSCH, may also be dynamically signaled by gNB on downlink with the Downlink Control Information (DCI) carried on PDCCH from the access network if within the network coverage, or dynamically signaled on sidelink with the Sidelink Control Information (SCI) carried on PSCCH from an RSU, a proximity lead, a scheduling UE, a group lead or a transmitting UE.

Similar to the periodic measuring signals, aperiodic transmission occasions of a sidelink measuring signal and the related transmit power should be known to UEs in a proximity for sidelink path loss measurements. An aperiodic sidelink measuring signal may be aperiodic S-CSI-RS, S-DMRS of PSDCH for discovery, S-DMRS of PSCCH for scheduling and decoding, or S-DMRS of PSSCH for aperiodic messaging.

Similar to the periodic measuring signals, the transmission occasions of an aperiodic sidelink measuring signal may include, for example, an allocation in time within a slot or subframe or a frame, e.g., Time_{symbol}, length in time, e.g., Timeₗₑₙₜₕ in symbols, slots, subframes or frames, or pattern in time, e.g., Timeₚₐₜₜₑᵣₙ such as a bitmap in symbol with a slot, a subframe or a frame; an allocation in frequency, e.g., Frequency_{PRB_num} as Physical Resource Block (PRB) number or index, or Frequency_{subch_num} as subchannel number or index, or Frequency_{RE_num} as Resource Element (RE) number or index Frequencyₚₐₜₜₑᵣₙ as frequency pattern within a sidelink bandwidth part (SL-BWP); and an allocation in space, ASCSIRS_{ID} or ASCSIRSRS_{index} for aperiodic S-CSI-RS, or QCL relationship with S-SSB or S-CSI-RS or Transmission Configuration Indicator (TCI) state associated with the S-SSB or S-CSI-RS for S-DMRS port of PSDCH, S-DMRS port of PSCCH, or S-DMRS port of PSSCH.

Similar to the periodic measuring signals, the transmission occasion may also be indicated by the configuration ID or index, e.g., AS-CSIRS_Config_{ID} or AS-CSIRS_Config_{index} for aperiodic S-CSI-RS, S-DMRS_PSDCH_Config_{ID} or S-DMRS_PSDCH_Config_{index} for S-DMRS of a PSDCH, S-DMRS_PSCCH_Config_{ID} or S-DMRS_PSCCH_Config_{index} for S-DMRS of a PSCCH, S-DMRS_PSSCH_Config_{ID}, or S-DMRS_PSSCH_Config_{index} for S-DMRS of a PSSCH with aperiodic messaging, wherein the configuration may include the allocation in time, frequency, and space respectively.

Similar to the periodic measuring signals, the transmit power may be, for example, AS-CS/RS_{power} for transmit power level and/or AS-CS/RS_{poweroffset} for transmit power level offset from S-SSB of an aperiodic S-CSI-RS; PSDCH_{power} as the transmit power level for S-DMRS of PSDCH if same power level as the associated PSDCH and/or SDMRSPSDCH_{poweroffset} as the power offset for S-DMRS from the associated PSDCH power level; PSCCH_{power} as the transmit power level for S-DMRS of PSCCH if same power level as the associated PSCCH and/or SDMRSPSCCH_{poweroffset} as the power offset for S-DMRS from the associated PSCCH power level; PSSCH_{power} as the transmit power level for S-DMRS of PSSCH if same power level as the associated PSSCH and/or SDMRSPSSCH_{poweroffset} as the power offset for S-DMRS from the associated PSSCH power level.

Similar to the periodic measuring signals, the transmission occasions and related transmit power of an aperiodic sidelink measuring signal may be pre-configured or configured via RRC on Uu interface or SL-RRC on PC5 interface, semi-statically via MAC CE on Uu interface or SL-MAC CE on PC5 interface or dynamically indicated via DCI on Uu interface by a gNB or a V2X server via Uu if under the network coverage or via SCI on PC5 interface by an RSU, a proximity lead, a scheduling UE, a group lead or a paired UE or the transmitting UE if out of the network coverage. The transmission may be activated and/or deactivated by DCI on downlink sent from a gNB or V2X server if within the network coverage, or by SCI on sidelink sent from an RSU, a proximity lead, a scheduling UE, a group lead if under locally centralized control, or self-announced or self-managed by a paired UE or the transmitting UE for a fully distributive V2X network in proximity. If S-DMRS of PSCCH or PSSCH or S-CSI-RS transmitted with PSSCH, the transmit power may be adjusted via transmit power control. But the power level is not expected to change during each path loss measurement period or interval. The transmit power may also be indicated in the SCI associated to the PSSCH, e.g., indicated in the SCI for decoding the associated PSSCH. For example, a transmitting UE may send S-DMRS associated to a PSSCH or insert S-CSI-RS with a PSSCH, a receiving UE or receiving UEs may measure the sidelink RSRP and may report to the transmitting UE. The reporting occasion or time interval may be configured via RRC or SL-RRC, or MAC CE or SL MAC CE, and the triggering of reporting may be implicitly from receiving a S-DMRS or S-CSI-RS with a PSSCH or may be explicitly from an indication carried in SCI or from SL-MAC CE.

For static synchronization sources, e.g., S-SSB, periodic transmissions may be more efficient. For dynamic synchronization sources, e.g., S-SSB, or S-CSI-RS or S-DMRS as a sidelink reference signal for synchronization (SL-RS-Sync), aperiodic transmissions may be a better choice for the tradeoff between needed synchronization sources in a proximity and interferences among the synchronization sources in a proximity, as well as the efficient usage of sidelink resources for transmitting S-SSBs in a proximity.

The S-SS and/or S-DMRS of PSBCH within an S-SSB may be transmitted periodically on a sidelink from an RSU, a proximity lead, a group lead or a synchronization source UE, with the transmit power as part of S-SSB configuration for configuration based transmit power control for S-SSB or with the transmit power indicated in S-SSB transmission for open-loop transmit power control for S-SSB.

Aperiodic S-SSB(s) may be activated or deactivated on a sidelink based on the synchronization source situation in the proximity, and the transmit power may be as part of the S-SSB configuration activated or deactivated by an RSU, proximity lead, group lead or a synchronization source UE, the transmit power may be indicated in S-SSB transmission for open-loop transmit power control for S-SSB.

Similarly, the S-CSI-RS may be transmitted periodically on a sidelink from an RSU, a proximity lead, a scheduling UE, a group lead or a synchronization source UE or a paired UE with the transmit power as part of the S-CSI-RS configuration or with the transmit power based on the S-SSB transmit power setting (e.g., with an offset from S-SSB transmit power) or with the transmit power indicated for S-CSI-RS transmission for open-loop transmit power control for S-CSI-RS.

Aperiodic S-CSI-RS(s) may be activated or deactivated for a time interval, or scheduled or inserted with a PSSCH transmission on a sidelink, based on the S-CSI-RS allocation and request in the proximity, and the transmit power may be as part of the aperiodic S-CSI-RS configuration activated or deactivated, or the transmit power may be indicated by S1-MAC CE or SCI for aperiodic S-CSI-RS transmission for open-loop transmit power control for aperiodic S-CSI-RS, or the transmit power may be based on the S-SSB transmit power with an offset for aperiodic S-CSI-RS transmit power level for a V2X service.

The S-DMRS of periodic PSDCH may be transmitted periodically from an RSU, a proximity lead, a scheduling UE, a group lead or a synchronization source UE or a UE wanting to be discovered with the transmit power as part of the PSDCH configuration, or based on the S-SSB transmit power with an offset for discovery transmit power level for a V2X service, or dynamically indicated for a PSDCH transmission per the transmit power control for a PSDCH.

The S-DMRS with an aperiodic PSDCH may also be transmitted if a UE wants to be discovered with the transmit power as part of the PSDCH configuration, or based on the S-SSB transmit power with an offset for discovery transmit power level for a V2X service, or dynamically indicated by SCI for a PSDCH transmission per the transmit power control for a PSDCH.

The S-DMRS of PSCCH and/or PSSCH may be transmitted periodically from an RSU, a proximity lead, a scheduling UE, a group lead or a synchronization source UE for periodic broadcasting messages as an example with the transmit power as part of the PSCCH and/or PSSCH configuration or dynamically indicated for a PSCCH and/or PSSCH transmission per the transmit power control for the PSCCH and/or PSSCH.

The S-DMRS with an aperiodic PSCCH and/or PSSCH may also be transmitted for dynamic signal and/or data transmissions with the transmit power indicated implicitly or explicitly with SCI as part of open-loop and/or closed-loop transmit power control for the PSCCH and/or PSSCH.

### Sidelink Open-Loop TPC

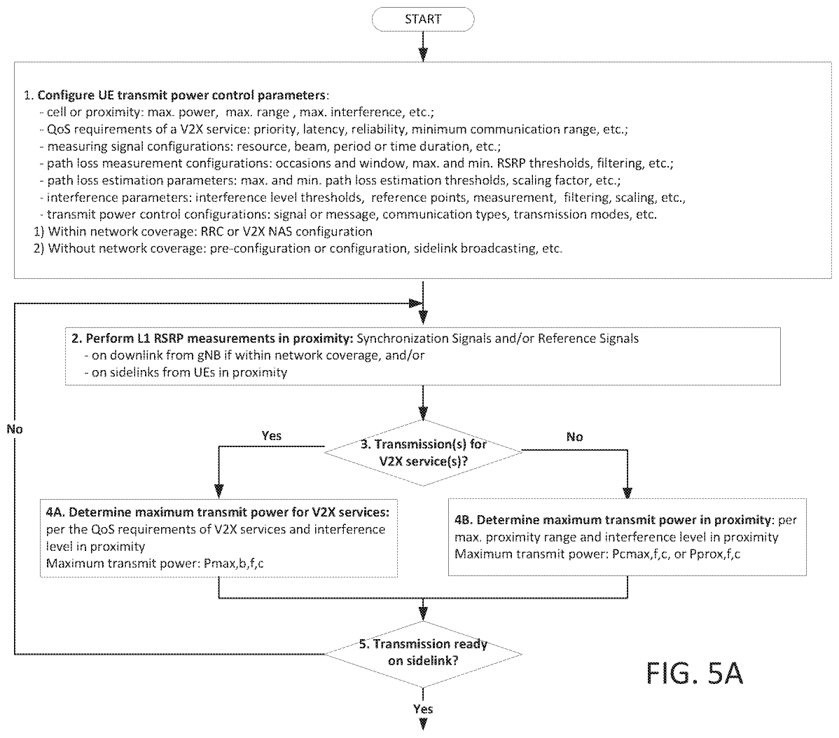

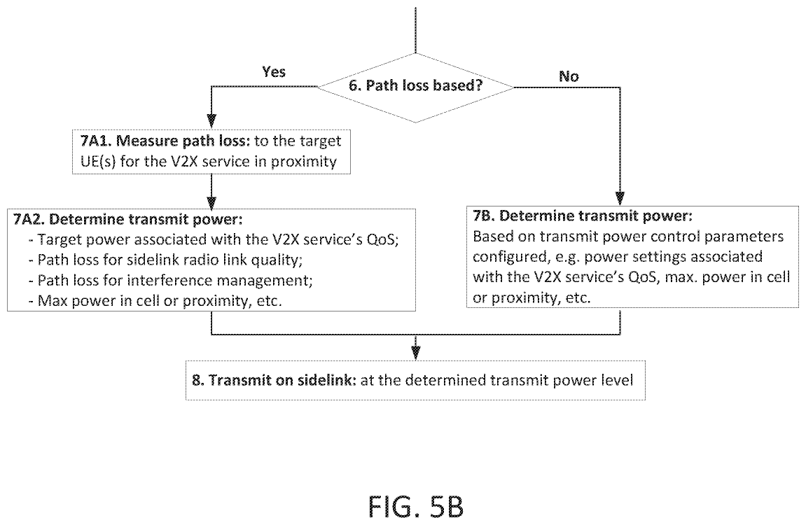

For NR sidelink, open-loop transmit power control may be conducted per a selected power value for a V2X service based on its QoS requirements, such as priority, latency, reliability, minimum service range, interference, congestion control, etc., from a set of transmit power values configured for a set of V2X services, e.g. configuration based open-loop power control; and/or may be conducted per the path loss estimation based on DL path loss measurements for interference control and/or SL path loss measurements for sidelink path loss compensation as discussed previously, e.g., path loss based open-loop power control with interference control and/or sidelink path loss compensation. A high-level overview of the proposed open-loop transmit power control procedure is depicted in FIG. 5A and FIG. 5B, which may contain the following steps.

At step 1, configure UE QoS parameters, interference control parameters, transmit power control parameters: The UE's transmit power control may contain the following configurable parameters as an example:

Cell or proximity based: max power in cell and/or in proximity, max. coverage range in proximity, max. allowable interference level in proximity, etc.;

QoS requirements of a V2X service: priority, latency, reliability, minimum communication range, etc.;

Measuring signal configurations: resource configurations, beam association or correspondence, antenna or antenna port configuration, period or time duration for measuring, transmit power level, etc.;

Path loss measurement configurations: measuring occasions and time window, max. and min. RSRP thresholds, filtering parameters, etc.;

Path loss estimation parameters: max. and min. path loss estimation thresholds, scaling factor, numerology scaling, target power level, etc.;

Interference parameters: interference level thresholds, interference reference points (e.g., gNB of access network, RSU, proximity lead, group lead, or a synchronization source UE, etc. in a proximity of a UE), interference measurement configurations and filtering parameters, interference scaling factors, target interference power level, etc.; and

Transmit power control configurations: transmit power control (TPC) for difference signal or message transmissions of a V2X service, TPC for different communication types (e.g., unicast, groupcast, or broadcast), TPC for different transmission modes (e.g. NR Mode 1 or Mode 2), etc.

These parameters may be pre-configured and/or configured or reconfigured via RRC or SL-RRC or V2X NAS configuration if within a network coverage. They may also be pre-configured by manufacture or service provider via V2X server, configured during group discovery and joining a group or peer discovery and pairing with a peer UE, or broadcasted via sidelink broadcast messages (e.g., sidelink system information) from an RSU, proximity lead, a group lead or a synchronization source UE.

At step 2, perform L1 RSRP measurements in proximity: The physical layer or Layer 1 (L1) RSRP measurements, which may be filtered with layer 2 or layer 3 filters for higher layer RSRP, in the proximity may be measured from the following measuring signals as an example:

Downlink: SS and/or DMRS of PBCH of SSBs, or CSI-RS on Uu interface from gNB if within network coverage; and/or

Sidelinks: S-SS and/or S-DMRS of PSBCH of S-SSBs, S-CSI-RS, or S-DMRS of PSDCH, PSCCH and/or PSSCH, or a combination of them from RSUs, proximity leads, group leads, synchronization source UEs; or S-CSI-RS, or S-DMRS of PSDCH, PSCCH and/or PSSCH, or a combination of them from UEs in a proximity, e.g., from a transmitting UE or a receiving UE.

At step 3, transmission(s) for V2X service(s): any transmission for a V2X service or transmissions for V2X services in proximity configured or pre-scheduled? If no transmission for a V2X service is configured or pre-scheduled, go to step 4B; otherwise, go to Step 4A.

At step 4A, determine maximum transmit power for V2X services in a proximity: decide the maximum transmit power for V2X services in proximity per the QoS requirements of V2X services, such as priority, priority, latency, reliability, minimum communication range, etc., and interference level in proximity measured at step 2, as well as the maximum transmit power for a V2X service, e.g., P_{max, b, f, c} per BWP b per carrier f per cell c.

At step 4B, determine maximum transmit power in a proximity: decide the maximum transmit power in a proximity per max. proximity range and interference level in proximity measured at step 2, as well as the maximum transmit power, e.g., P_{cmax, f, c} or P_{prox, f, c} per carrier f per cell c.

At step 5, a transmission ready on sidelink? Check if any signal or message is ready for a configured or scheduled transmission. If no, return to step 2; otherwise, move to step 6.

At step 6, path loss based? Check if the transmit power control is based on path loss. If yes, go to 7A1 and then 7A2; otherwise, go to 7B.

At step 7A1, measure path loss: Measure the sidelink path loss to the target UE(s) or receiving path loss measurement from the target UE(s) for a V2X service in proximity.

At step 7A2, determine transmit power: Decide the transmit power for the configured or scheduled transmission of a V2X service based on the following parameters.

Target power: on sidelink associated with the V2X service's QoS, such as priority, latency, reliability, minimum communication range, etc. target interference power level for interference control;

Path loss for sidelink radio link quality, measured at step 7A1;

Path loss for interference management, measured at step 2;

Max power in cell or proximity, etc.

At step 7B, determine transmit power: Decide the transmit power for the configured or scheduled transmission of a V2X service based on transmit power control parameters configured if there is no path loss measured or reported, e.g., power settings associated with the V2X service's QoS, max. power setting in cell or proximity, etc. Set transmit power based on configuration may be applicable when there is no sidelink path loss measurement for the initial transmissions such as S-SSB, or discovery channels. This is also applicable for the initial transmission or for a very low latency V2X services which may need to be transmitted immediately when the signal or data is ready for transmitting, e.g., no time for measuring the path loss as shown at step 7A1. Another example is using the path loss for interference management if no sidelink path loss is measured or received.

At step 8, transmit on sidelink: Transmit the signal or message on the sidelink at the determined transmit power level.

### Sidelink TPC for Synchronization Signal Block

A synchronization source may be static or dynamic to the UE(s) in the proximity of the synchronization source. Some of the synchronization sources are at fixed absolution location without any mobility such as a gNB and an RSU, some of the synchronization sources are at fixed relative location with very low relative mobility to the UEs in its proximity such as a proximity lead and a group lead, and some of the synchronization sources are at changing relative locations with high relative mobility to some of the UEs in its proximity due to different speed and/or moving directions such as a synchronization source UE in a fully distributed V2X network in a proximity.

A V2X network may be formed in the proximity of a synchronization source such as a gNB, an RSU, a proximity lead, a group lead, or a synchronization source UE. Due to different speeds and moving directions, V2X networks may be merged or split according to the available synchronization sources.

### Configured TPC for Synchronization

For a fixed location or very low relative mobility synchronization source, the transmit power may be set per configuration, e.g. statically or fixed at a selected power level for a required V2X service range in a proximity.

For NR sidelink, the transmit power of Sidelink Primary Synchronization Signal (S-PSS) P_{SPSS}, the transmit power of Sidelink Secondary Synchronization Signal (S-SSS) P_{SSSS}, the transmit power of Physical Sidelink Broadcast Channel (PSBCH) P_{PSBCH} may be configured by the higher layer with different QoS requirements, e.g., high power level may be configured for a V2X service which requires for high priority, low latency, high reliability, and/or large minimum communication range. For example, a set of {\hat{P}_{SPSS}(i), \hat{P}_{SSSS}(i), \hat{P}_{PSBCH}(i)} may be configured corresponding to a V2X service proximity range \hat{R}ₚᵣₒₓ(i), defined or mapped with the QoS requirements such as priority, latency, reliability, minimum communication range, interference, congestion control, etc., and with transmission beam or panel configuration j, where j is one of B beams or panel for simultaneous multi-beam or multi-panel or antenna transmission, as in the following:

$${P}_{SPSS , b , f , c , j} ( i ) = \frac{1}{B} \cdot min \{ {P}_{C M A X , f , c} , {\hat{P}}_{SPSS , b , f , c} ( i ) \} dBm , \\ {P}_{SSSS . b , f , c , j} ( i ) = \frac{1}{B} \cdot min \{ {P}_{CMAX , f , c} , \frac{1}{B} \cdot {\hat{P}}_{SSSS , b , f , c} ( i ) \} dBm , \\ {P}_{PSBCH , b , f , c , j} ( i ) = \frac{1}{B} \cdot min \{ {P}_{CMAX , f , c} , \frac{1}{B} \cdot {\hat{P}}_{PSBCH , b , f , c} ( i ) \} dBm , \qquad$$

where b is for an active sidelink BWP, f is for a carrier, c is for a serving cell, i is an index or ID for a V2X service mapped with the QoS requirements, and j is for a beam for multi-beam or for the panel for multi-panel transmissions.

In another way, the transmit power of Sidelink Synchronization Signal (S-SS) P_{S-SS} or transmit power of Sidelink Synchronization Signal Block (S-SSB) P_{S-SSB} may be configured for S-SSB containing S-PSS, S-SSS and PSBCH by the higher layer with different QoS requirements. For example, a set of {\hat{P}_{S-SS}(i)} or a set of {\hat{P}_{S-SB}(i)} may be configured corresponding to a V2X service proximity range \hat{R}ₚᵣₒₓ(i) defined or mapped with the QoS requirements such as priority, latency, reliability, minimum communication range, interference, congestion control, etc., with transmit beam or panel or antenna j (where j is one of B beams or panels for simultaneous multi-beam or multi-panel or multi-antenna transmission), as follows:

$${P}_{SPSS , b , f , c , j} ( i ) = {P}_{SSSS , b , f , c , j} ( i ) = {P}_{PSBCH , b , f , c , j} ( i ) = \frac{1}{B} \cdot min \{ {P}_{C MAX , f , c} , {\hat{P}}_{S - SS , b , f , c} ( i ) \} dBm , or \\ {P}_{SPSS , b , f , c , j} ( i ) = {P}_{SSSS , b , f , c , j} ( i ) = {P}_{PSBCH , b , f , c , j} ( i ) = \frac{1}{B} \cdot min \{ {P}_{C MAX , f , c} , {\hat{P}}_{S - SS , b , f , c} ( i ) \} dBm \qquad$$

There may be power offset between S-PSS and S-SSS, e.g., 0 dB, 3 dB. The power of S-SSS may be adjusted accordingly based on this offset. The power offset, e.g., P_{SSSSoffset}, may be configured by the higher layer as part of the S-SS or S-SSB configuration.

If the S-DMRS of the PSBCH within a S-SSB is boosted with transmit power, the power offset P_{PSBCHoffset} may be configured by the higher layer as part of the S-SSB configuration, where the power offset may be a constant or a set of {\hat{P}_{PBSCHoffset}(i)} corresponding to proximity range \hat{R}ₚᵣₒₓ(i) requirement for different V2X services. With the power offset, the transmit power of PSBCH within a S-SSB for a proximity range \hat{R}ₚᵣₒₓ(i) of a V2X service on beam or panel j, where j is one of B beams or panels or antenna for simultaneous multi-beam or multi-panel or multi-antenna transmission, may be adjusted as follows.

$${P}_{PSBCH , b , f , c , j} ( i ) = \frac{1}{B} \cdot min \{ {P}_{C MAX , f , c} , {\hat{P}}_{S - SS , b , f , c} ( i ) + {\hat{P}}_{PSBCHoffset , b , f , c} ( i ) \} dBm , or \\ {P}_{PSBCH , b , f , c , j} ( i ) = \frac{1}{B} \cdot min \{ {P}_{C MAX , f , c} , {\hat{P}}_{S - SS , b , f , c} ( i ) + {\hat{P}}_{PSBCHoffset , b , f , c} ( i ) \} dBm . \qquad$$

The P_{CMAX,f,c} is the configured maximum UE transmit power for carrier f of cell c, where cell c may be a serving cell if under the network coverage or a virtual “cell” in proximity if out of network coverage. A virtual cell may be one or multiple proximities formed with one or multiple V2X services respectively in a local area with one or multiple synchronization sources, where a virtual lead such as RSU or proximity lead may assist and manage the V2X configurations, interference level in the proximity, channel accessing, resource allocation and reservation, etc. among the V2X services in this local area.

TPC with Interference Management for Synchronization

For a moving synchronization source, its transmit power may be adjusted for inference management in a proximity. For example, the transmit power may be reduced if it is approaching a gNB or an RSU and the transmit power may be increased if it is departing from a gNB or an RSU, for reducing interference to the gNB or the RSU.

If inband interference management is included in the open-loop transmit power control for S-SSB, path losses may be measured from N interference reference points, such as gNB if under the network coverage as shown in FIG. 3 (a), or an RSU, a proximity lead, a group lead or a synchronization source UE as the UE A shown in FIG. 4(a). The transmit power for S-PSS, S-SSS, and PSBCH of a S-SSB for a required proximity range \hat{R}ₚᵣₒₓ(i) of a V2X service on beam or panel or antenna j, where j is one of B beams or panels or antennas for simultaneous multi-beam or multi-panel multi-antenna transmission, may be set as follows.

With a targeted power P₀(i) on the sidelink adjusted with path loss PL_{b,f,c}^{int}(s, n) measured from all interference reference points (i.e. n=0, . . . N−1):

$${P}_{S P S S , b , f , c , j} ( i , s ) = \frac{1}{B} \cdot min \{ \begin{matrix}{P}_{CMAX , f , c} , 10 \cdot {log}_{10} ( {2}^{μ} \cdot {M}_{R B}^{S P S S} ) + {P}_{O\_ S P S S , b , f , c} ( i ) + \\ {f ( {α}_{S P S S , b , f , c}^{i n t} ( i , n ) \cdot {PL}_{b , f , c}^{i n t} ( s , n ) ) \vert}_{n = 0}^{N - 1}\end{matrix} \} dBm \\ {P}_{S S S S , b , f , c , j} ( i , s ) = \frac{1}{B} \cdot min \{ \begin{matrix}{P}_{CMAX , f , c} , 10 \cdot {log}_{1 \; 0} ( {2}^{μ} \cdot {M}_{R B}^{S S S S} ) + {P}_{{O\_ }_{SSSS} , b , f , c} ( i ) + \\ {f ( {α}_{S S S S , b , f , c}^{i n t} ( i , n ) \cdot {PL}_{b , f , c}^{i n t} ( s , n ) ) \vert}_{n = 0}^{N - 1}\end{matrix} \} dBm {P}_{P S B C H , b , f , c , j} ( i , s ) = \frac{1}{B} \cdot min \{ \begin{matrix}{P}_{CMAX , f , c} , 10 \cdot {log}_{1 \; 0} ( {2}^{μ} \cdot {M}_{R B}^{PSBCH} ) + {P}_{{O\_ }_{PSBCH} , b , f , c} ( i ) + \\ {f ( {α}_{P S B C H , b , f , c}^{i n t} ( i , n ) \cdot {PL}_{b , f , c}^{i n t} ( s , n ) ) \vert}_{n = 0}^{N - 1}\end{matrix} \} dBm \qquad$$

With a targeted power P₀ (i, n) for interference reference point n (n=0, . . . N−1):

$${P}_{S P S S , b , f , c , j} ( i , s ) = \frac{1}{B} \cdot min \{ \begin{matrix}{P}_{CMAX , f , c} , 10 \cdot {log}_{10} ( {2}^{μ} \cdot {M}_{R B}^{S P S S} ) + \\ {f ( {P}_{{O\_ }_{S P S S} , b , f , c} ( i , n ) + {α}_{S P S S , b , f , c}^{i n t} ( i , n ) \cdot {PL}_{b , f , c}^{i n t} ( s , n ) ) \vert}_{n = 0}^{N - 1}\end{matrix} \} dBm , \\ {P}_{S S S S , b , f , c , j} ( i , s ) = \frac{1}{B} \cdot min \{ \begin{matrix}{P}_{CMAX , f , c} , 10 \cdot {log}_{1 \; 0} ( {2}^{μ} \cdot {M}_{R B}^{S S S S} ) + \\ {f ( {P}_{{O\_ }_{SSSS} , b , f , c} ( i , n ) + {α}_{S S S S , b , f , c}^{i n t} ( i , n ) \cdot {PL}_{b , f , c}^{i n t} ( s , n ) ) \vert}_{n = 0}^{N - 1}\end{matrix} \} dBm , {P}_{P S B C H , b , f , c , j} ( i , s ) = \frac{1}{B} \cdot min \{ \begin{matrix}{P}_{CMAX , f , c} , 10 \cdot {log}_{1 \; 0} ( {2}^{μ} \cdot {M}_{R B}^{PSBCH} ) + \\ {f ( {P}_{{O\_ }_{PSBCH} , b , f , c} ( i , n ) + {α}_{P S B C H , b , f , c}^{i n t} ( i , n ) \cdot {PL}_{b , f , c}^{i n t} ( s , n ) ) \vert}_{n = 0}^{N - 1}\end{matrix} \} dBm \qquad$$

The P_{CMAX, f, c} is the configured maximum UE transmit power for carrier f of cell c, where cell c may be a virtual “cell” in proximity if out of network coverage or a serving cell if under the network coverage.

The M_{RB}^{SPSS}, M_{RB}^{SSSS}, and M_{RB}^{PSBCH} are S-PSS, SSS and PSBCH frequency resource assignments in resource blocks respectively, which are scaled with 2¹¹ where pt. corresponds to a subcarrier spacing of a numerology.

The P_{O_SPSS,b,f,c}(i), P_{O_SSSS,b,f,c}(i), and P_{O_PSBCH,b,f,c}(i) are S-PSS, S-SSS and PSBCH target powers respectively at the sidelink receiver or P_{O_SPSS,b,f,c}(i, n), P_{O_SSSS,b,f,c}(i, n), and P_{O}_{_{PSBCH}}_{,b,f,c}(i, n) target power for interference reference point n (n=0, . . . , N−1) for a proximity range \hat{R}ₚᵣₒₓ(i) of a V2X service on sidelink BWP b of carrier f of cell c, where cell c may be a virtual “cell” in proximity if out of network coverage or a serving cell if under the network coverage. For example, the target power may be set per the minimum communication range of a V2X service, or per the maximum allowable interference to an interference reference point or per the maximum allowable interference to the interference reference points in the proximity.

The α_{SPSS,b,f,c}^{int}(i, n), α_{SSSS,b,f,c}^{int}(i, n), and α_{PSBCH,b,f,c}^{int}(i, n) are S-PSS, S-SSS and PSBCH interference reference point path loss scaling factors, e.g., the weighting of the path loss measured from an interference reference point, respectively for a proximity range \hat{R}ₚᵣₒₓ(i) of a V2X service from an interference reference point n on BWP b of carrier f of cell c, where cell c may be a virtual “cell” in proximity if out of network coverage or a serving cell if under the network coverage.

The PL_{b,f,c}^{int}(s,n) is the nth interference reference point path loss measured from an interference reference point n with measuring signal configuration s on BWP b of carrier f of cell c, where cell c may be a virtual “cell” in proximity if out of network coverage or a serving cell if under the network coverage. The reference points may be a gNB as illustrated in FIG. 3 (a), or may be an RSU, a proximity lead, a group lead or a synchronization source UE as the UE A illustrated in FIG. 4(a).

For a proximity range \hat{R}ₚᵣₒₓ(i) of a V2X service, the inband interference based path loss PL_{b,f,c}^{int}(s, n) may be weighted or scaled with α_{SPSS,b,f,c}^{int}(i, n), α_{SSSS,b,f,c}^{int}(i, n), and α_{PSBCH,b,f,c}^{int}(i, n) for S-PSS, SSS and PSBCH respectively. For example, a value of 0.5 for α_{PSSS,b,f,c}^{int}(i, n) may set the transmit power adjustment for S-PSS based on PL_{b,f,c}^{int}(s, n) measurement in half scale, e.g., less considering the inband interference; or a value of 1.0 for α_{PSSS,b,f,c}^{int}(i, n) may set the transmit power adjustment for S-PSS based on PL_{b,f,c}^{int}(s, n) measurement in full scale, e.g., fully considering the inband interference.

The f of ƒ(α_{SPSS,b,f,c}^{int}(i, n)·PL_{b,f,c}^{int}(s, n))|ₙ₌₀^{N-1} or ƒ(P_{O}_{_{_SPSS,b,f,c}}(i, n)+α_{SPSS,b,f,c}^{int}(i, n)·PL_{b,f,c}^{int}(s, n))| for SPSS as an example may be a minimum function

$${min}_{n = 0 , … , N - 1} ( {α}_{SPSS , b , f , c}^{i n t} ( i , n ) \cdot {PL}_{b , f , c}^{i n t} ( s , n ) ) , or$$

$${min}_{n = 0 , … , N - 1} ( {P}_{{O}_{\_SPSS} , b , f , c} ( i , n ) + {α}_{SPSS , b , f , c}^{i n t} ( i , n ) \cdot {PL}_{b , f , c}^{i n t} ( s , n ) )$$

for most interference control, or a maximum function

$${min}_{n = 0 , … , N - 1} ( {α}_{SPSS , b , f , c}^{i n t} ( i , n ) \cdot {PL}_{b , f , c}^{i n t} ( s , n ) ) , or$$

$${min}_{n = 0 , … , N - 1} ( {P}_{{O}_{\_SPSS} , b , f , c} ( i , n ) + {α}_{SPSS , b , f , c}^{i n t} ( i , n ) \cdot {PL}_{b , f , c}^{i n t} ( s , n ) )$$

for least interference control, or a scaled averaging function η_{SPSS,b,f,c}^{int}(i)Σₙ₌₀^{n=N-1}α_{SPSS,b,f,c}^{int}(i, n)·PL_{b,f,c}^{int}(s, n) or η_{SPSS,b,f,c}^{int}(i)Σₙ₌₀^{n=N-1}P_{O}_{_{_SPSS}}_{,b,f,c}(i, n)+α_{SPSS,b,f,c}^{int}(i, n)·PL_{b,f,c}^{int}(s, n) for a scaled average interference control.

For f as a minimum function, e.g.,

$${f ( {α}_{SPSS , b , f , c}^{i n t} ( i , n ) \cdot {PL}_{b , f , c}^{i n t} ( s , n ) ) \vert}_{n = 0}^{N - 1} as$$

$${min}_{n = 0 , … , N - 1} ( {α}_{SPSS , b , f , c}^{i n t} ( i , n ) \cdot {PL}_{b , f , c}^{i n t} ( s , n ) ) ,$$

for example, if the PL measured on downlink from a gNB is smaller than the PL measured from an RSU, the PL of gNB is taken as the limit for more interference control, and thus a lower transmit power is set according to a closer distance to an interference reference point gNB (e.g. based on smaller PL which is resulting from closer distance with gNB). In this more interference control case, RSU will get less than required interference level.

For f as a maximum function,

$${f ( {α}_{SPSS , b , f , c}^{i n t} ( i , n ) \cdot {PL}_{b , f , c}^{i n t} ( s , n ) ) \vert}_{n = 0}^{N - 1} as$$

$${min}_{n = 0 , … , N - 1} ( {α}_{SPSS , b , f , c}^{i n t} ( i , n ) \cdot {PL}_{b , f , c}^{i n t} ( s , n ) ) ,$$

for example, if the PL measured on downlink from a gNB is smaller than the PL measured from an RSU, the PL of RSU is taken as the limit for less interference control, and thus a higher transmit power is set according to a further distance to an interference reference point RSU (e.g. based on larger PL which is resulting from further distance with RSU). In this less interference control case, gNB will suffer more interference.

For f as a weighted average function, ƒ(α_{SPSS,b,f,c}^{int}(i, n)·PL_{b,f,c}^{int}(s, n))|ₙ₌₀^{N-1} as η_{SPSS,b,f,c}^{int}(i)Σₙ₌₀^{n=N-1}α_{SPSS,b,f,c}^{int}(i, n)·PL_{b,f,c}^{int}(s, n), for example, if the PL measured on downlink from a gNB is smaller than the PL measured from an RSU, a scaled averaged value of gNB's PL and RSU's PL is taken as the limit for average interference control, and thus a transmit power is set higher for gNB's interference control and lower for RSU's interference control (e.g. based on an average PL between gNB and RSU). In this scaled average interference control, gNB will suffer a little more interference and RSU will get a little less than required interference, e.g. balanced interference control among the interference reference points.

The η_{SPSS,b,f,c}^{int}(i), η_{SSSS,b,f,c}^{int}(i), and η_{PSBCH,b,f,c}^{int}(i) are S-PSS, S-SSS and PSBCH total interference reference point path loss scaling factors respectively for a proximity range \hat{R}ₚᵣₒₓ(i) of a V2X service from N interference reference points on sidelink BWP b of carrier ƒ of cell c, where cell c may be a virtual “cell” in proximity if out of network coverage or a serving cell if under the network coverage. For example, η_{SPSS,b,f,c}^{int}(i)=1/N is for the total path loss averaged with the weighted or scaled path losses measured from N interference reference points.

### Sidelink TPC for Discovery

### Configured TPC for Discovery

For NR sidelink, the transmit power for discovery message carried on dedicated Physical Sidelink Discovery Channel (PSDCH), e.g., P_{PSDCH}, or on shared Physical Sidelink Control Channel (PSCCH), e.g., P_{PSCCHdisc}, and Physical Sidelink Shared Channel (PSSCH), e.g., P_{PSSCHdisc}, may be configured by the higher layer with different QoS requirements. For illustration purpose, PSDCH is used for discovery channel in the following examples. For example, a set of {\hat{P}_{PSDCH}(i)} or {\hat{P}_{PSCCHdisc}(i), \hat{P}_{PSSCHdisc}(i)} may be configured corresponding to a proximity range \hat{R}ₚᵣₒₓ(i) of a V2X service on beam j, where j is one of B beams for simultaneous multi-beam transmission, as follows:

$${P}_{P S DCH , b , f , c , j} ( i ) = \frac{1}{B} \cdot min \{ {P}_{CMAX , f , c} , {\hat{P}}_{PSDCH , b , f , c} ( i ) \} dBm , \\ {P}_{PSCCHdisc , b , f , c , j} ( i ) = \frac{1}{B} \cdot min \{ {P}_{CMAX , f , c} , {\hat{P}}_{PSCCHdisc , b , f , c} ( i ) \} dBm , \\ {P}_{PSSCHdisc , b , f , c , j} ( i ) = \frac{1}{B} \cdot min \{ {P}_{CMAX , f , c} , {\hat{P}}_{PSSCHdisc , b , f , c} ( i ) \} dBm . \qquad$$

If the transmit power for discovery is set based on the transmit power of S-SS or S-SSB, e.g., with a power offset configured or indicated by higher layer, the transmit power for discovery channels may be set as the follows using S-SSB as an example.

$${P}_{PSDCH , b , f , c , j} ( i ) = \frac{1}{B} \cdot min \{ {P}_{CMAX , f , c} , {\hat{P}}_{SSSB , b , f , c} ( i ) + {\hat{P}}_{PSDCHoffset , b , f , c} ( i ) \} dBm , \\ {P}_{PSCCHdisc , b , f , c , j} ( i ) = \frac{1}{B} \cdot min \{ {P}_{CMAX , f , c} , {\hat{P}}_{SSSB , b , f , c} ( i ) + {\hat{P}}_{PSCCHoffset , b , f , c} ( i ) \} dBm , \\ {P}_{PSSCH , b , f , c , j} ( i ) = \frac{1}{B} \cdot min \{ {P}_{CMAX , f , c} , {\hat{P}}_{SSSB , b , f , c} ( i ) + {\hat{P}}_{PSSCHoffset , b , f , c} ( i ) \} dBm . \qquad$$

TPC with Interference Management for Discovery

If inband interference management is included in the open-loop transmit power control for discovery channel(s), the path loss measured from N interference reference points, such as gNB if under the network coverage as shown in FIG. 3 (a), or an RSU, a proximity lead, a group lead or a synchronization source UE as the UE A shown in FIG. 4(a). The transmit power of discovery message carried on dedicated PSDCH, or on shared PSCCH and PSSCH for a proximity range \hat{R}ₚᵣₒₓ(i) of a V2X service on beam j, where j is one of B beams for simultaneous multi-beam transmission, may be set as follows.

$${P}_{PSDCH , b , f , c , j} ( i , s ) = \frac{1}{B} \cdot min \{ \begin{matrix}{P}_{CMAX , f , c} , 10 \cdot {log}_{10} ( {2}^{μ} \cdot {M}_{R B , b , f , c}^{PSDCH} ) + {P}_{{O \_ }_{PSDCH} , b , f , c} ( i ) + \\ {η}_{PSDCH , b , f , c}^{i n t} ( i ) {\sum }_{n = 0}^{n = N - 1} {α}_{PSDCHS , b , f , c}^{i n t} ( i , n ) \cdot {PL}_{b , f , c}^{i n t} ( s , n )\end{matrix} \} dBm , \\ {P}_{PSCCHdisc , b , f , c , j} ( i , s ) = \frac{1}{B} \cdot min \{ \begin{matrix}{P}_{CMAX , f , c} , 10 \cdot {log}_{10} ( {2}^{μ} \cdot {M}_{R B , b , f , c}^{PSCCHdisc} ) + {P}_{{O\_ }_{PSCCHdisc} , b , f , c} ( i ) + \\ {η}_{PSCCHdisc , b , f , c}^{i n t} ( i ) {\sum }_{n = 0}^{n = N - 1} {α}_{PSCCHSdisc , b , f , c}^{i n t} ( i , n ) \cdot {PL}_{b , f , c}^{i n t} ( s , n )\end{matrix} \} dBm , \\ {P}_{PSSCHdisc , b , f , c , j} ( i , s ) = \frac{1}{B} \cdot min \{ \begin{matrix}{P}_{CMAX , f , c} , 10 \cdot {log}_{10} ( {2}^{μ} \cdot {M}_{R B , b , f , c}^{PSSCHdisc} ) + {P}_{{O\_ }_{PSSCHdisc} , b , f , c} ( i ) + \\ {η}_{PSSCHdisc , b , f , c}^{i n t} ( i ) {\sum }_{n = 0}^{n = N - 1} {α}_{PSSCHdisc , b , f , c}^{i n t} ( i , n ) \cdot {PL}_{b , f , c}^{i n t} ( s , n )\end{matrix} \} dBm \qquad$$

Similar to the synchronization power control, the transmit power control with interference management may also be generally described as the follows.
With a targeted power P_{0_PSDCH, b,f,c} (i) on the sidelink receiver based on QoS requirement such as minimum communication range, latency, reliability, etc., adjusted with path loss PL_{b,f,c}^{int}(s,n) measured from all interference reference points (i.e. n=0, . . . N−1):

$${P}_{P S D C H , b , f , c , j} ( i , s ) = \frac{1}{B} \cdot min \{ \begin{matrix}{P}_{CMAX , f , c} , 10 \cdot {log}_{1 \; 0} ( {2}^{μ} \cdot {M}_{R B}^{PSDCH} ) + {P}_{{O\_ }_{PSDCH} , b , f , c} ( i ) + \\ {f ( {α}_{P S D C H , b , f , c}^{i n t} ( i , n ) \cdot {PL}_{b , f , c}^{i n t} ( s , n ) ) \vert}_{n = 0}^{N - 1}\end{matrix} \} dBm ,$$

With a targeted power P_{0_PSDCH,b,f,c} (i, n) for interference reference point n (n=0, . . . N−1) based on interference control to the interference reference point:

$${P}_{P S D C H , b , f , c , j} ( i , s ) = \frac{1}{B} \cdot min \{ \begin{matrix}{P}_{CMAX , f , c} , 10 \cdot {log}_{1 \; 0} ( {2}^{μ} \cdot {M}_{R B}^{PSDCH} ) + \\ {f ( {P}_{{O\_ }_{PSDCH} , b , f , c} ( i , n ) + {α}_{PSDCH , b , f , c}^{i n t} ( i , n ) \cdot {PL}_{b , f , c}^{i n t} ( s , n ) ) \vert}_{n = 0}^{N - 1}\end{matrix} \} dBm ,$$

where the f may be a minimum function, maximum function, weighted average function, etc.

The M_{RB,b,f,c}^{PSDCH}, M_{RB,b,f,c}^{PSCCHdisc}, and M_{RB,b,f,c}^{PSSCHdisc} are dedicated discovery channel PSDCH, and shared discovery channel PSCCH and PSSCH frequency resource assignments in resource blocks respectively on BWP b of carrier f of cell c, which are scaled with 2^{μ} where μ is a subcarrier space of a numerology.

The P_{O_PSDCH,b,f,c}(i), P_{O_PSCCHdisc,b,f,c}(i), and P_{O_PSSCHdisc,b,f,c}(i) are dedicated discovery channel PSDCH, and shared discovery channel PSCCH and PSSCH target powers respectively at the receiver for a proximity range \hat{R}ₚᵣₒₓ(i) of a V2X service on BWP b of carrier ƒ of cell c, where cell c may be a virtual “cell” in proximity if out of network coverage or a serving cell if under the network coverage. For example, the target power may be set per the minimum communication range for a V2X service, or per the maximum allowable interference to an interference reference point or per the maximum allowable interference to the interference reference points in the proximity.

The α_{PSDCH,b,f,c}^{int}(i, n), α_{PSCCHdisc,b,f,c}^{int}(i, n), and α_{PSSCHdisc,b,f,c}^{int}(i, n) are dedicated discovery channel PSDCH, and shared discovery channel PSCCH and PSSCH interference reference point path loss scaling factors respectively for a proximity range \hat{R}ₚᵣₒₓ(i) of a V2X service on BWP b of carrier f of cell c, where cell c may be a virtual “cell” in proximity if out of network coverage or a serving cell if under the network coverage.

The PL_{b,f,c}^{int}(s, n) is the nth interference reference point path loss measured from a reference point on BWP b of carrier ƒ of cell c, where cell c may be a virtual “cell” in proximity if out of network coverage or a serving cell if under the network coverage. The reference points may be a gNB as illustrated in FIG. 3 (a), and may be an RSU, a proximity lead, a group lead or a synchronization source UE as the UE A illustrated in FIG. 4(a).

For a proximity range \hat{R}ₚᵣₒₓ(i) of a V2X service, the inband interference based path loss PL_{b,f,c}^{int}(s, n) may be scaled with α_{PSDCH,b,f,c}^{int}(i, n), α_{PSCCHdisc,b,f,c}^{int}(i, n), and α_{PSSCHdisc,b,f,c}^{int}(i, n) for dedicated discovery channel PSDCH, and shared discovery channel PSCCH and PSSCH respectively. For example, a value of 0.5 for α_{PSDCH,b,f,c}^{int}(i, n) may set the transmit power adjustment for PSDCH based on PL_{b,f,c}^{int}(s, n) measurement in half scale, e.g., less considering the inband interference; or a value of 1.0 for α_{PSDCH,b,f,c}^{int}(i, n) may set the transmit power adjustment for PSDCH based on PL_{b,f,c}^{int}(s, n) measurement in full scale, e.g., fully considering the inband interference.

The η_{PSDCH,b,f,c}^{int}(i, n), η_{PSCCHdis,b,f,c}^{int}(i, n), and η_{PSSCHdisc,b,f,c}^{int}(i, n) are dedicated discovery channel PSDCH and shared discovery channel PSCCH and PSSCH total interference reference point path loss scaling factors respectively for a proximity range \hat{R}ₚᵣₒₓ(i) of a V2X service from N interference reference points on BWP b of carrier f of cell c, where cell c may be a virtual “cell” in proximity if out of network coverage or a serving cell if under the network coverage. For example,

$${η}_{PSDCH , b , f , c}^{i n t} ( i , n ) = \frac{1}{N}$$

is for the total path loss averaged with the weighted or scaled path losses measured from N interference reference points.

### Adjustable TPC for Discovery

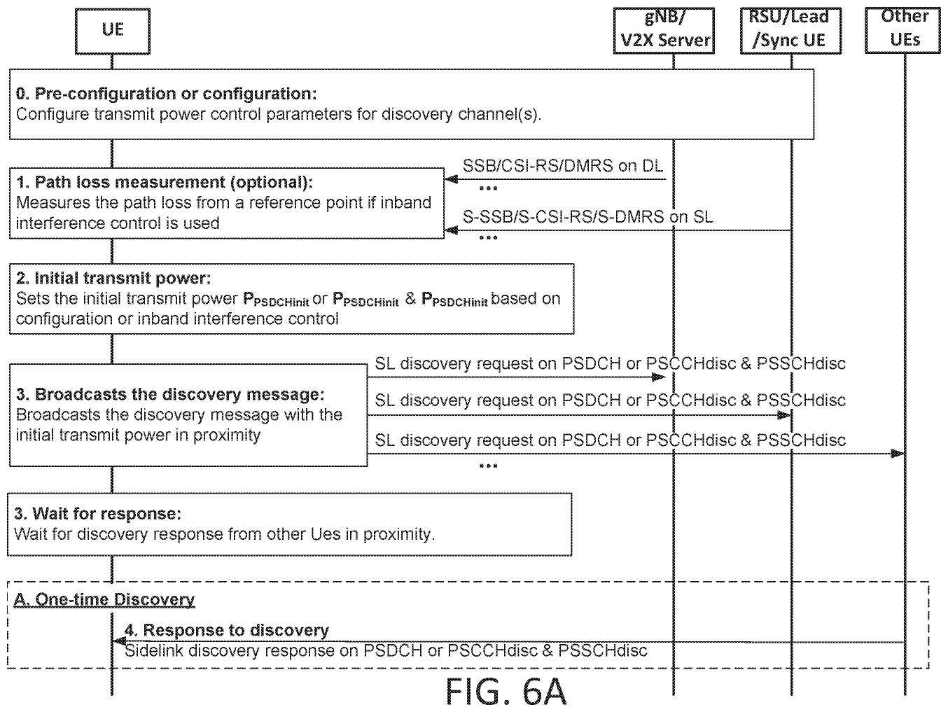

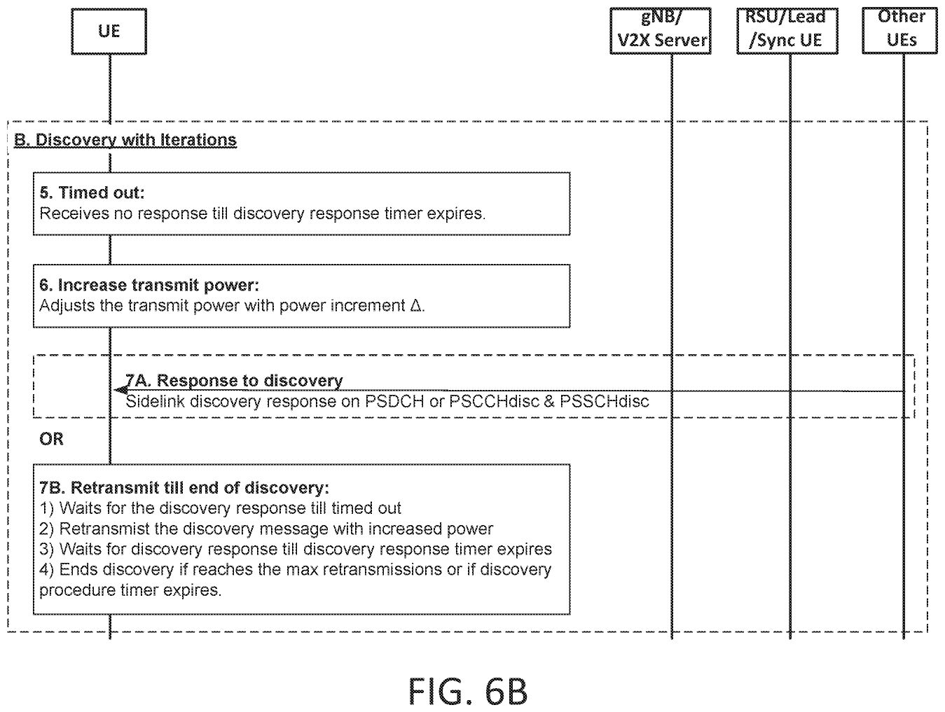

The discoverable range may be highly related to the level of transmit power. The higher transmit power, the larger discoverable area in the proximity. For some advanced NR V2X services where fast discovery is required, an open-loop adjustable transmit power scheme is exemplified in FIG. 6A and FIG. 6B, which may contain the following steps as an example.

At step 0, pre-configuration or configuration: configure QoS, interference management, transmit power control parameters for discovery channel(s) by gNB if under network coverage (i.e. mode 1), or by RSU, a Lead, a synchronization source UE if out of network coverage (i.e. mode 2).

At step 1, path loss measurement (optional): measures the path loss from a reference point if inband interference control is used with SSB/CSI-RS/DMRS on DL or S-SSB/S-CSI-RS/S-DMRS on SL.

At step 2, initial transmit power: sets the initial transmit power P⁰_{PSDCH} based on configuration described herein or inband interference control described herein or maximum transmit power.

At step 3, broadcasts the discovery request: broadcasts the discovery message with the initial transmit power in proximity, e.g., sidelink discovery request on PSDCH or PSCCHdisc & PSSCHdisc

A. One-Time Discovery

At step 4, response to discovery request: a receiving UE(s) sends sidelink discovery response on PSDCH or PSCCHdisc & PSSCHdisc with the transmit power determined by the measured RSRP of the S-DMRS of PSDCH, or PSCCH and PSSCH and the related transmit power configured or indicated with the discovery request message, as well as the reporting measured RSRP or sidelink path loss from the receiving UE to the transmitting UE.

OR

B. Discovery with Iterations

At step 5, timed out: receives no response till when the discovery response searching window ends or when the discovery response timer expires

At step 6, increase transmit power: adjusts the transmit power at kth (k>0) transmission occasion with power increment [symbol] (k) for a proximity range \hat{R}ₚᵣₒₓ(i) of a V2X service on beam j, where j is one of B beams for simultaneous multi-beam transmission, may be set as the follows.

$${P}_{PSDCH , b , f , c , j}^{k} ( i ) = \frac{1}{B} \cdot min \{ {P}_{CMAX , f , c} , {P}_{MAXdisc , f , c} ( i ) , {P}_{PSDCH , b , f , c , j}^{k - 1} ( i ) + {Δ}_{PSDCH , b , f , c , j} ( i , k ) \} dBm , \\ {P}_{PSCCH , b , f , c , j}^{k} ( i ) = \frac{1}{B} \cdot min \{ {P}_{CMAX , f , c} , {P}_{MAXdisc , f , c} ( i ) , {P}_{PSCCH , b , f , c , j}^{k - 1} ( i ) + {Δ}_{PSCCHdisc , b , f , c , j} ( i , k ) \} dBm , \\ {P}_{PSDCH , b , f , c , j}^{k} ( i ) = \frac{1}{B} \cdot min \{ {P}_{CMAX , f , c} , {P}_{MAXdisc , f , c} ( i ) , {P}_{PSDCH , b , f , c , j}^{k - 1} ( i ) + {Δ}_{PSSCHdisc , b , f , c , j} ( i , k ) \} dBm ,$$

If inband interference management is included in the TPC setting, then the adjusted transmit power for discovery channels may be set as the follows.

$${P}_{PSDCH , b , f , c , j}^{k} ( i , s ) = \frac{1}{B} \cdot min \{ {P}_{CMAX , f , c} , {P}_{MAXdisc , f , c} ( i ) , {P}_{PSDCH , b , f , c , j}^{k - 1} ( i , s ) + {Δ}_{PSDCH , b , f , c , j} ( i , k ) \} dBm , \\ {P}_{PSCCH , b , f , c , j}^{k} ( i , s ) = \frac{1}{B} \cdot min \{ {P}_{CMAX , f , c} , {P}_{MAXdisc , f , c} ( i ) , {P}_{PSCCH , b , f , c , j}^{k - 1} ( i , s ) + {Δ}_{PSCCHdisc , b , f , c , j} ( i , k ) \} dBm , \\ {P}_{PSSCH , b , f , c , j}^{k} ( i , s ) = \frac{1}{B} \cdot min \{ {P}_{CMAX , f , c} , {P}_{MAXdisc , f , c} ( i ) , {P}_{PSSCH , b , f , c , j}^{k - 1} ( i , s ) + {Δ}_{PSSCH , b , f , c , j} ( i , k ) \} dBm ,$$

The P_{MAXdisc,f,c}(i) is maximum allowable transmit power for discovery corresponding to a proximity range \hat{R}ₚᵣₒₓ(i) of a V2X service.

The P_{PSDCH,b,f,c,j}^{k-1}(i, s), P_{PSCCH,b,f,c,j}^{k-1}(i, s) and P_{PSSCH,b,f,c,j}^{k-1}(i, s) are the transmit power at (k−1)th transmission occasion for discovery message carried on dedicated PSDCH, or on shared PSCCH and PSSCH respectively.

At step 7A, response to discovery request: sends sidelink discovery response on PSDCH or PSCCHdisc & PSSCHdisc with the transmit power determined by the measured RSRP of the S-DMRS of PSDCH, or PSCCH and PSSCH and the related transmit power configured or indicated with the discovery request message, as well as reporting the measured RSRP or sidelink path loss from the receiving UE to the transmitting UE.

OR

At step 7B, retransmit till end of discovery:

1) Waits for the discovery response till timed out;

2) Retransmits the discovery request message with increased power;

3) Waits for discovery response till discovery response timer expires; and

4) Ends discovery if reaches the maximum retransmissions or if discovery procedure timer expires.

### Sidelink TPC for Broadcast

### Configured TPC for Broadcast

For NR sidelink, the transmit power for broadcast message carried on PSCCH for short message, e.g., P_{PSCCH}, and on PSSCH, e.g., P_{PSSCH}, may be configured by the higher layer with different QoS requirements. For example, a set of {\hat{P}_{PSCCH}(i, j), \hat{P}_{PSSCH}(i, j)} may be configured corresponding to a proximity range \hat{R}ₚᵣₒₓ(i) of a V2X service with transmission configuration/or transmit beam j (where/is one of B beams for simultaneous multi-beam transmission) as follows:

P_{PSCCH,b,f,c}(i,j)=Min{P_{CMAX,f,c},\hat{P}_{PSCCH,b,f,c}(i,j)} dBm,

P_{PSSCH,b,f,c}(i,j)=min{P_{CMAX,f,c},\hat{P}_{PSSCH,b,f,c}(i,j)} dBm.

TPC with Interference Management for Broadcast

If inband interference management is included in the open-loop transmit power control for broadcast channel(s), the path loss measured from N interference reference points, such as gNB if under the network coverage as shown in FIG. 3 (a), or an RSU, a proximity lead, a group lead or a synchronization source UE as the UE A shown in FIG. 4(a). The transmit power of broadcast message carried on PSCCH and PSSCH for a proximity range \hat{R}ₚᵣₒₓ(i) of a V2X service for transmission configuration j or transmit beam j (where j is one of B beams for simultaneous multi-beam transmission) may be set as follows.

$${P}_{PSCCH , b , f , c} ( i , s , j ) = min \{ \begin{matrix}{P}_{CMAX , f , c} , 10 \cdot {log}_{10} ( {2}^{μ} \cdot {M}_{R B , b , f , c}^{PSSCH} ) + {P}_{O\_ PSCCH , b , f , c} ( i , j ) + \\ {η}_{PSCCH , b , f , c}^{i n t} ( i ) {\sum }_{n = 0}^{n = N - 1} {α}_{PSCCH , b , f , c}^{i n t} ( i , n ) \cdot {PL}_{b , f , c}^{i n t} ( s , n )\end{matrix} \} dBm , \\ {P}_{PSSCH , b , f , c} ( i , s , j ) = min \{ \begin{matrix}{P}_{CMAX , f , c} , 10 \cdot {log}_{10} ( {2}^{μ} \cdot {M}_{R B , b , f , c}^{PSSCH} ) + {P}_{O\_ P S S C H , b , f , c} ( i , j ) + \\ {η}_{PSSCH , b , f , c}^{i n t} ( i ) {\sum }_{n = 0}^{n = N - 1} {α}_{PSSCH , b , f , c}^{i n t} ( i , n ) \cdot {PL}_{b , f , c}^{i n t} ( s , n )\end{matrix} \} dBm ,$$

Similar to the synchronization power control, the transmit power control with interference management may be generally described as the follows using PSSCH as an example.
With a targeted power P_{0_PSSCH, b,f,c} (i) on the sidelink receiver based on QoS requirement such as minimum communication range, latency, reliability, etc., adjusted with path loss PL_{b,f,c}^{int}(s, n) measured from all interference reference points (i.e. n=0, . . . N−1):

$${P}_{PSSCH , b , f , c , j} ( i , s ) = \frac{1}{B} \cdot min \{ \begin{matrix}{P}_{CMAX , f , c} , \\ 10 \cdot {log}_{10} ( {2}^{μ} \cdot {M}_{RB}^{PSSCH} ) + {P}_{O \_ PSSCH , b , f , c} ( i ) + f ( {α}_{PSSCH , f , c}^{int} ( i , n ) \cdot {PL}_{b , f , c}^{int} ( s , n ) ) {\vert}_{n = 0}^{N - 1}\end{matrix} \} dBm ,$$

With a targeted power P_{0_PSSCH,b,f,c} (i, n) for interference reference point n (n=0, . . . N−1) based on interference control to the interference reference point:

$${P}_{PSSCH , b , f , c , j} ( i , s ) = \frac{1}{B} \cdot min \{ \begin{matrix}{P}_{CMAX , f , c} , \\ 10 \cdot {log}_{10} ( {2}^{μ} \cdot {M}_{RB}^{PSSCH} ) + f ( {P}_{{O}_{\_ PSSCH} , b , f , c} ( i , n ) + {α}_{PSSCH , f , c}^{int} ( i , n ) \cdot {PL}_{b , f , c}^{int} ( s , n ) ) {\vert}_{n = 0}^{N - 1}\end{matrix} \} dBm ,$$

where the f may be a minimum function, maximum function, weighted average function, etc.

The M_{RB,b,f,c}^{PSCCH}, and M_{RB,b,f,c}^{PSSCH} are PSCCH and PSSCH frequency resource assignments in resource blocks respectively on BWP b of carrier f of cell c, which are scaled with 2^{μ} where μ is a subcarrier space of a numerology.

The P_{O_PSCCH,b,f,c}(i, j) and P_{O}_{_{PSSCH}}_{,b,f,c}(i, j) are PSCCH and PSSCH target powers respectively at the receiver for a proximity range \hat{R}ₚᵣₒₓ(i) of a V2X service for transmission configuration j or transmit beam j on BWP b of carrier f of cell c, where cell c may be a virtual “cell” in proximity if out of network coverage or a serving cell if under the network coverage.

The α_{PSCCH,b,f,c}^{int}(i, n), and α_{PSSCH,b,f,c}^{int}(i, n) are PSCCH and PSSCH interference reference point path loss scaling factors respectively for a proximity range \hat{R}ₚᵣₒₓ(i) of a V2X service on BWP b of carrier f of cell c, where cell c may be a virtual “cell” in proximity if out of network coverage or a serving cell if under the network coverage.

The PL_{b,f,c}^{int}(r, s) is the nth interference reference point path loss measured from a reference point on BWP b of carrier ƒ of cell c, where cell c may be a virtual “cell” in proximity if out of network coverage or a serving cell if under the network coverage. The reference points may be a gNB as illustrated in FIG. 3 (a), and may be an RSU, a proximity lead, a group lead or a synchronization source UE as the UE A illustrated in FIG. 4(a).

For a proximity range \hat{R}ₚᵣₒₓ(i) of a V2X service, the inband interference based path loss PL_{b,f,c}^{int}(r, s) may be scaled with α_{PSCCH,b,f,c}^{int}(i, n), and α_{PSSCH,b,f,c}^{int}(i, n) for PSCCH and PSSCH respectively. For example, a value of 0.5 for α_{PSSCH,b,f,c}^{int}(i, n) may set the transmit power adjustment for PSCCH based on PL_{b,f,c}^{int}(r, s) measurement in half scale, e.g., less considering the inband interference; or a value of 1.0 for α_{PSSCH,b,f,c}^{int}(i, n) may set the transmit power adjustment for PSCCH based on PL_{b,f,c}^{int}(r, s) measurement in full scale, e.g., fully considering the inband interference.

The η_{PSCCH,b,f,c}^{int}(i, n), and η_{PSSCH,b,f,c}^{int}(i, n) are PSCCH and PSSCH total interference reference point path loss scaling factors respectively for a proximity range \hat{R}ₚᵣₒₓ(i) of a V2X service from N interference reference points on BWP b of carrier η of cell c, where cell c may be a virtual “cell” in proximity if out of network coverage or a serving cell if under the network coverage. For example,

$${η}_{PSSCH , b , f , c}^{int} ( i . n ) = \frac{1}{N}$$

is for the total path loss averaged with the weighted or scaled path losses measured from N interference reference points.

### Sidelink Closed-Loop TPC

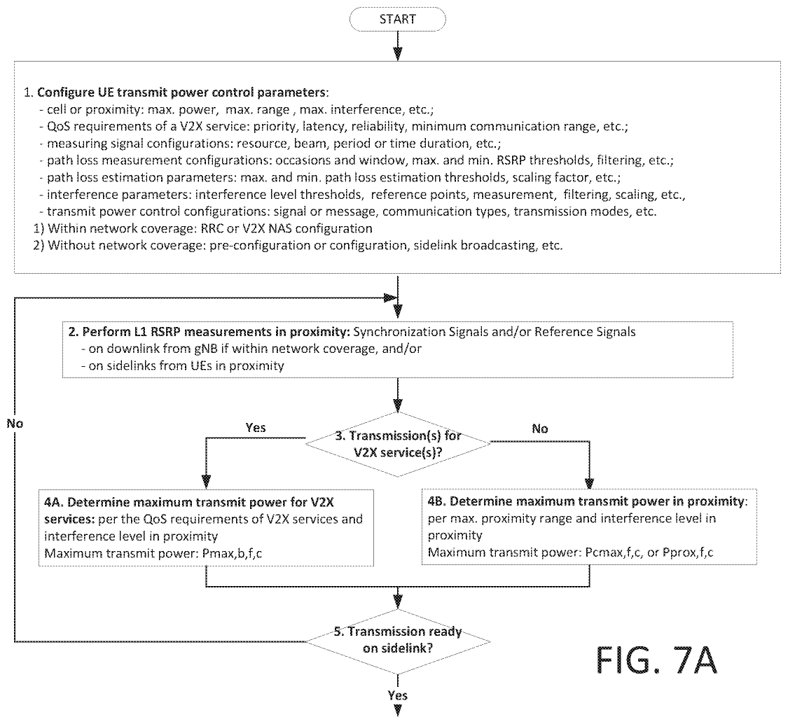

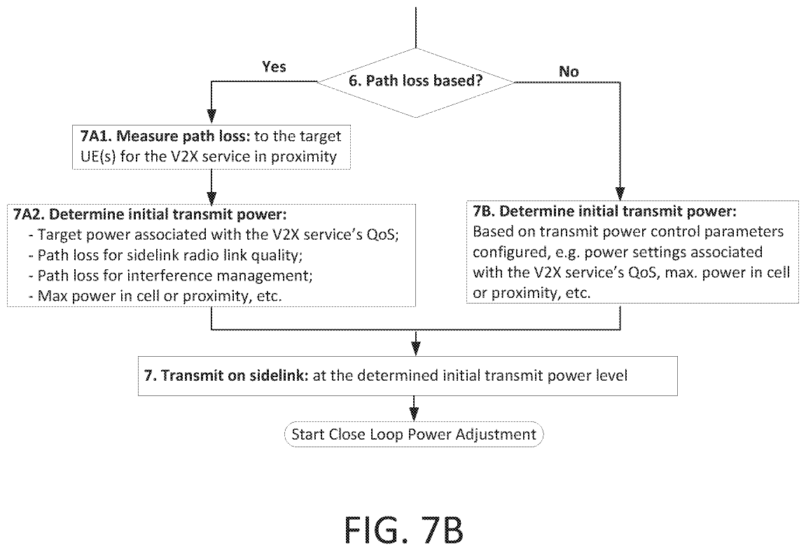

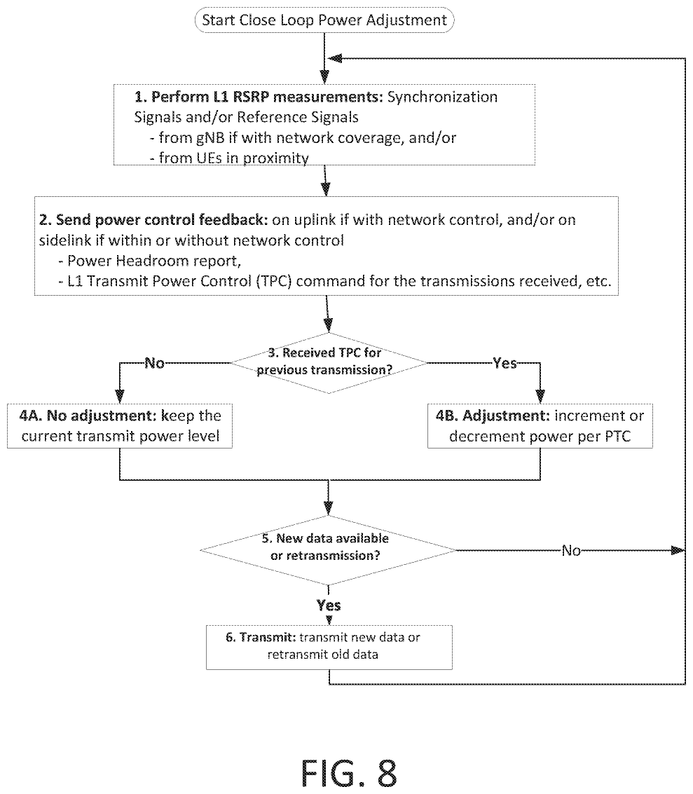

The instantaneous path loss on sidelink may vary due to radio channel fading. Hence, close-loop power control is necessary for more precise transmit power management to ensure required performance as well as avoiding unnecessary interference in the proximity. A high-level overview of the proposed closed-loop transmit power control procedure is depicted in FIG. 7A and FIG. 7B for initial transmit power control and FIG. 8 for closed-loop transmit power adjustment.

The initial transmit power control illustrated in FIG. 7A and FIG. 7B is similar to the open loop transmit power control described in FIG. 5A and FIG. 5B with one or more of path loss based interference control or sidelink pathloss compensation based transmit power control, as exemplified for synchronization signal and discovery message and broadcast message.

The closed-loop transmit power control illustrated in FIG. 8, may contain the following steps.

At step 1, perform L1 RSRP measurements: for interference management, measure RSRP from the synchronization signals and/or reference signals which may be filtered with layer 2 or layer 3 filters, e.g. SS and/or DMRS of a SSB, or CSI-RS on downlink from a gNB if under the network coverage, or the S-SS and/or S-DMRS of a S-SSB, or S-CSI-RS on sidelink from an RSU, a proximity lead, a group lead or a synchronization source UE or S-CSI-RS on sidelink from UEs in proximity. Measure or receive sidelink RSRP for sidelink path loss, which may be filtered with layer 2 or layer 3 filters.

At step 2, send power control feedback: sends power control feedback to gNB on uplink if with network control, and/or on sidelink to an RSU, a proximity lead, a group lead, a synchronization source UE, or the paired UE on a sidelink. The feedback may be Power Headroom (PH) report to gNB if in NR V2X Mode 1, or to an RSU, a proximity lead, a group lead or a synchronization source UE if in NR V2X Mode 2, The feedback may also be the measured or filtered L1 RSRP or L1 transmit power control (TPC) command for a previously received signal or message on a sidelink, e.g., S-DMRS of a PSSCH or aperiodic S-CSI-RS.

At step 3, received sidelink RSRP or sidelink TPC for previous transmission? Check if an RSRP or TPC is received for the previously transmitted signal or message. If yes, go to step 4B; otherwise, go to step 4A.

At step 4A, no adjustment: keep the current transmit power level.

At step 4B, adjustment: increase or decrease the transmit power level based on the received sidelink RSRP or TPC.

At step 5, a new data available or retransmission? Check if a new data is ready for transmission or retransmission with previous data. If yes, go to step 6; otherwise go to step 1.

At step 6, transmit: transmit the new data or retransmit the previous data with the adjusted transmit power. Then go to step 1.

Sidelink Closed-Loop TPC for Unicast

Closed-loop transmit power control starts with an initial power level, e.g., at 0th transmission occasion, and then adjust the transmit power level for the following transmissions, e.g., kth transmission accession with k>0, based on the power control feedback information, for example the TPC instruction for increasing or decreasing the power with an absolution or accumulative adjustment.

### Initial Transmit Power for Unicast

### Configured Initial Transmit Power for Unicast

For NR sidelink, the initial transmit power as an open-loop transmit power control, at 0th transmission accession, for Sidelink Channel State Information Reference Signal (S-CSI-RS), e.g., P_{SCSIRS}⁰, Sidelink Control Information (SCI) carried on PSCCH, e.g., P_{PSCCH}⁰. and sidelink control or data message carried on PSSCH, e.g., P_{PSSCH}⁰, may be configured by the higher layer with different QoS requirements. For example, a set of {\hat{P}_{SCSIRS}(i, j)}, {\hat{P}_{PSCCH}(i, j)} and {\hat{P}_{PSSCH}(i, j)} may be configured corresponding to a proximity range \hat{R}ₚᵣₒₓ(i) of a V2X service with configuration j, where j is one of C configurations for different transmissions or transmission beams, as follows:

P_{SCSIRS,b,f,c}⁰(i,j)=min{P_{CMAX,f,c},\hat{P}_{SCSIRS,b,f,c}(i,j)} dBm,

P_{PSCCH,b,f,c}⁰(i,j)=min{P_{CMAX,f,c},\hat{P}_{PSCCH,b,f,c}(i,j)} dBm,

P_{PSSCH,b,f,c}⁰(i,j)=min{P_{CMAX,f,c},\hat{P}_{PSSCH,b,f,c}(i,j)} dBm.

Initial Transmit Power with Interference Management

If inband interference management is included in the transmit power control for S-CSI-RS, PSCCH and PSSCH, the path loss measured from N interference reference points, such as gNB or gNB-like RSU if under the network coverage as shown in FIG. 3 (a), or an RSU, a proximity lead, a group lead or a synchronization source UE as the UE A shown in FIG. 4(a). The initial transmit power of unicast PSCCH and PSSCH, as an open-loop transmit power control, for a proximity range \hat{R}ₚᵣₒₓ(i) of a V2X service with configuration j, where j is one of C configurations for different transmissions messages or transmission modes or transmission beams, may be set as follows.

P_{SCSIRS,b,f,c}⁰(i,j,r,s)=min{P_{CMAX,f,c}(0),10·log₁₀(2^{μ}·M_{RE,b,f,c}^{SCSIRS}(0))+P_{O_SCSIRS,b,f,c}(i,j)+α_{SCSIRS,b,f,c}(i,j)·PL_{b,f,c}(r)+η_{SCSIRS,b,f,c}^{int}(i)Σₙ₌₀^{n=N-1}α_{SCSIRS,b,f,c}^{int}(i,n)·PL_{b,f,c}^{int}(s,n)} dBm,

P_{PSCCH,b,f,c}⁰(i,j,r,s)=min{P_{CMAX,f,c}(0),10·log₁₀(2^{μ}·M_{RB,b,f,c}^{PSCCH}(0))+P_{O_PSCCH,b,f,c}(i,j)+α_{PSCCH,b,f,c}(i,j)·PL_{b,f,c}(r)+Δ_{TF,b,f,c}(0)+Δ_{F_PSCCH}(F)+η_{PSCCH,b,f,c}^{int}(i)Σₙ₌₀^{n=N-1}α_{PSCCH,b,f,c}^{int}(i,n)·PL_{b,f,c}^{int}(s,n)} dBm,

P_{PSSCH,b,f,c}⁰(i,j,r,s)=min{P_{CMAX,f,c}(0),10·log₁₀(2^{μ}·M_{RB,b,f,c}^{PSSCH}(0))+P_{O_PSSCH,b,f,c}(i,j)+α_{PSCCH,b,f,c}(i,j)·PL_{b,f,c}(r)+Δ_{TF,b,f,c}(0)+η_{PSSCH,b,f,c}^{int}(i)Σₙ₌₀^{n=N-1}α_{PSSCH,b,f,c}^{int}(i,n)·PL_{b,f,c}^{int}(s,n)} dBm.

Similar to the synchronization power control, the transmit power control with interference management may be generally described as the follows using PSSCH as an example With a targeted power P_{0_PSSCH, b,f,c} (i) on the sidelink receiver based on QoS requirement such as minimum communication range, latency, reliability, etc., adjusted with path loss PL_{b,f,c}^{int}(s, n) measured from all interference reference points (i.e. n=0, . . . N−1):

$${P}_{PSSCH , b , f , c , j} ( i , s ) = \frac{1}{B} \cdot min \{ \begin{matrix}{P}_{CMAX , f , c} , \\ 10 \cdot {log}_{10} ( {2}^{μ} \cdot {M}_{RB}^{PSSCH} ) + {P}_{{O\_}_{PSSCH} , b , f , c} ( i ) + f ( ( {α}_{PSSCH , f , c}^{int} ( i , n ) \cdot {PL}_{b , f , c}^{int} ( s , n ) {\vert}_{n = 0}^{N - 1} ) , {α}_{PSSCH , b , f , c} ( i , j ) \cdot {PL}_{b , f , c} ( r ) )\end{matrix} \} dBm ,$$

With a targeted power P_{0_PSSCH,b,f,c} (i, n) for interference reference point n (n=0, . . . N−1) based on interference control to the interference reference point:

$${P}_{PSSCH , b , f , c , j} ( i , s ) = \frac{1}{B} \cdot min \{ \begin{matrix}{P}_{CMAX , f , c} , \\ 10 \cdot {log}_{10} ( {2}^{μ} \cdot {M}_{RB}^{PSSCH} ) + f ( ( {P}_{{O\_}_{PSSCH} , b , f , c} ( i , n ) + {α}_{PSSCH , f , c}^{int} ( i , n ) \cdot {PL}_{b , f , c}^{int} ( s , n ) ) {\vert}_{n = 0}^{N - 1} , {P}_{{O}_{PSSCH} , b , f , c} ( i , j ) + {α}_{PSSCH , b , f , c} ( i , j ) \cdot {PL}_{b , f , c} ( r ) )\end{matrix} \} dBm ,$$

where the f may be a minimum function, maximum function, weighted average function, etc.

The M_{RB,b,f,c}^{SCSIRS}(0), M_{RB,b,f,c}^{PSCCH}(0), and M_{RB,b,f,c}^{PSSCH}(0) are S-CSI-RS,PSCCH and PSSCH initial frequency resource assignments in resource blocks respectively with configuration j, where j is one of C configurations for different transmissions or transmission beams, on BWP b of carrier f of cell c.

The P_{O_SCSIRS,b,f,c}(i, j), P_{O_PSCCH,b,f,c}(i, j), and P_{O}_{_{PSSCH,b,f,c}}(i, j) are S-CSI-RS, PSCCH and PSSCH target powers respectively at the receiver for a proximity range \hat{R}ₚᵣₒₓ(i) of a V2X service with configuration j, where j is one of C configurations for different transmissions or transmission beams, on BWP b of carrier f of cell c, where cell c may be a virtual “cell” in proximity if out of network coverage or a serving cell if under the network coverage. The target power may be set per transmission configuration or transmit beam configuration, per the QoS requirement of a V2X service such as priority, latency, reliability, minimum communication range, per the interference level in proximity, etc.

The α_{SCSIRS,b,f,c}(i, j), α_{PSCCH,b,f,c}(i, j), and α_{PSSCH,b,f,c}(i, j) are S-CSI-RS, PSCCH and PSSCH path loss scaling factors respectively for a proximity range \hat{R}ₚᵣₒₓ(i) of a V2X service with configuration j, where j is one of C configurations for different transmissions or transmission beams, on BWP b of carrier f of cell c, where cell c may be a virtual “cell” in proximity if out of network coverage or a serving cell if under the network coverage.

The PL_{b,f,c}(r) is the sidelink path loss measured with a reference signal configuration r, as illustrated in FIG. 3 (b) with network coverage and FIG. 4(b) without network coverage, on BWP b of carrier f of cell c, where cell c may be a virtual “cell” in proximity if out of network coverage or a serving cell if under the network coverage. For a proximity range \hat{R}ₚᵣₒₓ(i) of a V2X service, the sidelink path loss PL_{b,f,c}(r) may be scaled with α_{SCSIRS,b,f,c}(i, j), α_{PSCCH,b,f,c}(i, j), and α_{PSSCH,b,f,c}(i, j) for S-CSI-RS, PSCCH and PSSCH respectively.

The Δ_{TF,b,f,c}(0) is the initial power adjustment related to Modulation Coding Scheme (MCS) for PSCCH and PSSCH respectively.

The Δ_{F_PSCCH}(F) is the power adjustment related to different format of PSCCH.

The α_{SCSIRS,b,f,c}^{int}(i, n), α_{PSCCH,b,f,c}^{int}(i, n), and α_{PSSCH,b,f,c}^{int}(i, n) are S-CSI-RS, PSCCH and PSSCH interference reference point path loss scaling factors respectively for a proximity range \hat{R}ₚᵣₒₓ(i) of a V2X service on BWP b of carrier f of cell c, where cell c may be a virtual “cell” in proximity if out of network coverage or a serving cell if under the network coverage.

The PL_{b,f,c}^{int}(s, n) is the nth interference reference point path loss measured from a reference point on BWP b of carrier f of cell c, where cell c may be a virtual “cell” in proximity if out of network coverage or a serving cell if under the network coverage. The reference points may be a gNB as illustrated in FIG. 3 (a), and may be an RSU, a proximity lead, a group lead or a synchronization source UE as illustrated in FIG. 4(a).

For a proximity range \hat{R}ₚᵣₒₓ(i) of a V2X service, the inband interference based path loss PL_{b,f,c}^{int}(s, n) may be scaled with α_{SCSIRS,b,f,c}(i, j), α_{PSCCH,b,f,c}(i, j), and α_{PSSCH,b,f,c}(i, j) for S-CSI-RS, PSCCH and PSSCH respectively. For example, a value of 0.5 for α_{PSCCH,b,f,c}^{int}(i, n) may set the transmit power adjustment for PSCCH based on PL_{b,f,c}^{int}(s, n) measurement in half scale, e.g., less considering the inband interference; or a value of 1.0 for α_{PSCCH,b,f,c}^{int}(i, n) may set the transmit power adjustment for PSCCH based on PL_{b,f,c}^{int}(s, n) measurement in full scale, e.g., fully considering the inband interference.

The η_{SCSIRS,b,f,c}^{int}(i, n), η_{PSCCH,b,f,c}^{int}(i, n), and η_{PSSCH,b,f,c}^{int}(i, n) are S-CSI-RS, PSCCH and PSSCH total interference reference point path loss scaling factors respectively for a proximity range \hat{R}ₚᵣₒₓ(i) of a V2X service from an interference reference point n on BWP b of carrier f of cell c, where cell c may be a virtual “cell” in proximity if out of network coverage or a serving cell if under the network coverage. For example,

$${η}_{PSSCH , b , f , c}^{int} ( i . n ) = \frac{1}{N}$$

is for the total path loss averaged with the weighted or scaled path losses measured from N interference reference points.

### Closed-Loop Transmit Power Control for Unicast

Closed-loop TPC may be conducted based on the power control feedback, e.g., the sidelink RSRP or TPC instruction. The closed-loop transmit power of unicast with PSCCH and PSSCH at kth (k>0) transmission occasion for a proximity range \hat{R}ₚᵣₒₓ(i) of a V2X service with configuration j, where j is one of C configurations for different transmissions messages or transmission modes or transmission beams, may be set as follows with the TPC feedback.

$${P}_{SCSIRS , b , f , c}^{k} ( i , j , r , s ) = min \{ {P}_{CMAX , f , c} \{ k ) , 10 \cdot {log}_{10} ( {2}^{μ} \cdot {M}_{RB , b , f , c}^{SCSIRS} ( k ) ) + {P}_{O \_ SCSIRS , b , f , c} ( i , j ) + {α}_{SCSIRS , b , f , c} ( i , j ) \cdot {PL}_{b , f , c} ( r ) + {η}_{SCSIRS , b , f , c}^{int} ( i ) {\sum }_{n = 0}^{n = N - 1} {α}_{SCSIRS , b , f , c}^{int} ( i , n ) \cdot {PL}_{b , f , c}^{int} ( s , n ) + {f}_{b , f , c} ( k , l ) \} dBm , \\ {P}_{PSSCH , b , f , c}^{k} ( i , j , r , s ) = min \{ {P}_{CMAX , f , c} \{ k ) , 10 \cdot {log}_{10} ( {2}^{μ} \cdot {M}_{RB , b , f , c}^{PSSCH} ( k ) ) + {P}_{{O}_{PSSCH} , b , f , c} ( i , j ) + {α}_{PSSCH , b , f , c} ( i , j ) \cdot {PL}_{b , f , c} ( r ) + {Δ}_{TF , b , f , c} ( k ) + {Δ}_{{F}_{PSSCH}} ( F ) + {η}_{PSSCH , b , f , c}^{int} ( i ) {\sum }_{n = 0}^{n = N - 1} {α}_{PSSCH , b , f , c}^{int} ( i , n ) \cdot {PL}_{b , f , c}^{int} ( s , n ) + {f}_{b , f , c} ( k , l ) \} dBm , \\ {P}_{PSSCH , b , f , c}^{k} ( i , j , r , s ) = min \{ {P}_{CMAX , f , c} \{ k ) , 10 \cdot {log}_{10} ( {2}^{μ} \cdot {M}_{RB , b , f , c}^{PSSCH} ( k ) ) + {P}_{O\_ PSSCH , b , f , c} ( i , j ) + {α}_{PSSCH , b , f , c} ( i , j ) \cdot {PL}_{b , f , c} ( r ) + {Δ}_{TF , b , f , c} ( k ) + {η}_{PSSCH , b , f , c}^{int} ( i ) {\sum }_{n = 0}^{n = N - 1} {α}_{PSSCH , b , f , c}^{int} ( i , n ) \cdot {PL}_{b , f , c}^{int} ( s , n ) + {f}_{b , f , c} ( k , l ) \} dBm ,$$

Similar to the synchronization power control, the transmit power control with interference management may be generally described as the follows using PSSCH as an example. With a targeted power P_{0_PSSCH, b,f,c} (i) on the sidelink receiver based on QoS requirement such as minimum communication range, latency, reliability, etc., adjusted with path loss PL_{b,f,c}^{int}(s,n) measured from all interference reference points (i.e. n=0, . . . N−1):

$${P}_{PSSCH , b , f , c , j} ( i , s ) = \frac{1}{B} \cdot min \{ {P}_{CMAX , f , c} , 10 \cdot {log}_{10} ( {2}^{μ} \cdot {M}_{RB}^{PSSCH} ) + {P}_{{O\_}_{PSSCH} , b , f , c} ( i ) + f ( ( {α}_{PSSCH , f , c}^{int} ( i , n ) \cdot {PL}_{b , f , c}^{int} ( s , n ) {\vert}_{n = 0}^{N - 1} ) , {α}_{PSSCH , b , f , c} ( i , j ) \cdot {PL}_{b , f , c} ( r ) ) + {f}_{b , f , c} ( k , l ) \} dBm ,$$

With a targeted power P_{0_PSSCH,b,f,c} (i, n) for interference reference point n (n=0, . . . N−1) based on interference control to the interference reference point:

$${P}_{PSSCH , b , f , c , j} ( i , s ) = \frac{1}{B} \cdot min \{ {P}_{CMAX , f , c} , 10 \cdot {log}_{10} ( {2}^{μ} \cdot {M}_{RB}^{PSSCH} ) + f ( ( {P}_{{O}_{PSSCH} , b , f , c} ( i , n ) + {α}_{PSSCH , f , c}^{int} ( i , n ) \cdot {PL}_{b , f , c}^{int} ( s , n ) ) {\vert}_{n = 0}^{N - 1} , {P}_{{O}_{PSSCH} , b , f , c} ( i , j ) + {α}_{PSSCH , b , f , c} ( i , j ) \cdot {PL}_{b , f , c} ( r ) ) + {f}_{b , f , c} ( k , l ) \} dBm ,$$

where the f may be a minimum function, maximum function, weighted average function, etc.

The M_{RB,b,f,c}^{SCSIRS}(k), M_{RB,b,f,c}^{PSCCH}(k), and M_{RB,b,f,c}^{PSSCH}(k) are S-CSI-RS,PSCCH and PSSCH frequency resource assignments in resource blocks respectively at kth transmission occasion with configuration j, where j is one of C configurations for different transmissions or transmission beams, on BWP b of carrier f of cell c.

The Δ_{TF,b,f,c}(k) is the power adjustment at kth transmission occasion related to MCS for PSCCH and PSSCH respectively.

The f_{b,f,c} (k, l) is the closed-loop power control adjustment state at kth transmission occasion for power control loop l or power control loop configuration l. For accumulated closed-loop power adjustment, the f_{b,f,c}(k, l) may be calculated for S-CSI-RS, PSCCH, and PSSCH respectively with the following equations as an example.

f_{b,f,c}(k,l)=f_{b,f,c}(k−k₀,l)+Σₚ₌₀^{p=Γ-1}δ_{SCSIRS,b,f,c}(p,l),

f_{b,f,c}(k,l)=f_{b,f,c}(k−k₀,l)+Σₚ₌₀^{p=Γ-1}δ_{PSCCH,b,f,c}(p,l),

f_{b,f,c}(k,l)=f_{b,f,c}(k−k₀,l)+Σₚ₌₀^{p=Γ-1}δ_{PSSCH,b,f,c}(p,l),

where
f_{b,f,c}(k−k₀,l) is the closed-loop power control adjustment state at (k−k₀)th transmission occasion for power control loop l or power control loop configuration l; and
Σₚ₌₀^{p=Γ-1} δ_{PSCCH,b,f,c}(p,l) is accumulated total of sidelink RSRP or TPC command values indicated by power control feedback received between transmission occasion k−k₀ and k for power control loop l or power control loop configuration l.

### Closed-Loop TPC Procedures for Unicast

Closed-loop TPC procedures are exemplified in this section.

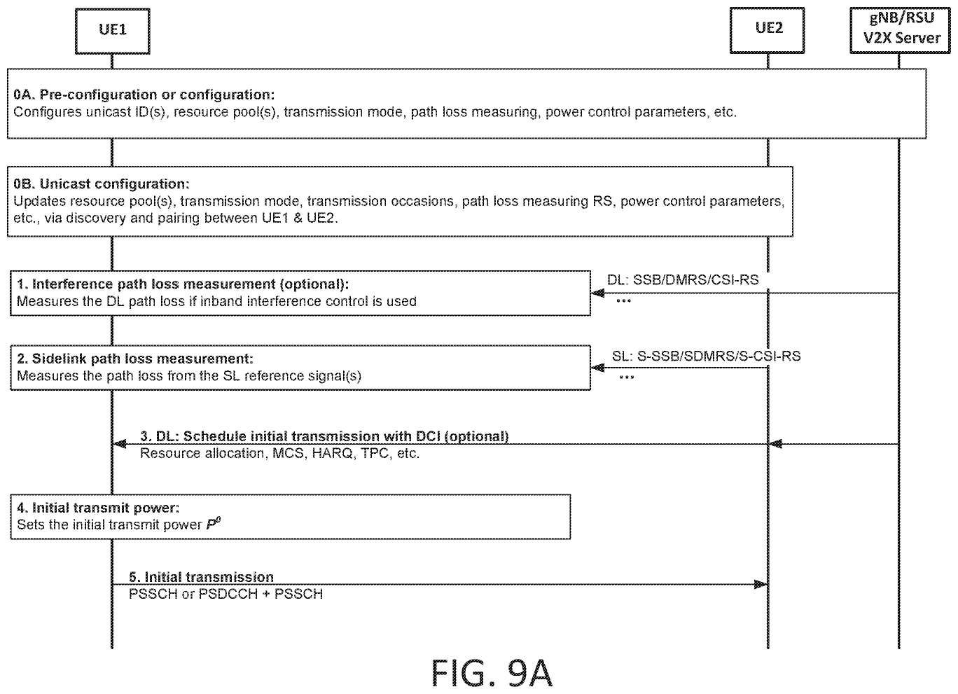

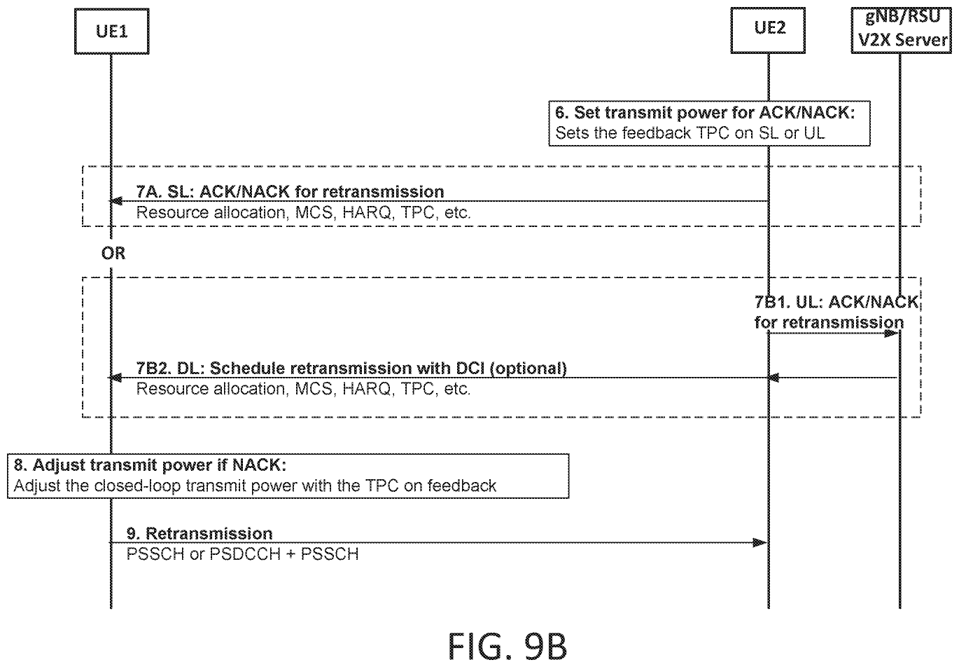

As depicted in FIG. 9A and FIG. 9B, the closed-loop power control for unicast under network coverage may contain the following steps.

At step 0A, pre-configuration or configuration: gNB or gNB-like RSU configures unicast ID(s), resource pool(s), transmission mode, path loss measuring, power control parameters, etc.

At step 0B, unicast configuration: UE1 updates resource pool(s), transmission mode, transmission occasions, path loss measuring RS, power control parameters, etc., via discovery and pairing between UE1 & UE2.

At step 1, interference path loss measurement (optional): optional if inband interference control is used. UE1 measures the DL path loss, using the PSS/SSS and/or DMRS of PBCH within SSB(s) or the CSI-RS from gNB or gNB-like RSU.

At step 2, sidelink path loss measurement: UE1 measures the path loss from the SL reference signal(s) such as S-PSS/S-SSS and/or S-DMRS of PSBCH within S-SSB(s) or S-CSI-RS or S-DMRS from UE2 or receives the path loss from UE2 of from the SL reference signal(s) such as S-PSS/S-SSS and/or S-DMRS of PSBCH within S-SSB(s) or S-CSI-RS or S-DMRS from UE1 respectively.

At step 3, schedule initial transmission with DCI (optional): optional for dynamically scheduled transmission. gNB sends sidelink schedule to UE1 only or both UE1 and UE2 with DCI(s) which may contain resource allocation, MSC, HARQ, TPC, etc.

At step 4, initial transmit power: UE1 sets the initial transmit power P° with interference or not as configured (e.g., RRC configuration) or indicated (e.g., DCI scheduling the transmission) by gNB.

At step 5, initial transmission: UE1 sends the initial transmission with PSSCH or PSDCCH and PSSCH at the initial transmit power P°.

At step 6, set transmit power for ACK/NACK: UE2 decodes the received message and calculates the transmit power for sending ACK/NACK feedback on SL to UE1 or on Uu to gNB.

For the ACK/NACK feedback on SL, UE2 may use channel reciprocal property to calculate the transmit power for ACK/NACK on SL Carried by for example PSFCH (Physical Sidelink Feedback Channel). For example, UE2 may set the feedback transmit power with UE1's initial transmit power, as indicated in the initial transmission or as configured during the pairing, adjusted with the measured RSRP, with the power adjustment indicated in RSRP or TPC on the feedback to UE1 if retransmission is needed. If the feedback requires larger communication range, the transmit power level for feedback may be based on one of configured values based on the QoS such as communication range, reliability, latency, receiving UE's location or transmitting UE and receiving UE's distance, etc., adjusted on the measured RSRP with the received PSSCH with an adjustment such as power boosting, interference control, etc.

Step 7A or Step 7B1 and 7B2.

At step 7A, ACK/NACK for retransmission: UE2 sends ACK/NACK feedback to UE1. If NACK, the retransmission settings such as resource allocation, MCS, HARQ, TPC, etc., may be included.

At step 7B1, ACK/NACK for retransmission: UE2 sends ACK/NACK feedback to gNB with UL transmit power setting as configured (e.g., RRC configuration) or indicated (e.g., DCI for the initial transmission) by gNB.

At step 7B2, schedule retransmission with DCI (optional): optional if dynamically scheduling the retransmission. The gNB schedules the retransmission on sidelink with DCI(s) containing resource allocation, MCS, HARQ, TPC, etc. to UE1 or to both UE1 and UE2

At step 8, adjust transmit power if NACK: UE1 adjusts the closed-loop transmit power per sidelink RSRP or TPC feedback from UE2, or per TPC indicated in the DCI for retransmission from gNB.

At step 9, retransmission: UE1 sends retransmission to UE2 with PSSCH or PSDCCH and PSSCH at the adjusted transmit power.

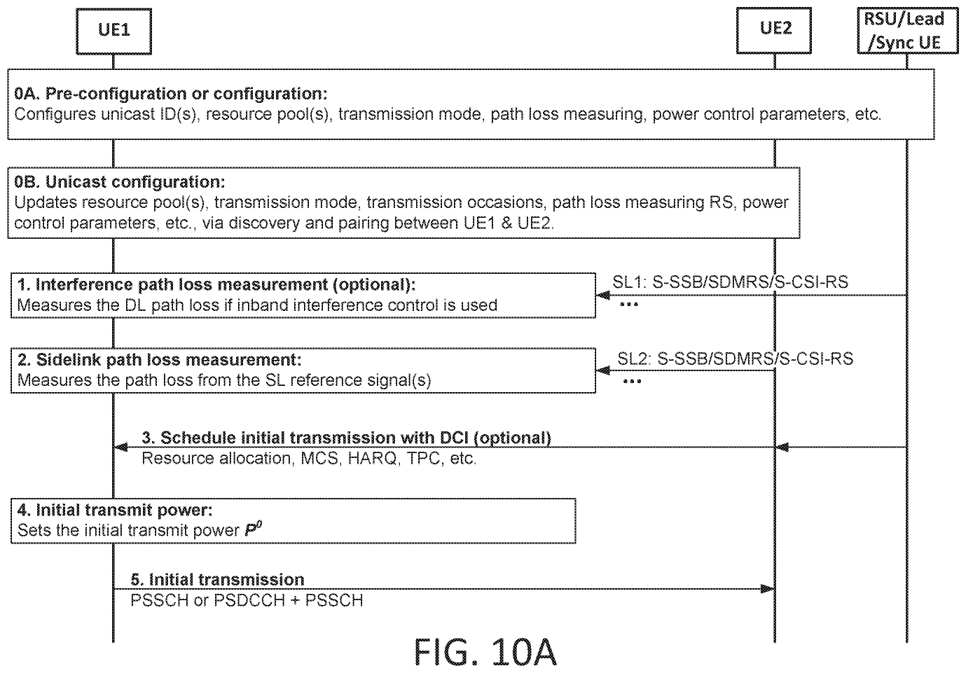

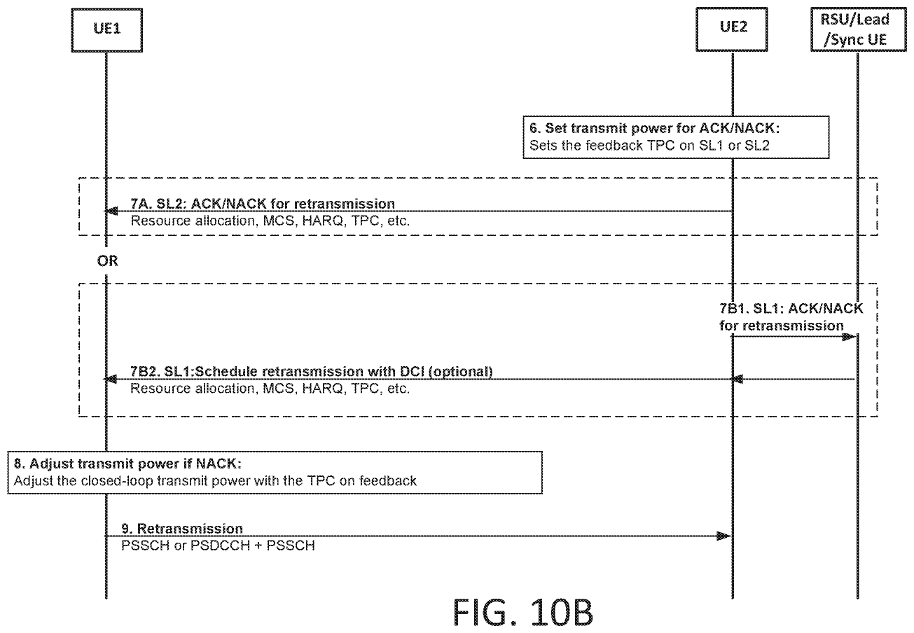

As depicted in FIG. 10A and FIG. 10B, the closed-loop power control for unicast without network coverage may contain the following steps.

At step 0A, pre-configuration or configuration: RSU, proximity lead, group lead or synchronization source UE configures unicast ID(s), resource pool(s), transmission mode, path loss measuring, power control parameters, etc.

At step 0B, unicast configuration: UE1 updates resource pool(s), transmission mode, transmission occasions, path loss measuring RS, power control parameters, etc., via discovery and pairing between UE1 & UE2.

At step 1, interference path loss measurement (optional): optional if inband interference control is used. UE1 measures the interference path loss, using the S-PSS/S-SSS and/or S-DMRS of PSBCH within S-SSB(s) or the S-CSI-RS on SL1 from RSU, proximity lead, group lead or synchronization source UE.

At step 2, sidelink path loss measurement: UE1 measures the path loss from the sidelink signal(s) such as S-PSSS/S-SSS and/or S-DMRS of PSBCH within S-SSB(s) or S-CSI-RS on SL2 from UE2, or receives the path loss from UE2 based on a previous transmission

At step 3, schedule initial transmission with DCI (optional): optional for dynamically scheduled transmission. RSU, proximity lead, group lead or synchronization source UE sends sidelink schedule to UE1 only or both UE1 and UE2 with SCI(s) which may contain resource allocation, MSC, HARQ, TPC, etc.

At step 4, initial transmit power: UE1 sets the initial transmit power P⁰ with interference or not as configured (e.g., via pairing) or indicated (e.g., SCI scheduling the transmission) by RSU, proximity lead, group lead or synchronization source UE.

At step 5, initial transmission: UE1 sends the initial transmission with PSSCH or PSDCCH and PSSCH at the initial transmit power P⁰ to UE2 on SL2.

At step 6, set transmit power for ACK/NACK: UE2 decodes the received message and calculates the transmit power for sending Sidelink Feedback Control Information (SFCI) containing ACK/NACK feedback on SL2 to UE1 or on SL1 to RSU, proximity lead, group lead or synchronization source UE.

For the ACK/NACK feedback on SL2, UE2 may use channel reciprocal property to calculate the transmit power for ACK/NACK on SL2. For example, UE2 may set the feedback transmit power with UE1's initial transmit power, as indicated in the initial transmission or as configured during the pairing, adjusted with the measured RSRP with or without power boosting which may be configured by RRC or SL-RRC or indicated by SL-MAC CE or SCI, with the power adjustment feedback indicated in RSRP or TPC on a feedback channel, such as PSSCH, to UE1 if retransmission is needed. If the feedback requires larger communication range, the transmit power level for feedback may be based on one of configured values based on the QoS such as communication range, reliability, latency, receiving UE's location or transmitting UE and receiving UE's distance, etc., and/or adjusted with the measured RSRP of the received PSSCH with an adjustment such as power boosting. The transmit power control may also use the scheme proposed for broadcast message transmit power control with or without interference control as described previously.

Step 7A or Step 7B1 and 7B2.

At step 7A, ACK/NACK for retransmission: UE2 sends SFCI containing ACK/NACK feedback on SL2 to UE1. If NACK, the retransmission settings such as resource allocation, MSC, HARQ, TPC, etc., may be included in SFCI or SCI.

At step 7B1, ACK/NACK for retransmission: UE2 sends SFCI containing ACK/NACK feedback on SL1 to RSU, proximity lead, group lead or synchronization source UE with sidelink transmit power setting as configured (e.g., via pairing) or indicated (e.g., SCI for the initial transmission) by RSU, proximity lead, group lead or synchronization source UE, or with the sidelink transmit power setting by using sidelink transmit power control scheme similar to the transmit power setting on SL2.

At step 7B2, schedule retransmission with DCI (optional): optional if dynamically scheduling the retransmission on SL. The RSU, proximity lead, group lead or synchronization source UE schedules the retransmission on SL2 with SCI(s) containing resource allocation, MSC, HARQ, TPC, etc. to UE1 or to both UE1 and UE2

At step 8, adjust transmit power if NACK: UE1 adjusts the closed-loop transmit power per RSRP or TPC feedback from UE2's SFCI on SL2, or per RSRP or TPC indicated in the SCI for retransmission from RSU, proximity lead, group lead or synchronization source UE on SL1.

At step 9, retransmission: if a NACK was received in Step 7A/B1.B2, UE1 sends retransmission to UE2 on SL2 with PSSCH or PSDCCH and PSSCH at the adjusted transmit power.

Sidelink Closed-Loop TPC for Groupcast

Closed-loop transmit power control starts with an initial power level, e.g., at 0th transmission occasion, for certain QoS requirement for a multicast or groupcast, and then adjust the transmit power level for the following transmissions, e.g., at kth (k>0) transmission occasion, based on the power control feedback information from UE(s) within the group, e.g., the TPC instructions for increasing or decreasing the power with an absolution or accumulative adjustment.

### Initial Transmit Power for Groupcast

### Configured Initial Transmit Power

For NR sidelink groupcast or multicast, the initial transmit power as an open-loop transmit power control for sidelink reference signal S-CSI-RS, e.g., P_{SCSIRSgp}⁰, Sidelink Control Information (SCI) carried on PSCCH, e.g., P_{PSCCHgp}⁰, and sidelink control or data carried on PSSCH, e.g., P_{PSSCHgp}⁰, may be configured by the higher layer with different QoS requirements. For example, a set of {\hat{P}_{SCSIRSgp}(i, j)}, {\hat{P}_{PSCCHgp}(i, j)} and {\hat{P}_{PSSCHgp}(i, j)} may be configured corresponding to a proximity range \hat{R}ₚᵣₒₓ(i) of a group with configuration j, where j is one of C configurations for different transmissions or transmission beams, as follows:

P_{SCSIRSgp,b,f,c}⁰(i,j)=min{P_{CMAX,f,c},\hat{P}_{SCSIRSgp,b,f,c}(i,j)} dBm,

P_{PSCCHgp,b,f,c}⁰(i,j)=min{P_{CMAX,f,c},\hat{P}_{PSCCHgp,b,f,c}(i,j)} dBm,

P_{PSSCHgp,b,f,c}⁰(i,j)=min{P_{CMAX,f,c},\hat{P}_{PSSCHgp,b,f,c}(i,j)} dBm.

Initial Transmit Power with Interference Management

If inband interference management is included in the transmit power control for S-CSI-RS, PSCCH and PSSCH, the path loss measured from N interference reference points, such as gNB if under the network coverage as shown in FIG. 3(a), or an RSU, a proximity lead, a group lead or a synchronization source UE as shown in FIG. 4(a). The initial transmit power of groupcast or multicast PSCCH and PSSCH for a proximity range \hat{R}ₚᵣₒₓ(i) of a group with configuration j, where j is one of C configurations for different transmissions messages or transmission modes or transmission beams, may be set as follows.

$${P}_{SCSIRSgp , b , f , c}^{0} ( i , j , r , s ) = min \{ {P}_{CMAX , f , c} \{ 0 ) , 10 \cdot {log}_{10} ( {2}^{μ} \cdot {M}_{RB , b , f , c}^{SCSIRS} ( 0 ) ) + {P}_{{O}_{SCSIRSgp} , b , f , c} ( i , j ) + \\ g ( {α}_{SCSIRSgp , b , f , c} ( i , j , q ) \cdot {PL}_{gp , b , f , c} ( r , q ) ) {\vert}_{q = 0}^{q = Q - 1} + \\ {η}_{SCSIRS , b , f , c}^{int} ( i ) {\sum }_{n = 0}^{n = N - 1} {α}_{SCSIRS , b , f , c}^{int} ( i , n ) \cdot {PL}_{b , f , c}^{int} ( s , n ) \} dBm , \\ {P}_{PSSCH , b , f , c}^{0} ( i , j , r , s ) = min \{ {P}_{CMAX , f , c} \{ 0 ) , 10 \cdot {log}_{10} ( {2}^{μ} \cdot {M}_{RB , b , f , c}^{PSSCH} ( 0 ) ) + {P}_{O\_ PSSCHgp , b , f , c} ( i , j ) + \\ g ( {α}_{PSSCHgp , b , f , c} ( i , j , q ) \cdot {PL}_{gp , b , f , c} ( r , q ) ) {\vert}_{q = 0}^{q = Q - 1} + \\ {Δ}_{TF , b , f , c} ( 0 ) + {Δ}_{F \_ PSSCH} ( F ) + {η}_{PSSCH , b , f , c}^{int} ( i ) {\sum }_{n = 0}^{n = N - 1} {α}_{PSSCH , b , f , c}^{int} ( i , n ) \cdot {PL}_{b , f , c}^{int} ( s , n ) \} dBm , \\ {P}_{PSSCHgp , b , f , c}^{0} ( i , j , r , s ) = min \{ {P}_{CMAX , f , c} \{ 0 ) , \\ 10 \cdot {log}_{10} ( {2}^{μ} \cdot {M}_{RB , b , f , c}^{PSSCH} ( 0 ) ) + {P}_{O\_ PSSCHgp , b , f , c} ( i , j ) + \\ g ( {α}_{PSSCHgp , b , f , c} ( i , j , q ) \cdot {PL}_{gp , b , f , c} ( r , q ) ) {\vert}_{q = 0}^{q = Q - 1} + {Δ}_{TF , b , f , c} ( 0 ) + {η}_{PSSCH , b , f , c}^{int} ( i ) {\sum }_{n = 0}^{n = N - 1} {α}_{PSSCH , b , f , c}^{int} ( i , n ) \cdot {PL}_{b , f , c}^{int} ( s , n ) \} dBm ,$$

Similar to the synchronization power control, the transmit power control with interference management may be generally described as the follows using PSSCH as an example. With a targeted power P_{0_PSSCH, b,f,c} (i) on the sidelink receiver based on QoS requirement such as minimum communication range, latency, reliability, etc., adjusted with path loss PL_{b,f,c}^{int}(s,n) measured from all interference reference points (i.e. n=0, . . . N−1):

$${P}_{PSSCH , b , f , c , j} ( i , s ) = \frac{1}{B} \cdot min \{ {P}_{CMAX , f , c} , 10 \cdot {log}_{10} ( {2}^{μ} \cdot {M}_{RB}^{PSSCH} ) + {P}_{{O\_}_{PSSCH} , b , f , c} ( i ) + f ( ( {α}_{PSSCH , f , c}^{int} ( i , n ) \cdot {PL}_{b , f , c}^{int} ( s , n ) {\vert}_{n = 0}^{N - 1} ) , g ( {α}_{PSSCHgp , b , f , c} ( i , j , q ) \cdot {PL}_{gp , b , f , c} ( r , q ) ) {\vert}_{q = 0}^{q = Q - 1} ) \} dBm ,$$

With a targeted power P_{0_PSSCH,b,f,c} (i, n) for interference reference point n (n=0, . . . N−1) based on interference control to the interference reference point:

$${P}_{PSSCH , b , f , c , j} ( i , s ) = \frac{1}{B} \cdot min \{ {P}_{CMAX , f , c} , 10 \cdot {log}_{10} ( {2}^{μ} \cdot {M}_{RB}^{PSSCH} ) + f ( ( {P}_{{O\_}_{PSSCH} , b , f , c} ( i , n ) + {α}_{PSSCH , f , c}^{int} ( i , n ) \cdot {PL}_{b , f , c}^{int} ( s , n ) {\vert}_{n = 0}^{N - 1} , {P}_{{O}_{PSSCH} , b , f , c} ( i , j ) + g ( {α}_{PSSCHgp , b , f , c} ( i , j , q ) \cdot {PL}_{gp , b , f , c} ( r , q ) ) {\vert}_{q = 0}^{q = Q - 1} ) \} dBm ,$$

where the f may be a minimum function, maximum function, weighted average function, etc.

The M_{RB,b,f,c}^{SCSIRS}(0), M_{RB,b,f,c}^{PSCCH}(0), and M_{RB,b,f,c}^{PSSCH}(0) are S-CSI-RS,PSCCH and PSSCH initial frequency resource assignments in resource blocks respectively with configuration j, where j is one of C configurations for different transmissions or transmission beams, on BWP b of carrier f of cell c.

The P_{O_SCSIRSgp,b,f,c}(i, j), P_{O_PSCCHgp,b,f,c}(i, j) and P_{O}_{_{PSSCHgp}}_{,b,f,c}(i, j) are S-CSI-RS, PSCCH and PSSCH target powers respectively at the receivers for a proximity range \hat{R}ₚᵣₒₓ(i) of a group with configuration j, where j is one of C configurations for different transmissions or transmission beams, on BWP b of carrier f of cell c, where cell c may be a virtual “cell” in proximity if out of network coverage or a serving cell if under the network coverage. The target power P_{O_SCSIRSgp,b,f,c}(i, j), P_{O_PSCCHgp,b,f,c}(i, j), and P_{O}_{_{PSSCHgp,b,f,c}}(i, j) may contains two components as follows.

P_{O_SCSIRSgp,b,f,c}(i,j)=P_{O_NOMINAL_SCSIRSgp,b,f,c}(i,j)+P_{O_UE_SCSIRSgp,b,f,c}(i,j),

P_{O_PSCCHgp,b,f,c}(i,j)=P_{O_NOMINAL_PSCCHgp,b,f,c}(i,j)+P_{O_UE_PSCCHgp,b,f,c}(i,j),

P_{O_PSSCHgp,b,f,c}(i,j)=P_{O_NOMINAL_PSSCHgp,b,f,c}(i,j)+P_{O_UE_PSSCHgp,b,f,c}(i,j),

where:

P_{O_NOMINAL_SCSIRSgp,b,f,c}(i, j), P_{O_NOMINAL_PSCCHgp,b,f,c}(i, j), and P_{O_NOMINAL_PSSCHgp,b,f,c}(i, j) may be configured per the priority, reliability, latency and minimum service range requirement for a V2X group with proximity range of range \hat{R}ₚᵣₒₓ(i) and transmission configuration or transmit beam configuration j for S-CSI-RS, PSCCH and PSSCH respectively, and

P_{O_UE_SCSIRSgp,b,f,c}(i, j), P_{O_UE_PSCCHgp,b,f,c}(i, j), and P_{O_UE_PSSCHgp,b,f,c}(i, j) are configured for UE specific component of a V2X group with proximity range of range \hat{R}ₚᵣₒₓ(i) and transmission configuration or transmit beam configuration j for S-CSI-RS, PSCCH and PSSCH respectively. For example, the P_{O_UE_PSSCHgp,b,f,c}(i, j) may be set differently with different reliability requirements for a groupcast or multicast, e.g., targeting to the worst, average, or best UE reception within the group based on UEs' locations within a group's proximity or on UEs' radio link quality measured from the measuring signals from the UEs within the group. For another example, P_{O_UE_PSSCHgp,b,f,c}(i, j) may be set differently with different latency requirements such as guaranteed service to all UEs in the group to minimize averaged delay caused by retransmissions or best effort service to most UEs in the group to allow certain level of averaged delay caused by retransmission.

The α_{SCSIRSgp,b,f,c}(i, j, q), α_{PSCCHgp,b,f,c}(i, j, q), and α_{PSSCHgp,b,f,c}(i, j, q) are S-CSI-RS, PSCCH and PSSCH qth (0<q<Q) path loss scaling factors respectively for a proximity range \hat{R}ₚᵣₒₓ(i) of a V2X service with configuration j, where j is one of C configurations for different transmissions or transmission beams, on BWP b of carrier f of cell c, where cell c may be a virtual “cell” in proximity if out of network coverage or a serving cell if under the network coverage.

The PL_{b,f,c}(r, q) is the sidelink qth (0≤q<Q) path loss measured from qth sidelink of total Q sidelinks, where Q may be a integer value smaller or equal to the total member UEs of a group, within a group for path loss measurement, with a reference signal configuration r, as illustrated in FIG. 3 (b) with network coverage and FIG. 4(b) without network coverage, on BWP b of carrier f of cell c, where cell c may be a virtual “cell” in proximity if out of network coverage or a serving cell if under the network coverage. For a proximity range \hat{R}ₚᵣₒₓ(i) of a V2X service, the sidelink path loss PL_{b,f,c}(r, q) may be scaled with α_{SCSIRSgp,b,f,c}(i, j, q), α_{PSCCHgp,b,f,c}(i, j, q), and α_{PSSCHgp,b,f,c}(i, j, q) for S-CSI-RS, PSCCH and PSSCH respectively.

The

$$g ( {α}_{SCSIRSgp , b , f , c} ( i , j , q ) \cdot {PL}_{gp , b , f , c} ( r , q ) ) {\vert}_{q = 0}^{q = Q - 1} , \\ g ( {α}_{PSSCHgp , b , f , c} ( i , j , q ) \cdot {PL}_{gp , b , f , c} ( r , q ) ) {\vert}_{q = 0}^{q = Q - 1} , \\ and$$

$$g ( {α}_{PSSCHgp , b , f , c} ( i , j , q ) \cdot {PL}_{gp , b , f , c} ( r , q ) ) {\vert}_{q = 0}^{q = Q - 1}$$

are function of scaled path loss measured on total Q sidelinks within a group for S-CSI-RS, PSCCH and PSSCH respectively. For example, the function may be one of the follows based on the QoS requirements such as service range, reliability, latency, etc., using PSSCH as an example below.

$$g ( {α}_{PSSCHgp , b , f , c} ( i , j , q ) \cdot {PL}_{gp , b , f , c} ( r , q ) ) {\vert}_{q = 0}^{q = Q - 1} = {min}_{q} \{ {α}_{PSSCHgp , b , f , c} ( i , j , 0 ) \cdot {PL}_{gp , b , f , c} ( r , 0 ) , … , {α}_{PSSCHgp , b , f , c} ( i , j , q ) \cdot {PL}_{gp , b , f , c} ( r , q ) , … , {α}_{PSSCHgp , b , f , c} ( i , j , Q ) \cdot {PL}_{gp , b , f , c} ( r , Q ) \}$$

for the least path loss compensation within the group, e.g., for the best UE's radio link among the UEs within the group;

$$g ( {α}_{PSSCHgp , b , f , c} ( i , j , q ) \cdot {PL}_{gp , b , f , c} ( r , q ) ) {\vert}_{q = 0}^{q = Q - 1} = {max}_{q} \{ {α}_{PSSCHgp , b , f , c} ( i , j , 0 ) \cdot {PL}_{gp , b , f , c} ( r , 0 ) , … , {α}_{PSSCHgp , b , f , c} ( i , j , q ) \cdot {PL}_{gp , b , f , c} ( r , q ) , … , {α}_{PSSCHgp , b , f , c} ( i , j , Q ) \cdot {PL}_{gp , b , f , c} ( r , Q ) \}$$

for the most path loss compensation within the group, e.g., for the worst UE's radio link among the UEs within the group;

$$g ( {α}_{PSSCHgp , b , f , c} ( i , j , q ) , {PL}_{gp , b , f , c} ( r , q ) ) {\vert}_{q = 0}^{q = Q - 1} = \frac{1}{Q} \{ {\sum }_{q = 0}^{q = Q} {α}_{PSSCHgp , b , f , c} ( i , j , q ) \cdot {PL}_{gp , b , f , c} ( r , q )$$

for scaled or weighted average path loss compensation among the UEs within the group.

The Δ_{TF,b,f,c}(0) is the initial power adjustment related to Modulation Coding Scheme (MCS) for PSCCH and PSSCH respectively.

The Δ_{F_PSCCH}(F) is the power adjustment related to different format of PSCCH.

The α_{SCSIRS,b,f,c}^{int}(i, n), α_{PSCCH,b,f,c}^{int}(i, n), and α_{PSSCH,b,f,c}^{int}(i, n) are S-CSI-RS, PSCCH and PSSCH interference reference point path loss scaling factors respectively for a proximity range \hat{R}ₚᵣₒₓ(i) of a V2X service on BWP b of carrier f of cell c, where cell c may be a virtual “cell” in proximity if out of network coverage or a serving cell if under the network coverage.

The PL_{b,f,c}^{int}(s, n) is the nth interference reference point path loss measured from a reference point on BWP b of carrier f of cell c, where cell c may be a virtual “cell” in proximity if out of network coverage or a serving cell if under the network coverage. The reference points may be a gNB as illustrated in FIG. 3 (a), and may be an RSU, a proximity lead, a group lead or a synchronization source UE as illustrated in FIG. 4(a). For a proximity range \hat{R}ₚᵣₒₓ(i) of a V2X service, the inband interference based path loss PL_{b,f,c}^{int}(s, n) may be scaled with α_{SCSIRS,b,f,c}(i, j), α_{PSCCH,b,f,c}(i, j), and α_{PSSCH,b,f,c}(i, j) for S-CSI-RS, PSCCH and PSSCH respectively. For example, a value of 0.5 for α_{PSCCH,b,f,c}^{int}(i, n) may set the transmit power adjustment for PSCCH based on PL_{b,f,c}^{int}(s, n) measurement in half scale, e.g., less considering the inband interference; or a value of 1.0 for α_{PSCCH,b,f,c}^{int}(i, n) may set the transmit power adjustment for PSCCH based on PL_{b,f,c}^{int}(s, n) measurement in full scale, e.g., fully considering the inband interference.

The η_{SCSIRS,b,f,c}^{int}(i, n), η_{PSCCH,b,f,c}^{int}(i, n), and η_{PSSCH,b,f,c}^{int}(i, n) are S-CSI-RS, PSCCH and PSSCH total interference reference point path loss scaling factors respectively for a proximity range \hat{R}ₚᵣₒₓ(i) of a V2X service from N interference reference points on BWP b of carrier f of cell c, where cell c may be a virtual “cell” in proximity if out of network coverage or a serving cell if under the network coverage. For example,

$${η}_{PSCCH , b , f , c}^{int} ( i , n ) = \frac{1}{N}$$

is for the total path loss averaged with the weighted or scaled path losses measured from N interference reference points.

### Closed-Loop Transmit Power Control

Closed-loop TPC may be conducted based on the power control feedbacks from UEs within a group, e.g., the TPC instructions from some or all UEs of a group. The closed-loop transmit power of groupcast or multicast with S-CSI-RS, PSCCH and PSSCH at kth occasion for a proximity range \hat{R}ₚᵣₒₓ(i) of a V2X service with configuration j, where j is one of C configurations for different transmissions messages or transmission modes or transmission beams, may be set as follows with the TPC feedback q∈[0, Q).

$${P}_{SCSIRSgp , b , f , c}^{k} ( i , j , r , s ) = min \{ {P}_{CMAX , f , c} ( k ) , 10 \cdot {log}_{10} ( {2}^{μ} \cdot {M}_{RB , b , f , c}^{SCSIRS} ( k ) ) + {P}_{O \_ SCSIRSgp , b , f , c} ( i , j ) + g ( {α}_{SCSIRSgp , b , f , c} ( i , j , q ) , {PL}_{gp , b , f , c} ( r , q ) ) {\vert}_{q = 0}^{q = Q - 1} + {η}_{SCSIRS , b , f , c}^{int} ( i ) {\sum }_{n = 0}^{n = N - 1} {α}_{SCSIRS , b , f , c}^{int} ( i , n ) \cdot {PL}_{b , f , c}^{int} ( s , n ) + {\tilde{f}}_{CCSIRSgp , b , f , c} ( k , l , q ) {\vert}_{q ∈ [ 0 , Q )} \} dBm , {P}_{PSCCHgp , b , f , c}^{k} ( i , j , r , s ) = min \{ {P}_{CMAX , f , c} ( k ) , 10 \cdot {log}_{10} ( {2}^{μ} \cdot {M}_{RB , b , f , c}^{PSCCH} ( k ) ) + {P}_{O \_ PSCCHgp , b , f , c} ( i , j ) + g ( {α}_{PSCCHgp , b , f , c} ( i , j , q ) , {PL}_{gp , b , f , c} ( r , q ) ) {\vert}_{q = 0}^{q = Q - 1} + {Δ}_{TF , b , f , c} ( k ) + {Δ}_{{F}_{PSCCH}} ( F ) + {η}_{PSCCH , b , f , c}^{int} ( i ) {\sum }_{n = 0}^{n = N - 1} {α}_{PSCCH , b , f , c}^{int} ( i , n ) \cdot {PL}_{b , f , c}^{int} ( s , n ) + {\tilde{f}}_{PSCCHgp , b , f , c} ( k , l , q ) {\vert}_{q ∈ [ 0 , Q )} \} dBm , {P}_{PSSCHgp , b , f , c}^{k} ( i , j , r , s ) = min \{ {P}_{CMAX , f , c} ( k ) , 10 \cdot {log}_{10} ( {2}^{μ} \cdot {M}_{RB , b , f , c}^{PSCCH} ( k ) ) + {P}_{O \_ PSCCHgp , b , f , c} ( i , j ) + g ( {α}_{PSCCHgp , b , f , c} ( i , j , q ) , {PL}_{gp , b , f , c} ( r , q ) ) {\vert}_{q = 0}^{q = Q - 1} + {Δ}_{TF , b , f , c} ( k ) + {η}_{PSCCH , b , f , c}^{int} ( i ) {\sum }_{n = 0}^{n = N - 1} {α}_{PSCCH , b , f , c}^{int} ( i , n ) \cdot {PL}_{b , f , c}^{int} ( s , n ) + {\tilde{f}}_{PSCCHgp , b , f , c} ( k , l , q ) {\vert}_{q ∈ [ 0 , Q )} \} dBm .$$

Similar to the synchronization power control, the transmit power control with interference management may be generally described as the follows using PSSCH as an example. With a targeted power P_{0_PSSCH, b,f,c} (i) on the sidelink receiver based on QoS requirement such as minimum communication range, latency, reliability, etc., adjusted with path loss PL_{b,f,c}^{int}(s,n) measured from all interference reference points (i.e. n=0, . . . N−1):

$${P}_{PSSCH , b , f , c , j} ( i , j ) = \frac{1}{B} \cdot min \{ \begin{matrix}{P}_{CMAX , f , c} , \\ \begin{matrix}10 \cdot {log}_{10} ( {2}^{μ} \cdot {M}_{RB}^{PSCCH} ) + {P}_{{O}_{PSSCH} , b , f , c} ( i ) + \\ {\tilde{f}}_{PSSCHgp , b , f , c} ( k , l , q ) {\vert}_{q ∈ [ 0 , Q )}\end{matrix}\end{matrix} \} dBm ,$$

With a targeted power P_{0_PSSCH,b,f,c} (i, n) for interference reference point n (n=0, . . . N−1) based on interference control to the interference reference point

$${P}_{PSSCH , b , f , c , j} ( i , j ) = \frac{1}{B} \cdot min \{ \begin{matrix}{P}_{CMAX , f , c} , \\ \begin{matrix}10 \cdot {log}_{10} ( {2}^{μ} \cdot {M}_{RB}^{PSCCH} ) + {f}^{″} + \\ {\tilde{f}}_{PSSCHgp , b , f , c} ( k , l , q ) {\vert}_{q ∈ [ 0 , Q )}\end{matrix}\end{matrix} \} dBm , \\ {f}^{′} = ( ( {α}_{PSSCH , f , c}^{int} ( i , n ) \cdot {PL}_{b , f , c}^{int} ( s , n ) {\vert}_{n = 0}^{N - 1} ) , g ( {α}_{PSSCHgp , b , f , c} ( i , j , q ) , {PL}_{gp , b , f , c} ( r , q ) ) {\vert}_{q = 0}^{q = Q - 1} \\ {f}^{″} = f ( ( {P}_{{O}_{\_ PSSCH} , b , f , c} ( i , n ) + {α}_{PSSCH , f , c}^{int} ( i , n ) \cdot {PL}_{b , f , c}^{int} ( s , n ) ) {\vert}_{n = 0}^{N - 1} , {P}_{{O}_{PSSCH} , b , f , c} ( i , j ) + g ( {α}_{PSSCHgp , b , f , c} ( i , j , q ) , {PL}_{gp , b , f , c} ( r , q ) ) {\vert}_{q = 0}^{q = Q - 1}$$

where the f may be a minimum function, maximum function, weighted average function, etc.,

The M_{RB,b,f,c}^{SCSIRS}(k), M_{RB,b,f,c}^{PSCCH}(k), and M_{RB,b,f,c}^{PSSCH}(k) are S-CSI-RS,PSCCH and PSSCH frequency resource assignments in resource blocks respectively at kth transmission occasion with configuration j, where j is one of C configurations for different transmissions or transmission beams, on BWP b of carrier f of cell c.

The Δ_{TF,b,f,c}(k) is the power adjustment at kth transmission occasion related to MCS for PSCCH and PSSCH respectively.

The \tilde{f}_{gp,b,f,c}(k,l, q)|_{q∈[0,Q)} is the closed-loop power control adjustment state at kth transmission occasion with total Q TPC feedback, e.g., q∈[0, Q), for power control loop l or power control loop configuration l. For accumulated closed-loop power adjustment, the \tilde{f}_{gp,b,f,c}(k, l, q)|_{q∈[0,Q)} may be calculated for S-CSI-RS, PSCCH, and PSSCH respectively with the following equations as an example.

For S-CSI-RS:

$${\tilde{f}}_{SCSIRSgp , b , {f}_{,} c} ( k , l , q ) {\vert}_{q ∈ [ 0 , Q )} = {\tilde{f}}_{gp , b , f , c} ( k - {k}_{0} , l , q ) {\vert}_{q ∈ [ 0 , Q )} + {\sum }_{p = 0}^{p = Γ - 1} {min}_{p} \{ {δ}_{SCSIRS , b , f , c} ( p , l , q ) \} {\vert}_{q ∈ [ 0 , Q )}$$

for least power adjustment, i.e. least sidelink path loss,

$${\tilde{f}}_{SCSIRSgp , b , {f}_{,} c} ( k , l , q ) {\vert}_{q ∈ [ 0 , Q )} = {\tilde{f}}_{gp , b , f , c} ( k - {k}_{0} , l , q ) {\vert}_{q ∈ [ 0 , Q )} + {Σ}_{p = 0}^{p = Γ - 1} {max}_{p} \{ {δ}_{SCSIRS , b , f , c} ( p , l , q ) \} {\vert}_{q ∈ [ 0 , Q )}$$

for most power adjustment for example for the UEs within a minimum communication range. and

$${\tilde{f}}_{SCSIRSgp , b , {f}_{,} c} ( k , l , q ) {\vert}_{q ∈ [ 0 , Q )} = {\tilde{f}}_{SCSIRSgp , b , f , c} ( k - {k}_{0} , l , q ) {\vert}_{q ∈ [ 0 , Q )} + {\sum }_{p = 0}^{p = Γ - 1} \frac{1}{Q} {\sum }_{q = 0}^{q = Q - 1} {δ}_{SCSIRS , b , f , c} ( p , l , q )$$

for averaged power adjustment, where

\tilde{f}_{SCSIRSgp,b,f,c}(k−k₀, l, q)|_{q∈[0,Q)} is the closed-loop power control adjustment state at (k−k₀)th transmission occasion for power control loop l or power control loop configuration l;

$${\sum }_{p = 0}^{p = Γ - 1} {min}_{p} \{ {δ}_{SCSIRS , b , f , c} ( p , l , q ) \} {\vert}_{q ∈ [ 0 , Q )} , {\sum }_{p = 0}^{p = Γ - 1} {max}_{p} \{ {δ}_{SCSIRS , b , f , c} ( p , l , q ) \} {\vert}_{q ∈ [ 0 , Q )} , and {\sum }_{p = 0}^{p = Γ - 1} \frac{1}{Q} {\sum }_{q = 0}^{q = Q - 1} {δ}_{SCSIRS , b , f , c} ( p , l , q )$$

are accumulated total of Γ TPC command values derived (e.g., least adjustment, most adjustment, or averaged adjustment respectively.) from total Q TPC feedbacks on from Q UEs within a group between transmission occasion k−k₀ and k for power control loop l or power control loop configuration l.

For PSCCH:

$${\tilde{f}}_{PSCCHgp , b , f , c} ( k , l , q ) {\vert}_{q ∈ [ 0 , Q )} = {\tilde{f}}_{PSCCHgp , b , f , c} ( k - {k}_{0} , l , q ) {\vert}_{q ∈ [ 0 , Q )} + {\sum }_{p = 0}^{p = Γ - 1} {min}_{p} \{ {δ}_{PSCCH , b , f , c} ( p , l , q ) \} {\vert}_{q ∈ [ 0 , Q )}$$

for least power adjustment,

$${\tilde{f}}_{PSCCHgp , b , f , c} ( k , l , q ) {\vert}_{q ∈ [ 0 , Q )} = {\tilde{f}}_{PSCCHgp , b , f , c} ( k - {k}_{0} , l , q ) {\vert}_{q ∈ [ 0 , Q )} + {\sum }_{p = 0}^{p = Γ - 1} {max}_{p} \{ {δ}_{PSCCH , b , f , c} ( p , l , q ) \} {\vert}_{q ∈ [ 0 , Q )}$$

for most power adjustment, and

$${\tilde{f}}_{PSCCHgp , b , f , c} ( k , l , q ) {\vert}_{q ∈ [ 0 , Q )} = {\tilde{f}}_{PSCCHgp , b , f , c} ( k - {k}_{0} , l , q ) {\vert}_{q ∈ [ 0 , Q )} + {\sum }_{p = 0}^{p = Γ - 1} \frac{1}{Q} {\sum }_{q = 0}^{q = Q - 1} {δ}_{PSCCH , b , f , c} ( p , l , q )$$

for averaged power adjustment.

For PSSCH:

$${\tilde{f}}_{PSCCHgp , b , f , c} ( k , l , q ) {\vert}_{q ∈ [ 0 , Q )} = {\tilde{f}}_{PSCCHgp , b , f , c} ( k - {k}_{0} , l , q ) {\vert}_{q ∈ [ 0 , Q )} + {\sum }_{p = 0}^{p = Γ - 1} {min}_{p} \{ {δ}_{PSCCH , b , f , c} ( p , l , q ) \} {\vert}_{q ∈ [ 0 , Q )}$$

for least power adjustment,

$${\tilde{f}}_{PSCCHgp , b , f , c} ( k , l , q ) {\vert}_{q ∈ [ 0 , Q )} = {\tilde{f}}_{PSCCHgp , b , f , c} ( k - {k}_{0} , l , q ) {\vert}_{q ∈ [ 0 , Q )} + {\sum }_{p = 0}^{p = Γ - 1} {max}_{p} \{ {δ}_{PSCCH , b , f , c} ( p , l , q ) \} {\vert}_{q ∈ [ 0 , Q )}$$

for most power adjustment, and

$${\tilde{f}}_{PSCCHgp , b , f , c} ( k , l , q ) {\vert}_{q ∈ [ 0 , Q )} = {\tilde{f}}_{PSCCHgp , b , f , c} ( k - {k}_{0} , l , q ) {\vert}_{q ∈ [ 0 , Q )} + \\ \frac{1}{Q} {\sum }_{p = 0}^{p = Γ - 1} \frac{1}{Q} {\sum }_{q = 0}^{q = Q - 1} {δ}_{PSCCH , b , f , c} ( p , l , q ) for averaged power adjustment .$$

### Closed-Loop TPC Procedures

Closed-loop TPC procedures for groupcast or multicast are exemplified in this section.

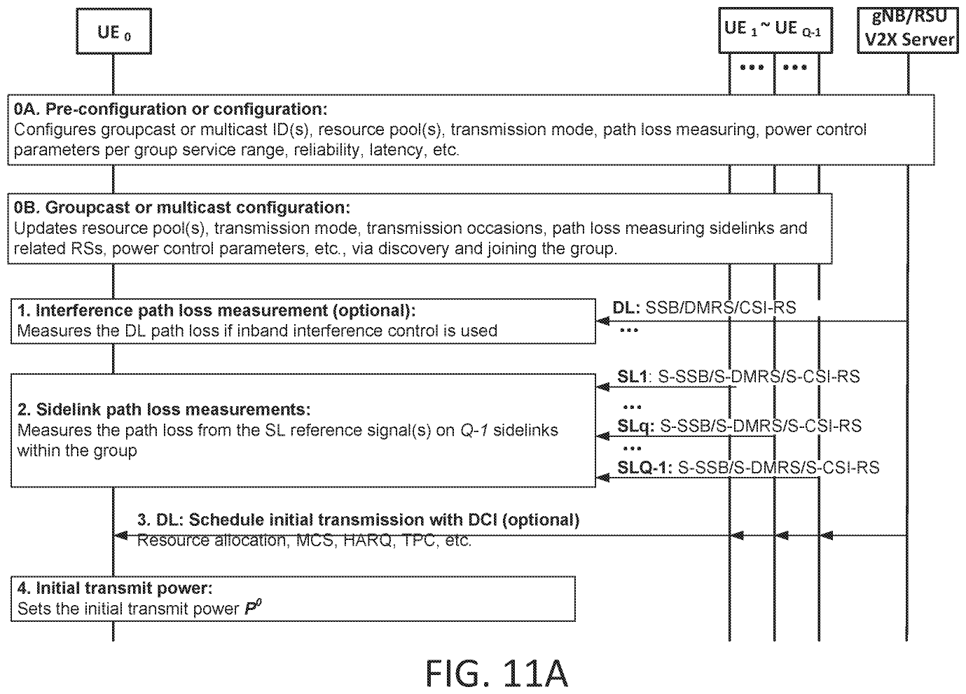

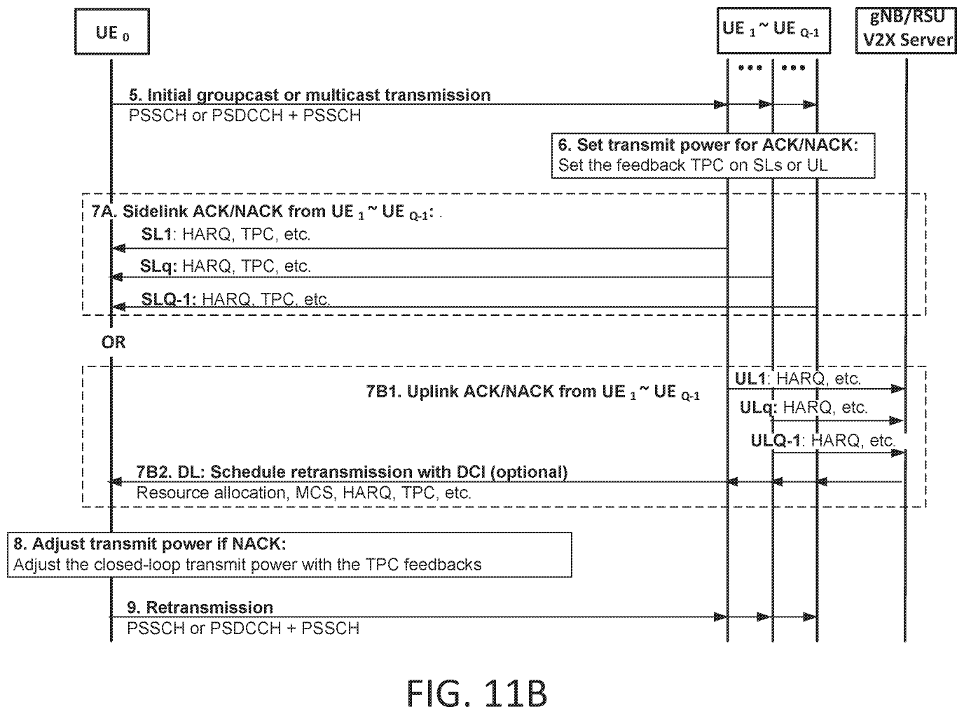

As depicted in FIG. 11A and FIG. 11B, the closed-loop power control for groupcast or multicast under network coverage may contain the following steps.

At step 0A, Pre-configuration or configuration: configures groupcast or multicast ID(s), resource pool(s), transmission mode, path loss measuring, power control parameters per group service range, reliability, latency, etc.

At step 0B, Groupcast or multicast configuration: updates resource pool(s), transmission mode, transmission occasions, path loss measuring sidelinks and related RSs, power control parameters, etc., via discovery and joining the group.

At step 1, Interference path loss measurement (optional): optional if inband interference control is used. UE0 measures the DL path loss, using the PSS/SSS and/or DMRS of PBCH within SSB(s) or the CSI-RS from gNB or gNB-like RSU.

At step 2, Sidelink path loss measurement: measures the path loss from the SL reference signal(s) on Q−1 sidelinks within the group.

At step 3, Schedule initial transmission with DCI (optional): optional for dynamically scheduled transmission. gNB sends sidelink schedule to UE₀ only or both UE₀ and UE₁˜UE_{Q-1} within the group with DCI(s) which may contain resource allocation, MCS, HARQ, TPC, etc.

At step 4, Initial transmit power: UE₀ sets the initial transmit power P⁰ with interference or not as configured (e.g., RRC configuration) or indicated (e.g., DCI scheduling the transmission) by gNB.

At step 5, Initial transmission: UE₀ groupcasts or multicasts the initial transmission with PSSCH or PSDCCH and PSSCH at the initial transmit power P⁰.

At step 6, Set transmit power for ACK/NACK: UE₁˜UE_{Q-1} decodes the received message with ACK or NACK and calculates the transmit power for sending ACK/NACK feedback on SL to UE₀ or on UL to gNB.

For the ACK/NACK feedback on SL, UE₁˜UE_{Q-1} may use channel reciprocal property to calculate the transmit power for ACK/NACK on SL. For example, UE₁˜UE_{Q-1} may set the feedback transmit power with UE₀'s initial transmit power, as indicated in the initial transmission or as configured during joining the group, adjusted with its measured RSRP, with the power adjustment indicated in RSRP or TPC on the feedback carried on SFCIs to UE₀. If the feedback requires larger communication range, the transmit power level for feedback may be based on one of configured values based on the QoS such as communication range, reliability, latency, receiving UE's location or transmitting UE and receiving UE's distance, etc., and/or adjusted with the measured RSRP of the received PSSCH with an adjustment such as power boosting. The transmit power control may also use the scheme proposed for broadcast message transmit power control with or without interference control as described previously.

Step 7A or Step 7B1 and 7B2.

At step 7A, Sidelink ACK/NACK from UE₁˜UE_{Q-1}: UE₁˜UE_{Q-1} send ACK/NACK feedbacks to UE₀. If NACK, the retransmission settings such as resource allocation, MCS, HARQ, TPC, etc., may be included on the SFCI or SCI.

At step 7B1, ACK/NACK for retransmission UE₁˜UE_{Q-1} send ACK/NACK feedbacks to gNB with UL transmit power setting as configured (e.g., RRC configuration) or indicated (e.g., DCI for the initial transmission) by gNB.

At step 7B2, Schedule retransmission with DCI (optional): optional if dynamically scheduling the retransmission. The gNB schedules the retransmission on sidelink with DCI(s) containing resource allocation, MCS, HARQ, TPC, etc. to UE₀ or to UE₀˜UE_{Q-1}.

At step 8, Adjust transmit power if NACK: UE₀ adjusts the closed-loop transmit power per TPC feedbacks from UE₀˜UE_{Q-1}, or per TPC indicated in the DCI for retransmission from gNB.

At step 9, Retransmission: UE₀ sends retransmission groupcasting or multicasting to UE₀˜UE_{Q-1} with PSSCH or PSDCCH and PSSCH at the adjusted transmit power.

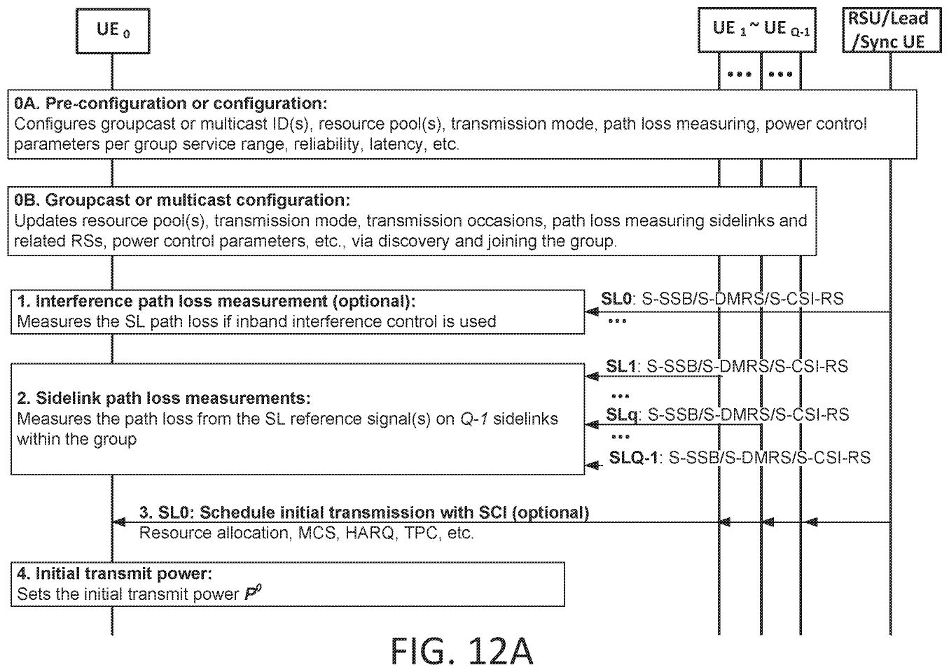

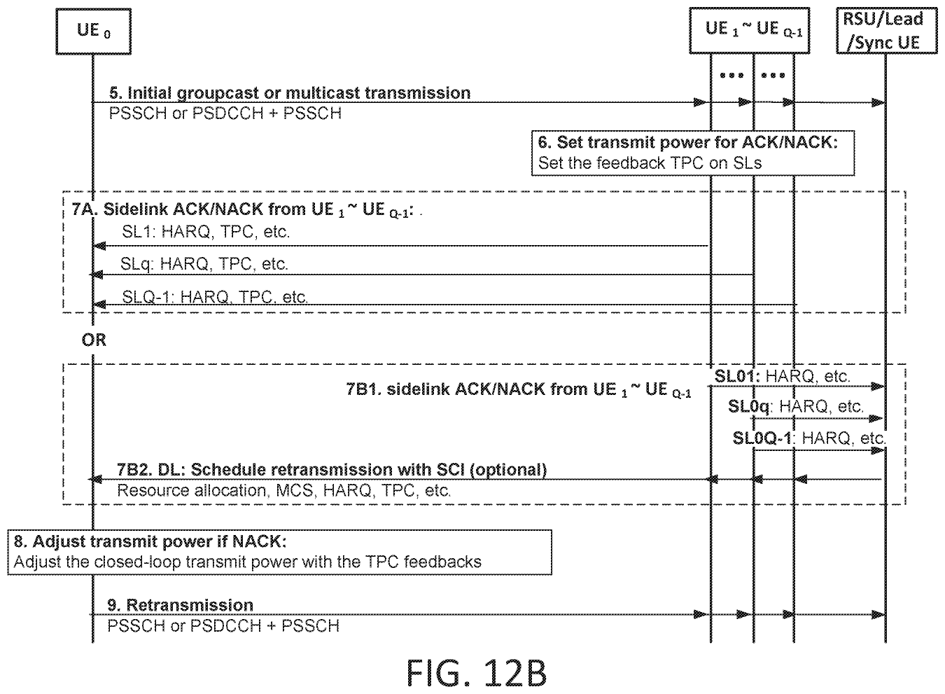

As depicted in FIG. 12A and FIG. 12B, the closed-loop power control for groupcast or multicast without network coverage may contain the following steps.

At step 0A, Pre-configuration or configuration: RSU, proximity lead, group lead or synchronization source UE configures groupcast or multicast ID(s), resource pool(s), transmission mode, path loss measuring, power control parameters per group service range, reliability, latency, etc.

At step 0B, Groupcast or multicast configuration: UE₀ updates resource pool(s), transmission mode, transmission occasions, path loss measuring sidelinks and related RSs, power control parameters, etc., via discovery and joining the group.

At step 1, Interference path loss measurement (optional): optional if inband interference control is used. UE₀ measures the sidelink path loss on SL0, using the S-PSS/S-SSS and/or S-DMRS of PSBCH within S-SSB(s) or the S-CSI-RS from RSU, proximity lead, group lead or synchronization source UE.

At step 2, Sidelink path loss measurement: measures the path loss from the SL reference signal(s) on Q−1 sidelinks within the group.

At step 3, Schedule initial transmission with DCI (optional): optional for dynamically scheduled transmission. RSU, proximity lead, group lead or synchronization source UE sends sidelink schedule to UE₀ only or UE₀˜UE_{Q-1} within the group with SCI(s) which may contain resource allocation, MCS, HARQ, TPC, etc.

At step 4, Initial transmit power: UE₀ sets the initial transmit power P⁰ with interference or not as configured (e.g., via joining the group) or indicated (e.g., SCI scheduling the transmission) by RSU, proximity lead, group lead or synchronization source UE.

At step 5, Initial transmission: UE₀ groupcasts or multicasts the initial transmission with PSSCH or PSDCCH and PSSCH at the initial transmit power P⁰.

At step 6, Set transmit power for ACK/NACK: UE1˜UE_{Q-1} decodes the received message with ACK or NACK and calculates the transmit power for sending ACK/NACK feedbacks carried by SFCI or SCI on SL to UE₀ or on SL to RSU, proximity lead, group lead or synchronization source UE.

For the ACK/NACK feedbacks on SL, UE1˜UE_{Q-1} may use channel reciprocal property to calculate the transmit power for ACK/NACK on SL. For example, UE1˜UE_{Q-1} may set the feedback transmit power with UE₀ 's initial transmit power, as indicated in the initial transmission or as configured during joining the group, with the power adjustment indicated in the TPC on the feedback carried on SFCIs or SCIs to UE₀.

Step 7A or Step 7B1 and 7B2.

At step 7A, Sidelink ACK/NACK from UE₁˜UE_{Q-1}: UE₁˜UE_{Q-1} send ACK/NACK feedbacks to UE₀. If NACK, the retransmission settings such as resource allocation, MCS, HARQ, TPC, etc., may be included on the SFCI or SCI.

At step 7B1, ACK/NACK for retransmission: UE₁˜UE_{Q-1} send ACK/NACK feedbacks to RSU, proximity lead, group lead or synchronization source UE with SL transmit power setting as configured (e.g., via joining the group) or indicated (e.g., SCI for the initial transmission) by RSU, proximity lead, group lead or synchronization source UE or with the sidelink transmit power setting by using sidelink transmit power control scheme similar to the transmit power setting on SL1˜SLQ−1.

At step 7B2, Schedule retransmission with SCI (optional): optional if dynamically scheduling the retransmission. The RSU, proximity lead, group lead or synchronization source UE schedules the retransmission on sidelink with SCI(s) containing resource allocation, MCS, HARQ, TPC, etc. to UE₀ only or to UE₀˜UE_{Q-1}.

At step 8, Adjust transmit power if NACK: UE₀ adjusts the closed-loop transmit power per TPC feedbacks from UE₀˜UE_{Q-1}, or per TPC indicated in the SCI for retransmission from RSU, proximity lead, group lead or synchronization source UE.

At step 9, Retransmission: UE₀ sends retransmission groupcast data or multicast data to UE₀˜UE_{Q-1} with PSSCH or PSDCCH and PSSCH at the adjusted transmit power.

### Power Sharing

At Uu interface, a NR system supports different data communications with different services such as enhanced Mobile Broadband (eMBB), Ultra-Reliable Low-Latency Communications (URLLC) and massive Machine Type Communications (mMTC). At PC5 interface, NR V2X supports more diverse communications such as unicast, groupcast and broadcast with periodic or aperiodic traffic with small or large data, and many of these communications require high reliability and low latency like URLLC.

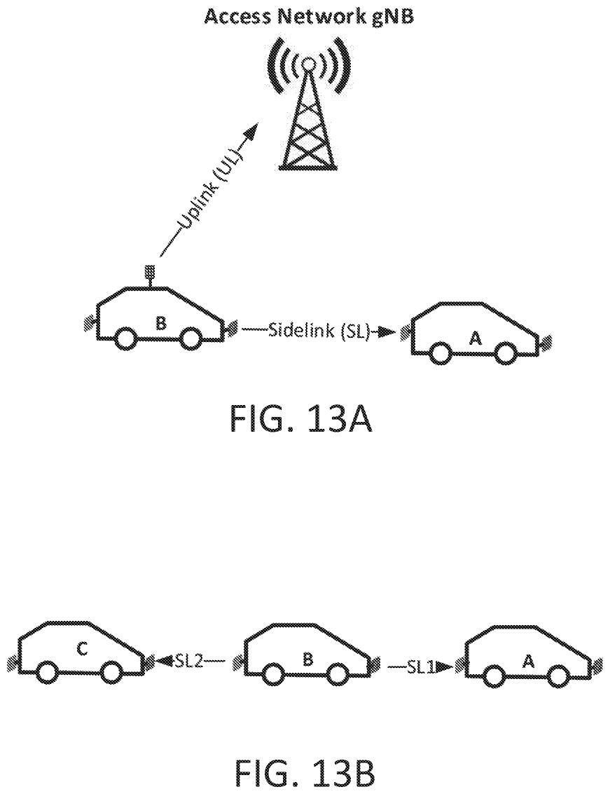

A UE may be configured or scheduled with an uplink (UL) transmission overlapping in time with a sidelink (SL) transmission. As illustrated in FIG. 13 A, UE B sends an UL transmission via its roof-top panel to a gNB while sending a SL transmission via its front bumper panel to UE A.

A UE may also be configured or scheduled with a SL transmission overlapping in time with another SL transmission. As illustrated in FIG. 13 B, UE B sends a SL transmission on sidelink SL1 to UE A via its front bumper panel while sending another SL transmission on sidelink SL2 to UE C via its rear bumper panel.

With the overlapped transmissions, if the total transmit power exceeds the maximum allowed transmit power, simply dropping a transmission may fail the reliability or latency requirement for services such as URLLC on Uu interface and emergency maneuver exchange on PC5 interface.

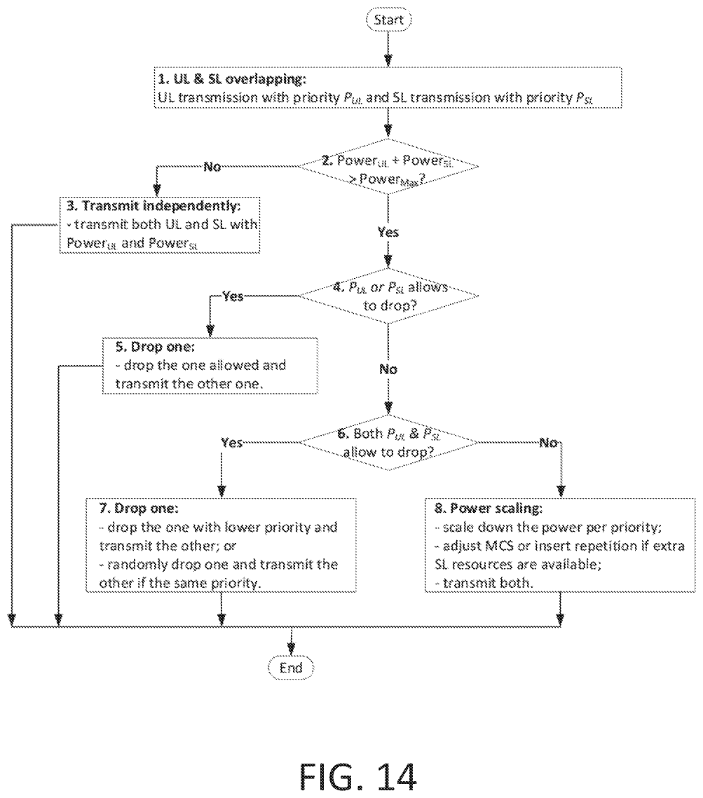

As exemplified in FIG. 14, power sharing between UL and SL may contain the following steps.

At step 1, UL & SL overlapping, a UE is scheduled or configured an UL transmission with priority P_{UL} and a SL transmission with priority P_{SL}.

At step 2, check if “Power_{UL}+Power_{SL}>Power_{Max}?”: If the total power of UL and SL exceeds the maximum allowed transmit power, move to step 4; otherwise, move to step 3.

At step 3, transmit independently: transmit both UL and SL with required power Power_{UL} and Power_{SL} respectively.

At step 4, check if “P_{UL} or P_{SL} allows to drop?”: if yes, move to step 5; otherwise, move to step 6.

At step 5, drop one: drop the one allowed and transmit the other one.

At step 6, check if “both P_{UL} & P_{SL} allow to drop?”: if yes, move to step 7; otherwise, move to step 8.

At step 7, drop one: compare the priority between P_{UL} and P_{SL}, drop the one with lower priority and transmit the other; or randomly drop one and transmit the other if the same priority with P_{UL} and P_{SL2}.

At step 8, power scaling: compare the priority level between P_{UL} and P_{SL} and scale down the power per priority, e.g. higher priority less scaling down or lower priority more scaling down; if extra SL resources are available, adjust MCS (e.g. lower the modulation) or insert repetition, indicate the adjusted MCS or repetition in the SCI associated with the SL transmission; transmit both UL and SL with scaled power level respectively.

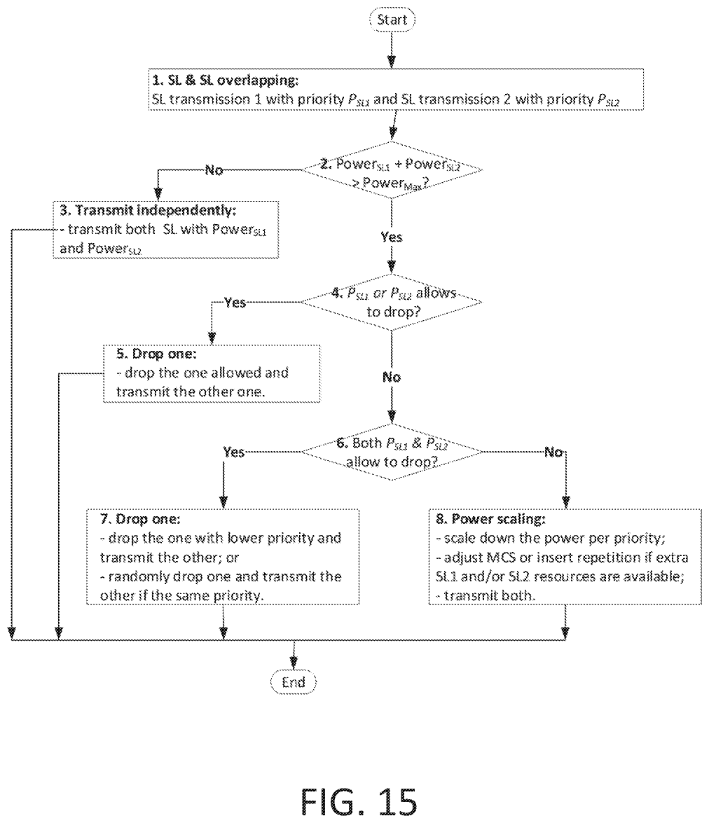

As exemplified in FIG. 15, power sharing between UL and SL may contain the following steps.

At step 1, SL & SL overlapping: a UE is scheduled or configured one SL transmission with priority P_{SL1} and another SL transmission with priority P_{SL2}.

At step 2, check if “Power_{SL1}+Power_{SL2}>Power_{Max}?”: If the total power of SL 1 and SL 2 exceeds the maximum allowed transmit power, move to step 4; otherwise, move to step 3.

At step 3, transmit independently: transmit both SL1 and SL2 with required power Power_{SL1} and Power_{SL2} respectively.

At step 4, check if “P_{SL1} or P_{SL2} allows to drop?”: if yes, move to step 5; otherwise, move to step 6.

At step 5, drop one: drop the one allowed and transmit the other one.

At step 6, check if “both P_{SL1} & P_{SL2} allow to drop?”: if yes, move to step 7; otherwise, move to step 8.

At step 7, drop one: compare the priority level between P_{SL1} and P_{SL2}, drop the one with lower priority and transmit the other; or randomly drop one and transmit the other if the same priority with P_{SL1} or P_{SL2}.

At step 8, power scaling: compare the priority level with P_{UL} or P_{SL} and scale down the power per priority, e.g. higher priority less scaling down or lower priority more scaling down; if extra SL resources are available, adjust MCS (e.g. lower the modulation) or insert repetition, indicate the adjusted MCS or repetition in the SCI associated with the SL transmission; transmit both SL1 and SL2 with the scaled power and the associated SCIs.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A method comprising:
receiving one or more of a sidelink quality of service configuration, a sidelink transmit power control configuration, or an interference control configuration;
determining one or more of a first path loss measurement from a first device or a second path loss measurement from a second device on sidelink;
estimating a sidelink transmit power based on one or more of the sidelink quality of service configuration, the sidelink transmit power control configuration, the interference control configuration, the first path loss measurement from the first device, or the second path loss measurement from the second device on sidelink; and
sending a transmission to the second device on sidelink based on the estimated sidelink transmit power.

2. The method of claim 1, wherein the sidelink quality of service configuration comprises one or more of a minimum sidelink communication range, a priority, or a latency.

3. The method of claim 1, wherein the sidelink transmit power control configuration comprises one or more of: a sidelink target power, a sidelink path loss scaling factor, a sidelink maximum transmit power, an initial sidelink transmit power, a sidelink transmit power adjustment per sidelink bandwidth part, or a sidelink reference signal configuration for path loss measurement.

4. The method of claim 1, wherein the interference control configuration comprises one or more of a path loss scaling factor per bandwidth part, a reference signal configuration for path loss measurement, or a transmit power of a reference signal for the path loss measurement.

5. The method of claim 1, wherein:
determining the first path loss measurement from the first device comprises one or more of:
measuring a path loss on downlink from a gNB using a synchronization signal block (SSB) or a channel state information reference signal (CSI-RS); or
measuring a path loss on sidelink from the first device using a sidelink synchronization signal block (SSB), a sidelink channel state information reference signal (CSI-RS), or a sidelink demodulation reference signal (DMRS); and
wherein determining the second path loss measurement from the second device on sidelink comprises one or more of:
measuring a path loss on sidelink using a sidelink synchronization signal block (SSB), a sidelink channel state information reference signal (CSI-RS), or a sidelink demodulation reference signal (DMRS) from the second device; or
receiving a measurement of sidelink reference signal received power (RSRP) from the second device for a second path loss or receiving a measured second path loss from the second device, wherein the measurement comprises one or more of a sidelink synchronization signal block (SSB), a sidelink channel state information reference signal (CSI-RS), or a sidelink demodulation reference signal (DMRS).

6. The method of claim 1, wherein estimating the sidelink transmit power comprises one or more of:
determining a sidelink transmit power based on a configured sidelink transmit power associated with a quality of service; and
determining a sidelink transmit power using interference control based on one or more of the first path loss measurement from the first device or the second path loss measurement from the second device on sidelink.

7. The method of claim 1, wherein sending a transmission comprises one or more of broadcasting a sidelink synchronization signal block, broadcasting a sidelink discovery message, sending a packet via a sidelink unicast, a sidelink multicast, or a sidelink broadcast, and sending a feedback for a sidelink unicast or a sidelink multicast.

8. An apparatus comprising:
receiving one or more of a sidelink quality of service configuration, a sidelink transmit power control configuration, or an interference control configuration;
determining one or more of a first path loss measurement from a first device or a second path loss measurement from a second device on sidelink;
estimating a sidelink transmit power based on one or more of the sidelink quality of service configuration, the sidelink transmit power control configuration, the interference control configuration, the first path loss measurement from the first device, or the second path loss measurement from the second device on sidelink; and
sending a transmission to the second device on sidelink based on the estimated sidelink transmit power.

9. The apparatus of claim 8, wherein the sidelink quality of service configuration comprises one or more of a minimum sidelink communication range, a priority, or a latency.

10. The apparatus of claim 8, wherein the sidelink transmit power control configuration comprises one or more of: a sidelink target power, a sidelink path loss scaling factor, a sidelink maximum transmit power, an initial sidelink transmit power, a sidelink transmit power adjustment per sidelink bandwidth part, or a sidelink reference signal configuration for path loss measurement.

11. The apparatus of claim 8, wherein the interference control configuration comprises one or more of a path loss scaling factor per bandwidth part, a reference signal configuration for path loss measurement, or a transmit power of a reference signal for the path loss measurement.

12. The apparatus of claim 8, wherein:
determining the first path loss measurement from the first device comprises one or more of:
measuring a path loss on downlink from a gNB using a synchronization signal block (SSB) or a channel state information reference signal (CSI-RS); or
measuring a path loss on sidelink from the first device using a sidelink synchronization signal block (SSB), a sidelink channel state information reference signal (CSI-RS), or a sidelink demodulation reference signal (DMRS); and
wherein determining the second path loss measurement from the second device on sidelink comprises one or more of:
measuring a path loss on sidelink using a sidelink synchronization signal block (SSB), a sidelink channel state information reference signal (CSI-RS), or a sidelink demodulation reference signal (DMRS) from the second device; or
receiving a measurement of sidelink reference signal received power (RSRP) from the second device for a second path loss or receiving a measured second path loss from the second device, wherein the measurement comprises one or more of a sidelink synchronization signal block (SSB), a sidelink channel state information reference signal (CSI-RS), or a sidelink demodulation reference signal (DMRS) from the apparatus.

13. The apparatus of claim 8, wherein estimating the sidelink transmit power comprises one or more of:
determining a sidelink transmit power based on a configured sidelink transmit power associated with a quality of service; and
determining a sidelink transmit power using interference control based on one or more of the first path loss measurement from the first device or the second path loss measurement from the second device on sidelink.

14. The apparatus of claim 8, wherein sending a transmission comprises one or more of broadcasting a sidelink synchronization signal block, broadcasting a sidelink discovery message, sending a packet via a sidelink unicast, a sidelink multicast, or a sidelink broadcast, and sending a feedback for a sidelink unicast or a sidelink multicast.

15. A computer-readable storage medium storing instructions which, when executed by a processor, cause an apparatus to perform operations comprising:
receiving one or more of a sidelink quality of service configuration, a sidelink transmit power control configuration, or an interference control configuration;
determining one or more of a first path loss measurement from a first device or a second path loss measurement from a second device on sidelink;
estimating a sidelink transmit power based on one or more of the sidelink quality of service configuration, the sidelink transmit power control configuration, the interference control configuration, the first path loss measurement from the first device, or the second path loss measurement from the second device on sidelink; and
sending a transmission to the second device on sidelink based on the estimated sidelink transmit power.

16. The computer-readable storage medium of claim 15, wherein the sidelink quality of service configuration comprises one or more of a minimum sidelink communication range, a priority, or a latency.

17. The computer-readable storage medium of claim 15, wherein the sidelink transmit power control configuration comprises one or more of: a sidelink target power, a sidelink path loss scaling factor, a sidelink maximum transmit power, an initial sidelink transmit power, a sidelink transmit power adjustment per sidelink bandwidth part, or a sidelink reference signal configuration for path loss measurement.

18. The computer-readable storage medium of claim 15, wherein the interference control configuration comprises one or more of a path loss scaling factor per bandwidth part, a reference signal configuration for path loss measurement, or a transmit power of a reference signal for the path loss measurement.

19. The computer-readable storage medium of claim 15, wherein:
determining the first path loss measurement from the first device comprises one or more of:
measuring a path loss on downlink from a gNB using a synchronization signal block (SSB) or a channel state information reference signal (CSI-RS); or
measuring a path loss on sidelink from the first device using a sidelink synchronization signal block (SSB), a sidelink channel state information reference signal (CSI-RS), or a sidelink demodulation reference signal (DMRS); and
wherein determining the second path loss measurement from the second device on sidelink comprises one or more of:
measuring a path loss on sidelink using a sidelink synchronization signal block (SSB), a sidelink channel state information reference signal (CSI-RS), or a sidelink demodulation reference signal (DMRS) from the second device; or
receiving a measurement of sidelink reference signal received power (RSRP) from the second device for a second path loss or receiving a measured second path loss from the second device, wherein the measurement comprises one or more of a sidelink synchronization signal block (SSB), a sidelink channel state information reference signal (CSI-RS), or a sidelink demodulation reference signal (DMRS) from the apparatus.

20. The computer-readable storage medium of claim 15, wherein estimating the sidelink transmit power comprises one or more of:
determining a sidelink transmit power based on a configured sidelink transmit power associated with a quality of service; and
determining a sidelink transmit power using interference control based on one or more of the first path loss measurement from the first device or the second path loss measurement from the second device on sidelink.
